(19) United States
(12) Patent Application Publication
(10) Pub. No.: US 2025/0348026 A1
(43) Pub. Date: Nov. 13, 2025

(54) IMAGE FORMING APPARATUS

(71) Applicant: CANON KABUSHIKI KAISHA, Tokyo (JP)

(72) Inventors: KOHEI OKAYASU, Shizuoka (JP); JUN HARA, Kanagawa (JP); AKISATO SAKAKI, Kanagawa (JP)

(21) Appl. No.: 19/198,436

(22) Filed: May 5, 2025

(30) Foreign Application Priority Data
May 7, 2024 (JP) 2024-075157
May 7, 2024 (JP) 2024-075203

(51) Int. Cl. G03G 15/08

(52) U.S. Cl. CPC G03G 15/0891; G03G 15/0875; G03G 15/0877; G03G 2215/068

(57) ABSTRACT

An image forming apparatus includes a rotary rotatable about a rotation axis extending in an axial direction, a toner cartridge supported by the rotary and having a discharge opening, the toner cartridge configured to discharge toner from the discharge opening; and a developing unit supported by the rotary and including a receiving opening configured to receive the toner discharged from the discharge opening, a storage chamber configured to store the toner received from the receiving opening, and a developing roller configured to bear the toner stored in the storage chamber, wherein the developing unit includes a guide portion, and the guide portion is configured to guide the toner stored in the storage chamber to be away from the receiving opening in the axial direction when the rotary rotates.

### BACKGROUND OF THE INVENTION

### Field of the Invention

The present invention relates to an image forming apparatus for forming an image on a recording material.

### Description of the Related Art

In an electrophotographic image forming apparatus, a rotary developing system is known in which a color image is formed by rotating a rotary having a plurality of developing units. Japanese Patent Application laid-open Nos. 2007-183305 and 2008-096852 describe image forming apparatuses each including a rotary having a plurality of developing units and a plurality of toner cartridges (toner storing containers) that can be installed in and removed from the rotary.

When a developing unit is replenished with the toner from the toner cartridge, image defects such as density unevenness may occur if the toner is unevenly distributed in the developing unit.

### SUMMARY OF THE INVENTION

An object of the present invention is to provide a technique capable of uniformly distributing the toner in a developing unit in a rotary developing type image forming apparatus capable of replenishing the toner from a toner cartridge to the developing unit.

To achieve the above object, an image forming apparatus of the present invention comprises:
a rotary rotatable about a rotation axis extending in an axial direction;
a toner cartridge supported by the rotary and having a discharge opening, the toner cartridge configured to discharge toner from the discharge opening; and
a developing unit supported by the rotary and including a receiving opening configured to receive the toner discharged from the discharge opening, a storage chamber configured to store the toner received from the receiving opening, and a developing roller configured to bear the toner stored in the storage chamber,
wherein the developing unit includes a guide portion, and the guide portion is configured to guide the toner stored in the storage chamber away from the receiving opening in the axial direction in a case where the rotary rotates,
wherein, in a case where a rotation phase of the rotary in which the guide portion guides the toner in a direction away from the receiving opening in the axial direction is a first rotation phase, a rotation phase of the rotary in which a positional relationship between the toner cartridge and the developing unit is a positional relationship in which the toner is able to move from the discharge opening to the receiving opening is a second rotation phase, and a rotation phase of the rotary in which the toner cartridge is installed in and removed from the rotary is an installation/removal phase, the second rotation phase is located after the first rotation phase during one rotation of the rotary from the installation/removal phase.

To achieve the above object, the image forming apparatus of the present invention comprises:
a rotary rotatable about a rotation axis extending in an axial direction;
a toner cartridge supported by the rotary, the toner cartridge having a discharge opening, the toner cartridge configured to discharge toner from the discharge opening; and
a developing unit supported by the rotary, the developing unit including a receiving opening configured to receive the toner discharged from the discharge opening, a storage chamber configured to store the toner received from the receiving opening, and a developing roller configured to bear the toner stored in the storage chamber,
wherein a plurality of guide portions is provided in the storage chamber, the plurality of guide portions include a first guide portion and a second guide portion, the first guide portion is positioned between the second guide portion and the receiving opening in the axial direction, and the second guide portion is further from the receiving opening than the first guide portion is from the receiving opening,
wherein the first guide portion and the second guide portion are configured to guide the toner stored in the storage chamber in a direction away from the receiving opening in the axial direction as the rotary rotates, and
wherein a maximum amount of toner that is able to be moved in the axial direction by the second guide portion is less than a maximum amount of toner that is able to move in the axial direction by the first guide portion as the rotary rotates.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to example 1;

FIG. 2 is a configuration diagram of the image forming apparatus according to example 1;

FIG. 3 is a schematic diagram of a developing unit, a toner cartridge, and a tray according to example 1;

FIGS. 4A and 4B are cross-sectional views of the image forming apparatus according to example 1;

FIG. 5 is a perspective view of a rotary main body according to example 1;

FIGS. 6A to 6C are perspective views of the image forming apparatus according to example 1;

FIGS. 7A and 7B are cross-sectional views of the image forming apparatus according to example 1;

FIG. 8 is an explanatory diagram of the rotary main body according to example 1;

FIG. 9 is an explanatory diagram of the rotary main body according to example 1;

FIG. 10 is an explanatory diagram of the rotary main body according to example 1;

FIGS. 11A and 11B are explanatory diagrams of a configuration related to movement of the tray according to example 1;

FIGS. 12A and 12B are explanatory diagrams of a configuration related to movement of the tray according to example 1;

FIG. 13 is a diagram showing an internal structure of the toner cartridge according to example 1;

FIG. 14 is a cross-sectional view showing the internal structure of the toner cartridge according to example 1;

FIG. 15 is a diagram showing an internal structure of the developing unit according to example 1;

FIG. 16 is a cross-sectional view showing the internal structure of the developing unit according to example 1;

FIG. 17 is a schematic diagram showing a state of movement of the developing unit according to rotation of a rotary assembly;

FIG. 18 is a schematic diagram in which a guide of the developing unit according to example 1 guides the toner;

FIG. 19 is a diagram showing an internal structure of a toner cartridge according to example 2;

FIG. 20 is a diagram showing an internal structure of a developing unit according to example 2;

FIG. 21 is a diagram showing an internal structure of a toner cartridge according to example 3;

FIG. 22 is a diagram showing an internal structure of a developing unit according to example 3

FIG. 23 is a diagram showing an internal structure of a developing unit of example 4;

FIG. 24 is a cross-sectional view showing an internal structure of a developing unit according to an embodiment;

FIG. 25 is a diagram showing a rotation phase of a rotary assembly according to the embodiment;

FIGS. 26A and 26B are diagrams showing a developing guide portion of example 4;

FIG. 27 is a diagram showing an internal structure of a developing unit of example 5;

FIGS. 28A and 28B are diagrams showing a developing guide portion of example 5;

FIG. 29 is a diagram showing an internal structure of a developing unit of example 6; and

FIGS. 30A and 30B are diagrams showing a developing guide portion of example 6.

### DESCRIPTION OF THE EMBODIMENTS

Hereinafter, modes for carrying out the present invention will be described in detail on the basis of embodiments by way of example with reference to the drawings. However, dimensions, materials, shapes, and relative arrangements of components described in the embodiment should be appropriately changed according to the configuration of a device to which the invention is applied and various conditions. That is, the scope of the present invention is not intended to be limited to the following embodiments. In addition, not all the features described in the following embodiments are essential to the solution of the invention.

### Example 1

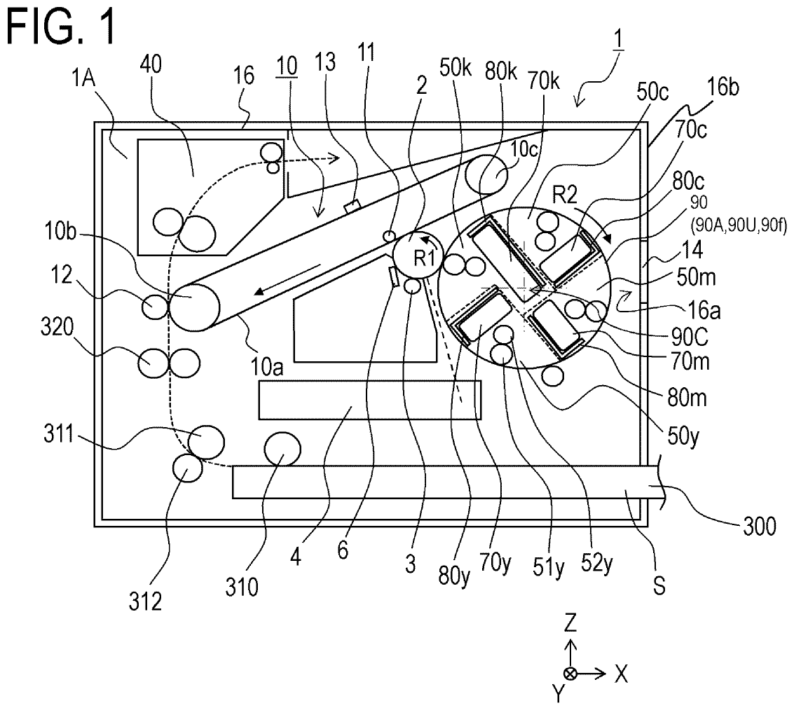

An image forming apparatus 1 according to example 1 will be described with reference to FIG. 1 to FIGS. 2A and 12B and FIG. 17.

In the following description and each drawing, a vertical direction when an image forming apparatus 1 is installed on a horizontal plane is defined as a Z direction. A direction which intersects the Z direction and which is a direction of a rotation axis 90C of a rotary main body 90 which will be described later (a rotation axis direction of the rotary) is defined as a Y direction. A direction which intersects both the Z direction and the Y direction is defined as an X direction. The X and the Y directions are preferably horizontal directions. Further, the X, Y and Z directions are preferably orthogonal to each other. Further, as necessary, the directions of arrows X, Y, and Z illustrated in the respective drawings are represented as +X side, +Y side, and +Z side, respectively, and the opposite sides are represented as −X side, −Y side, and −Z side, respectively.

### Overall Configuration of Image Forming Apparatus

First, the overall configuration of the image forming apparatus 1 will be described. The image forming apparatus 1 is a laser beam printer that forms an image on a sheet S by an electrophotographic method. More specifically, the image forming apparatus 1 is a color laser beam printer including four developing units 50y, 50m, 50c, and 50k. As the sheet S that is a recording material (recording medium), various sheet materials having different sizes and materials, such as paper such as plain paper and thick paper, a sheet material subjected to surface treatment such as a plastic film, cloth, and coated paper, and a sheet material having a special shape such as an envelope and index paper, can be used.

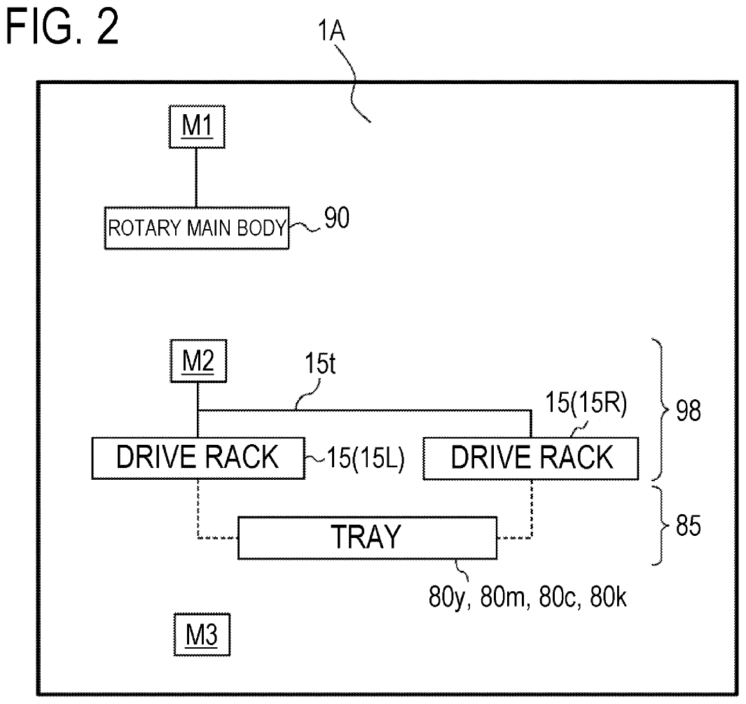

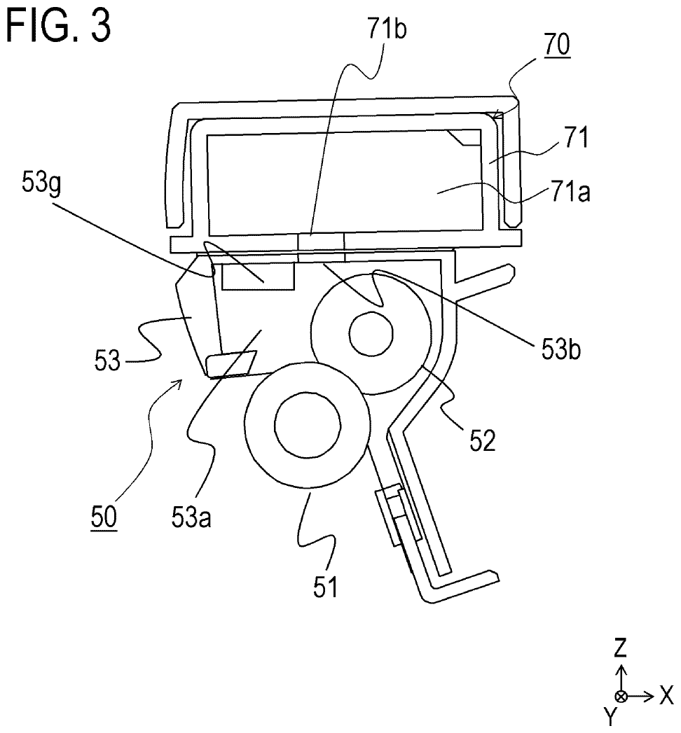

A schematic configuration and an image forming operation of the image forming apparatus 1 will be described with reference to FIGS. 1, 2, and 3. FIG. 1 is a schematic diagram showing a cross-sectional configuration of the image forming apparatus 1. FIG. 2 is a diagram illustrating a drive source of the image forming apparatus 1. FIG. 3 is a conceptual diagram showing a configuration for replenishing toner from a toner cartridge 70 to a developing unit 50.

As shown in FIG. 1, the image forming apparatus 1 includes an image forming apparatus main body (hereinafter, apparatus main body) 1A and toner cartridges 70y, 70m, 70c, and 70k that can be installed in and removed from the apparatus main body 1A. The apparatus main body 1A of the present example is a part obtained by removing the toner cartridges 70y, 70m, 70c, and 70k from the image forming apparatus 1.

The apparatus main body 1A of the image forming apparatus 1 includes an electrophotographic photosensitive member (hereinafter, photosensitive drum) 2 having a drum shape (cylindrical shape) as an image bearing member that bears an electrostatic latent image. A charging roller 3, a scanner 4 as an exposure device, and a cleaning unit 6 are disposed around the photosensitive drum 2.

The charging roller 3 is an example of a charging member or a charging unit for uniformly charging the photosensitive drum 2. The scanner 4 is an example of an exposure portion or an exposure unit that irradiates the photosensitive drum 2 with laser light according to image information to perform exposure. By irradiating the charged photosensitive drum 2 with laser light, an electrostatic latent image is formed on the surface of the photosensitive drum 2. The cleaning unit 6 is an example of a cleaning unit or a cleaning portion that removes toner remaining on the surface of the photosensitive drum 2.

The apparatus main body 1A further includes a sheet storage portion 300, a pickup roller 310, a feed roller 311, a separation roller 312, a pair of conveying rollers 320, a secondary transfer roller 12, a fixing device 40, and an intermediate transfer unit 10. The pickup roller 310 is an example of a feeding member or a feeding unit that feeds the sheet S. The feed roller 311 and the separation roller 312 are examples of a separation conveyance unit that conveys the sheets S while separating the sheet S one by one by frictional force. The secondary transfer roller 12 is an example of a transfer member or a transfer unit that transfers an image from the intermediate transfer belt 10a to the sheet S.

The intermediate transfer unit 10 includes an intermediate transfer belt 10a, a belt driving roller 10b, a tension roller 10c, a cleaning device 13, and a primary transfer roller 11. The intermediate transfer belt 10a is an example of an intermediate transfer member that bears an image to be transferred (primarily transferred) from the photosensitive drum 2 and conveys the image to be transferred (secondarily transferred) to the sheet S. The intermediate transfer belt 10a is stretched over the belt driving roller 10b and the tension roller 10c. The belt driving roller 10b is a driving member that conveys the intermediate transfer belt 10a by being rotationally driven by a drive source.

In addition, the apparatus main body 1A includes a rotary main body (a rotary, a rotating body, and a developing device) 90 having developing units 50y, 50m, 50c, and 50k. As will be described later, in the present example, trays (support members) 80y, 80m, 80c, and 80k are inserted into the rotary main body 90. Toner cartridges 70y, 70m, 70c, and 70k are removably installed in the trays 80y, 80m, 80c, and 80k.

In the following description, a plurality of members and the like having similar functions can be distinguished by being denoted by numbers. For example, one of the toner cartridges 70y, 70m, 70c, and 70k can be referred to as a first toner cartridge, one of the remaining three can be referred to as a second toner cartridge, one of the remaining two can be referred to as a third toner cartridge, and the last one can be referred to as a fourth toner cartridge. Similarly, one of the trays 80y, 80m, 80c, and 80k can be referred to as a first tray, one of the remaining three can be referred to as a second tray, one of the remaining two can be referred to as a third tray, and the last one can be referred to as a fourth tray. That is, one of the trays 80y to 80k is an example of a first support member, another one of the trays 80y to 80k is an example of a second support member, another one of the trays 80y to 80k is an example of a third support member, and the last one of the trays 80y to 80k is an example of a fourth support member. Such numbering is merely used for convenience of description, and can be appropriately changed in principle.

The developing units (first to fourth developing units) 50y, 50m, 50c, and 50k are examples of a developing unit or a developing portion that develops (visualizes) an electrostatic latent image formed on the photosensitive drum 2 into a toner image using toner of a color corresponding thereto. Each of the developing units 50y, 50m, 50c, and 50k develops the electrostatic latent image formed on the photosensitive drum 2 using yellow toner, magenta toner, cyan toner, or black toner. The developing units 50y, 50m, 50c, and 50k may be disposed in an order different from the order illustrated in FIG. 1.

The developing unit 50y includes a developing roller 51y and a supply roller 52y. The developing roller 51y is a developer bearing member that bears toner as a developer, rotates, and supplies the toner to the photosensitive drum 2. The supply roller 52y is a supply member that is disposed in contact with the developing roller 51y and supplies toner to the developing roller 51. A developing blade is a regulating member that regulates the thickness of a toner layer borne on the developing roller 51y. Other developing units 50m, 50c, and 50k also include similar developing rollers 51m, 51c, and 51k, supply rollers 52m, 52c, and 52k, and developing blades.

The toner cartridges 70y, 70m, 70c, and 70k corresponding to the developing units 50y, 50m, 50c, and 50k are installed in the rotary main body 90. Inside the toner cartridges 70y, 70m, 70c, and 70k, yellow toner, magenta toner, cyan toner, and black toner are stored as toners to be replenished to the developing units 50y, 50m, 50c, and 50k, respectively. One of the four color toners can be referred to as a first toner, one of the remaining three color toners can be referred to as a second toner, one of the remaining two color toners can be referred to as a third toner, and the last toner can be referred to as a fourth toner. For example, it can be said that the black toner is an example of a first toner and the magenta toner is an example of a second toner. Such numbering is merely used for convenience of description, and can be appropriately changed in principle.

Here, the rotary main body 90 includes a rotary frame 90f that supports the developing units 50y, 50m, 50c, and 50k. The developing units 50y, 50m, 50c, and 50k are supported by the rotary frame 90f that is a rotatable rotary support.

The trays 80y, 80m, 80c, and 80k are inserted into the rotary main body 90. The combined part of the rotary main body 90 and the trays 80y, 80m, 80c, and 80k can be referred to as a rotary unit 90U. In other words, the rotary unit 90U includes the rotary main body 90 and the trays 80y, 80m, 80c, and 80k.

The toner cartridges 70y to 70k are attachably and detachably held by the trays 80y to 80k. As will be described later, the trays 80y to 80k are slidably supported to the outside of the rotary main body 90. The combined part of the rotary unit 90U and the toner cartridges 70y, 70m, 70c, and 70k can be referred to as a rotary assembly 90A. In other words, the rotary assembly 90A includes the rotary unit 90U and the toner cartridges 70y, 70m, 70c, and 70k.

As will be described later, the rotary main body 90 is rotatable about a rotation axis (rotation center) 90C. The rotation axis 90C coincides with the rotation axes of the rotary frame 90f, the rotary unit 90U, and the rotary assembly 90A. Further, the rotation axis 90C is substantially parallel to the rotation axis (rotation center) of the photosensitive drum 2.

The rotary main body 90 is rotatable around the rotation axis 90C. By rotating the rotary main body 90 around the rotation axis 90C, any of the developing rollers 51y, 51m, 51c, and 51k can take a developing posture facing the photosensitive drum 2. The posture at which the developing roller 51y faces the photosensitive drum 2 is referred to as a yellow developing posture. The posture at which the developing roller 51m faces the photosensitive drum 2 is referred to as a magenta developing posture. The posture at which the developing roller 51c faces the photosensitive drum 2 is referred to as a cyan developing posture. The posture at which the developing roller 51k faces the photosensitive drum 2 is referred to as a black developing posture. That is, the rotary main body 90 can rotate around the rotation axis 90C such that the postures of the developing rollers 51y, 51m, 51c, and 51k relative to the photosensitive drum 2 are changed. The black developing posture is an example of a first developing posture at which a first developing roller (developing roller 51k) faces the photosensitive drum 2. The other developing postures are examples of a second developing posture at which second developing rollers (developing rollers 51y to 51c) face the photosensitive drum 2. The yellow/magenta/cyan/black developing postures can also be referred to as first to fourth developing postures. Such numbering is merely used for convenience of description, and can be appropriately changed in principle.

As illustrated in FIG. 2, the apparatus main body 1A includes motors M1, M2, and M3 as drive sources. As will be described later, the motor M1 supplies a driving force for rotating the rotary main body 90 about the rotation axis 90C. In other words, the motor M1 rotates the rotary assembly 90A and the rotary unit 90U about the rotation axis 90C.

Further, the apparatus main body 1A has a drive device 98 including the motor M2 and a transmission device. The transmission device includes drive racks 15L and 15R as drive gears which will be described later, and a transmission portion 15t. The driving force of the motor M2 is transmitted to the drive racks 15L and 15R through the transmission portion 15t. In other words, the motor M2 is configured to drive the drive racks 15L and 15R, and moves the trays 80y, 80m, 80c, and 80k with respect to the rotary main body 90 via the drive racks 15L and 15R.

The motor M3 drives members other than the members driven by the motor M1 and the motor M2. For example, the motor M3 drives the photosensitive drum 2, the developing units 50y, 50m, 50c, and 50k, the pickup roller 310, the feed roller 311, the pair of conveying rollers 320, the secondary transfer roller 12, the belt driving roller 10b, and the fixing device 40.

The members driven by the motors M1, M2, and M3 can be appropriately changed. Further, the roles of any two or all of the motors M1, M2, and M3 can be integrated into one motor. On the other hand, a drive source other than the motors M1, M2, and M3 may be added.

Here, subscripts y, m, c, and k attached to the developing units 50y, 50m, 50c, and 50k, the toner cartridges 70y, 70m, 70c, and 70k, the trays 80y, 80m, 80c, and 80k, and the like indicate toner colors. The basic configurations and functions of the developing units 50y, 50m, 50c, and 50k are common. The basic configurations and functions of the toner cartridges 70y, 70m, 70c, and 70k are common. Further, the basic configurations and functions of the trays 80y, 80m, 80c, and 80k are common. Therefore, in a case where it is not necessary to distinguish the units, cartridges, and trays, the subscripts y, m, c, and k are omitted, and description will be given based on any one of four units, cartridges, and trays.

As illustrated in FIG. 3, the toner cartridge 70 includes a toner frame 71. The toner frame 71 includes a toner storage portion 71a that stores toner and a discharge opening 71b that communicates with the toner storage portion 71a. The discharge opening 71b is provided in a toner frame inner surface 71d of the toner storage portion 71a and discharges the toner in the toner storage portion 71a.

The developing unit 50 includes a developing frame (storage frame) 53. The developing frame 53 includes a developing storage chamber 53a, a receiving opening 53b that communicates with the developing storage chamber (toner supply chamber) 53a, the developing roller 51, and the supply roller 52. The receiving opening 53b is provided in a developing frame inner surface 53d of the developing storage chamber 53a, and receives the toner discharged from the discharge opening 71b. The developing storage chamber 53a stores the toner received from the receiving opening 53b. The developing roller 51 bears the toner stored in the developing storage chamber 53a.

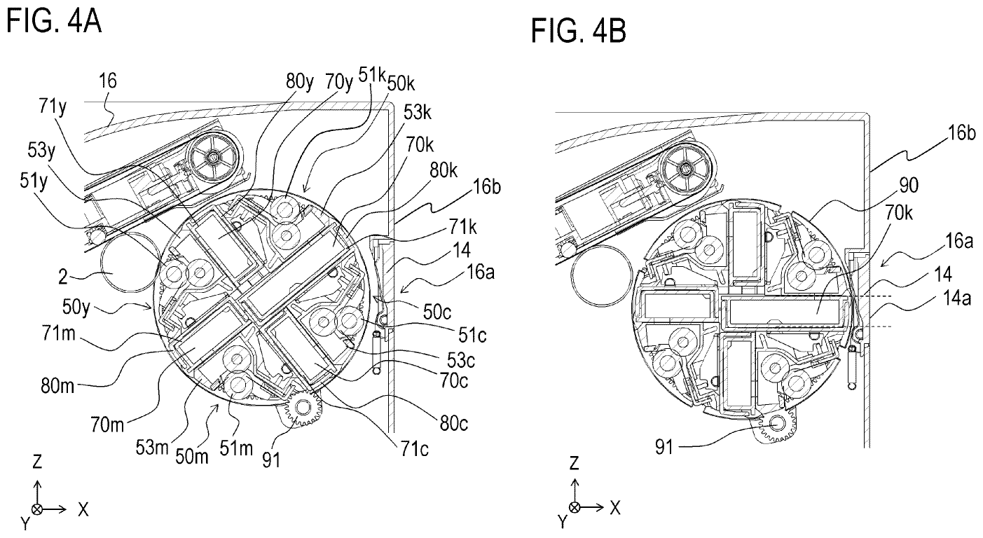

The developing roller 51k included in the developing unit 50k is an example of the first developing roller. The developing roller 51m included in the developing unit 50m is an example of the second developing roller. A developing frame 53k (FIG. 4A) of the developing unit 50k including the developing storage chamber 53a is an example of a first storage frame including a first storage portion. A developing frame 53m (FIG. 4A) of the developing unit 50m including the developing storage chamber 53a is an example of a second storage frame including a second storage portion. The rotary main body 90 is an example of a rotatable rotary having the first developing roller, the second developing roller, the first storage frame including the first storage portion, and the second storage frame including the second storage portion. In the present example, the rotary main body 90 includes first to fourth developing rollers and first to fourth storage frames.

As will be described later, the toner cartridge 70 is movable to a setting position and a retracted position retracted from the setting position with respect to the developing frame 53. In a state where the toner cartridge 70 is at the setting position with respect to the developing frame 53, the discharge opening 71b faces the receiving opening 53b. That is, the toner storage 71a of the toner cartridge 70 and the developing storage chamber 53a of the developing unit 50 communicate with each other via the discharge opening 71b and the receiving opening 53b. When toner is replenished from the toner cartridge 70 to the developing unit 50, at least a part of the receiving opening 53b is positioned below at least a part of the discharge opening 71b.

Then, the toner stored in the toner storage portion 71a is discharged from the discharge opening 71b, and the toner discharged from the discharge opening 71b is stored in the developing storage chamber 53a through the receiving opening 53b. The toner stored in the developing storage chamber 53a is supplied to the developing roller 51 by the supply roller 52. Through such a path, the toner stored in the toner storage portion 71a is supplied to the developing roller 51.

The toner cartridge 70 desirably includes a sealing member (first sealing member) (not illustrated) that covers the discharge opening 71b. In addition, the developing unit 50 desirably includes a sealing member (second sealing member) (not illustrated) that covers the receiving opening 53b.

In a state where the toner cartridge 70 is not set in the developing unit 50, it is desirable that the discharge opening 71b and the receiving opening 53b be covered with sealing members such that outflow of the toner from the discharge opening 71b and the receiving opening 53b is suppressed.

### Image Forming Operation

An image forming operation in the present example will be described. First, the photosensitive drum 2 is rotated in the arrow direction (counterclockwise) in FIG. 1 in synchronization with the rotation of the intermediate transfer belt 10a. Then, the surface of the photosensitive drum 2 is uniformly charged by the charging roller 3.

When a color image is formed on the sheet S, the rotary main body 90 rotates in the arrow direction (clockwise) in FIG. 1 while supporting the developing units 50y, 50m, 50c, and 50k as follows. Then, an electrophotographic process is repeatedly performed while moving the developing rollers 51y, 51m, 51c, and 51k to developing positions one by one.

First, the scanner 4 emits laser light based on image data corresponding to a yellow image to form an electrostatic latent image corresponding to the yellow image on the surface of the photosensitive drum 2. In parallel with the formation of the electrostatic latent image, the motor M1 rotates the rotary main body 90, and the rotary main body 90 takes the yellow developing posture. When the rotary main body 90 takes the yellow developing posture, the developing roller 51y is at the developing position and develops the electrostatic latent image formed on the photosensitive drum 2 with yellow toner.

Here, in the present example, each of the developing rollers 51y, 51m, 51c, and 51k is an elastic roller coated with rubber around a metal axis. At the developing position, each of the developing rollers 51y, 51m, 51c, and 51k develops the electrostatic latent image while being in contact with the photosensitive drum 2. That is, the image forming apparatus 1 in the present example adopts a contact developing method. However, at the developing position, each of the developing rollers 51y, 51m, 51c, and 51k may develop the electrostatic latent image in a state where a gap is formed between each developing roller and the photosensitive drums 2. That is, the image forming apparatus 1 may adopt a non-contact developing method.

When the yellow toner image is developed, the yellow toner image on the photosensitive drum 2 is primarily transferred to the intermediate transfer belt 10a by the primary transfer roller 11 disposed inside the intermediate transfer belt 10a.

Thereafter, by rotating the rotary main body 90 to sequentially move the developing rollers 51m, 51c, and 51k to developing positions, toner images of the respective colors are formed. That is, after the yellow toner image is formed on the intermediate transfer belt 10a, the rotary main body 90 takes the magenta developing posture, and a magenta toner image is formed on the intermediate transfer belt 10a. After the magenta toner image is formed on the intermediate transfer belt 10a, the rotary main body 90 takes the cyan developing posture, and a cyan toner image is formed on the intermediate transfer belt 10a. After the cyan toner image is formed on the intermediate transfer belt 10a, the rotary main body 90 takes the black developing posture, and a black toner image is formed on the intermediate transfer belt 10a. After the black toner image is formed on the intermediate transfer belt 10a, the rotary main body 90 rotates in the arrow direction (clockwise) illustrated in FIG. 1 around the rotation axis 90C and returns to the yellow developing posture. Note that the color of the image formed first on the intermediate transfer belt 10a is arbitrary, and for example, a black toner image may be formed first.

Then, primary transfer is repeated to superimpose toner images of four colors on the intermediate transfer belt 10a, whereby a color image is formed on the intermediate transfer belt 10a. The secondary transfer roller 12 and the cleaning device 13 are not in contact with the intermediate transfer belt 10a until a color image is formed on the intermediate transfer belt 10a.

Meanwhile, the sheet S is fed by the pickup roller 310 from the sheet storage portion 300 provided in a lower part of the apparatus main body 1A. The sheet S is sent to the pair of conveying rollers 320 in a state of being separated one by one by the feed roller 311 and the separation roller 312. The pair of conveying rollers 320 feeds the fed sheet S to a transfer portion (secondary transfer portion) which is a nip portion between the intermediate transfer belt 10a and the secondary transfer roller 12. The color image on the intermediate transfer belt 10a is transferred (secondarily transferred) to the surface of the conveyed sheet S.

The sheet S to which the color image has been transferred is sent to the fixing device 40. In the fixing device 40, the sheet S is heated and pressurized, and the image is fixed to the sheet S. The sheet S that has passed through the fixing device 40 is discharged to the outside of the image forming apparatus 1 as a product.

On the other hand, when a monochrome image is formed on the sheet S, the rotary main body 90 takes the black developing posture. In this state, an electrostatic latent image is formed on the surface of the photosensitive drum 2 by charging and exposure of the photosensitive drum 2, and then the electrostatic latent image is developed with black toner by the developing roller 51k located at the developing position. The black toner image is primarily transferred to the intermediate transfer belt 10a and then secondarily transferred to the sheet S. The subsequent process is similar to that in the case of a color image.

### Rotary Configuration

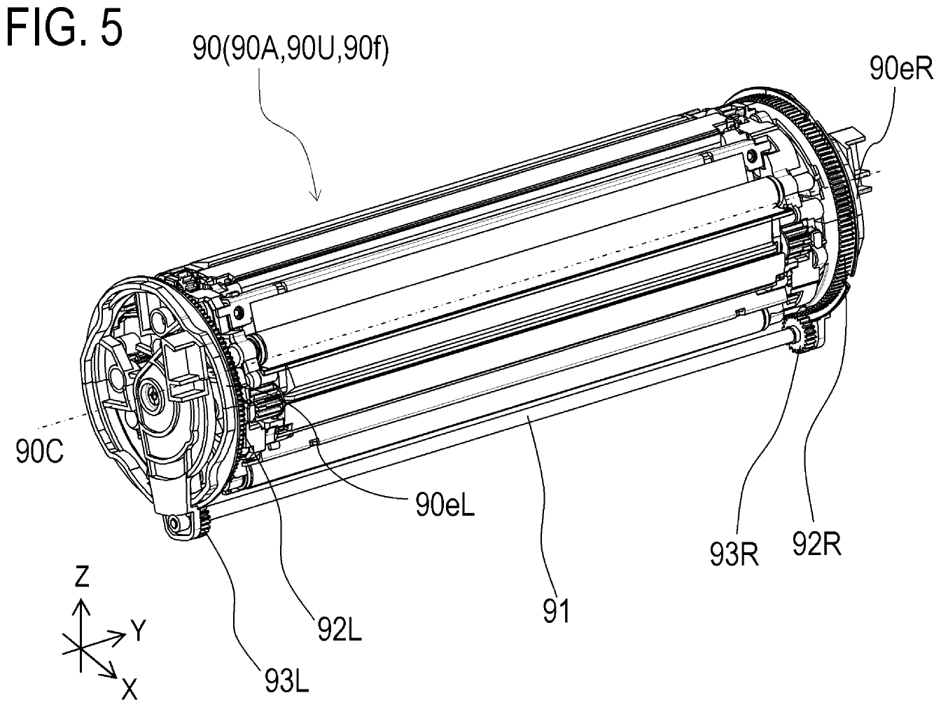

The configuration of the rotary main body 90 will be described with reference to FIG. 1, FIGS. 4A and 4B, and FIG. 5.

FIGS. 4A and 4B are cross-sectional views showing the rotary main body 90 of the image forming apparatus 1 and the periphery thereof. FIGS. 4A and 4B are cross-sectional views of the apparatus taken along a virtual plane perpendicular to the rotation axis 90C of the rotary main body 90. FIG. 5 is a perspective view of the rotary main body 90.

As described above, the toner cartridges 70y to 70k can be removably installed in the rotary main body 90. When the toner in the toner cartridges 70y to 70k runs out, the user can replenish the toner to the image forming apparatus 1 by replacing the toner cartridges 70y to 70k.

As illustrated in FIG. 1, the apparatus main body 1A includes a frame 16 that accommodates the rotary main body 90.

The frame 16 is a main body frame of the image forming apparatus 1 of the present example. The frame 16 is a housing (framework) of the apparatus main body 1A including a frame and an exterior member, and has a substantially rectangular parallelepiped shape in the present example.

The frame 16 includes an opening 16a. More specifically, the frame 16 includes a side surface 16b that expands in a direction intersecting the horizontal direction. The side surface 16b constitutes at least a part of the +X side external appearance surface of the apparatus main body 1A. The opening 16a is disposed on the side surface 16b. The side surface 16b is a side surface disposed on the downstream side of the discharge opening in a discharge direction in which the sheet S on which an image has been formed is discharged from the discharge opening of the apparatus main body 1A. The user can access the sheet storage portion 300 from the side surface 16b of the image forming apparatus 1 to replenish the sheet S or acquire the sheet S discharged from the discharge opening. Therefore, the side surface 16b can be referred to as a front surface of the apparatus main body 1A.

The toner cartridges 70y, 70m, 70c, and 70k can be removably installed in the rotary main body 90 through the opening 16a. That is, it can be said that the toner cartridge 70k is an example of a first toner cartridge that stores toner to be supplied to the first developing roller (developing roller 51k) and is removably installed in the rotary (rotary main body 90) through the opening 16a of the frame 16 of the apparatus main body 1A. It can be said that the toner cartridge 70m is an example of a second toner cartridge that stores toner to be supplied to the second developing roller (developing roller 51m) and is removably installed in the rotary (rotary main body 90) through the opening 16a of the frame 16 of the apparatus main body 1A.

In the present example, the toner cartridges 70y, 70m, 70c, and 70k are installed in and removed from the rotary main body 90 through the opening 16a in a state of being supported by the trays 80y to 80k. In other words, the user can install and remove the toner cartridges 70y to 70k in and from the rotary main body 90 via the trays 80y to 80k.

The opening 16a is disposed on the side surface 16b of the frame 16. In the present embodiment, the side surface 16b is a surface substantially parallel to the rotation axis 90C of the rotary main body 90. Therefore, in a case where the toner cartridge 70 is replaced, the toner cartridge 70 passes through the opening 16a in a direction intersecting (preferably, a direction orthogonal to) the rotation axis 90C.

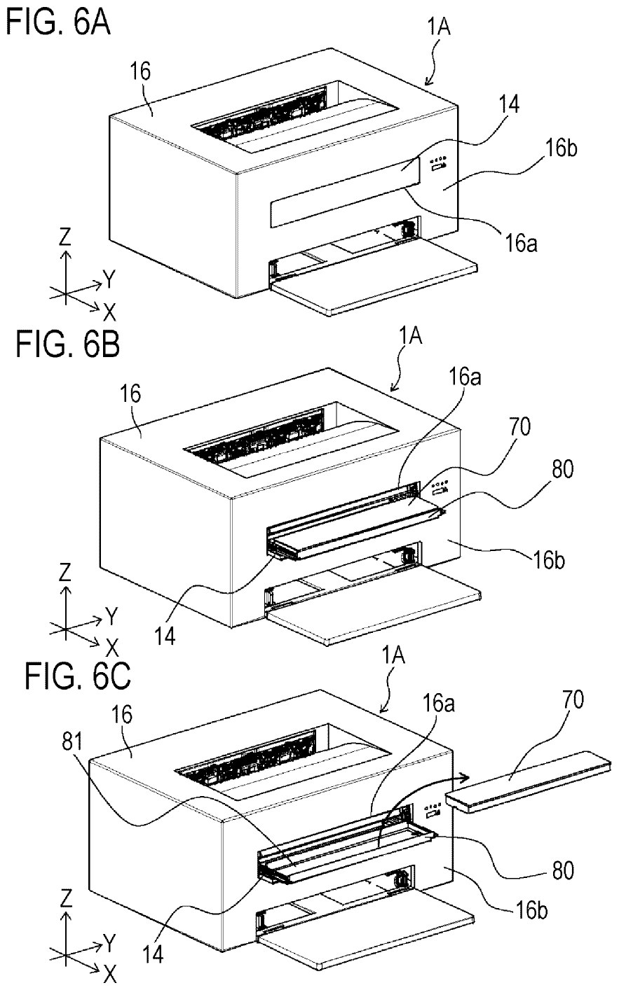

The image forming apparatus 1 includes a door 14 that covers the opening 16a of the frame 16. The door 14 is an opening/closing member movable between a closed position where the door covers the opening 16a (refer to FIG. 6A) and an open position where the opening 16a is exposed (refer to FIGS. 6B and 6C).

As described above, in the present example, the toner cartridge 70 is configured to be removably installed in the rotary main body 90 via the tray 80. Therefore, the toner cartridge 70 can be stably installed in and removed from the rotary main body 90.

More specifically, the user can replace the toner cartridge 70 by installing and removing the toner cartridge 70 in and from the tray 80 configured to be movable with respect to the rotary main body 90 (that is, with respect to the apparatus main body 1A). In the case of a configuration in which the user directly installs and removes a toner cartridge in and from the apparatus main body to replace the toner cartridge, the user is required to install the toner cartridge to a predetermined setting position in the apparatus main body. In the present example, the tray 80 is movable such that the toner cartridge 70 moves to the setting position in a state of supporting the toner cartridge 70. Therefore, the user can replace the toner cartridge 70 by a simple operation of putting the toner cartridge 70 on the tray 80, and thus the operability is improved.

Note that the toner cartridge 70 has an elongated shape with the Y direction parallel to the rotation axis 90C of the rotary main body 90 as a longitudinal direction. That is, the dimension of the toner cartridge 70 in the longitudinal direction is greater than the height and the width in the cross section orthogonal to the longitudinal direction. In the case of handling the toner cartridge 70 having such an elongated shape, the opening 16a is disposed on the side surface 16b of the frame 16 substantially parallel to the longitudinal direction (Y direction) of the toner cartridge 70, and thus the toner cartridge 70 can pass through the opening 16a with a short moving distance. For example, as compared with a case where the toner cartridge 70 is installed and removed through an opening provided on a side surface on any one side (+Y side or −Y side) of the frame 16 in the longitudinal direction of the toner cartridge 70, replacement of the toner cartridge 70 is facilitated.

The rotary main body 90 can rotate about the rotation axis 90C to take a replacement posture at which removal of any of the toner cartridges 70y to 70k from the rotary main body 90 is allowed. A posture at which the toner cartridge 70y is allowed to be removed is referred to as a yellow replacement posture. A posture at which the toner cartridge 70m is allowed to be removed is referred to as a magenta replacement posture. A posture at which the toner cartridge 70c is allowed to be removed is referred to as a cyan replacement posture.

A posture at which the toner cartridge 70k is allowed to be removed is referred to as a black replacement posture. The black replacement posture is an example of a first replacement posture at which the first toner cartridge is allowed to be removed from the rotary main body 90. The yellow/magenta/cyan replacement postures are examples of a second replacement posture at which the second toner cartridge is allowed to be removed from the rotary main body 90. The yellow/magenta/cyan/black replacement postures can also be referred to as first to fourth replacement postures. Such numbering is merely used for convenience of description, and can be appropriately changed in principle.

The rotary main body 90 rotates clockwise in FIG. 1 around the rotation axis 90C, and can sequentially take the yellow/magenta/cyan/black replacement postures. In the present embodiment, developing postures and replacement postures are alternately switched by rotating the rotary main body 90 clockwise in FIG. 1 around the rotation axis 90C. For example, in FIG. 1, the rotary main body 90 takes the black developing posture. When the rotary main body 90 rotates clockwise from this state, the posture of the rotary main body 90 is switched in the order of the cyan replacement posture, the yellow developing posture, the black replacement posture, the magenta developing posture, the yellow replacement posture, the cyan developing posture, and the magenta replacement posture. When the rotary main body 90 rotates clockwise from the magenta replacement posture, the rotary main body 90 returns to the black developing posture. That is, the rotary main body 90 can rotate clockwise by at least one rotation (360°).

FIG. 4A shows a cross section of the rotary main body 90 in a state of taking a developing posture (specifically, the yellow developing posture). FIG. 4B shows a cross section of the rotary main body 90 in a state of taking a replacement posture (specifically, the black replacement posture).

As shown in FIGS. 4A and 4B, four trays 80y to 80k are set in the rotary main body 90. The toner cartridges 70y to 70k are held in the trays 80y to 80k, respectively. In FIGS. 4A and 4B, the trays 80y to 80k are housed inside the rotary main body 90, and this state can be said to be a state in which the toner cartridges 70y to 70k are installed in the developing units 50y, 50m, 50c, and 50k.

As described above, the toner cartridge 70 is movable to the setting position and the retracted position retracted from the setting position with respect to the developing frame 53 of the developing unit 50. That is, the first toner cartridge (toner cartridge 70k) is movable to a first setting position and a first retracted position with respect to the first storage frame (developing frame 53k). The second toner cartridge (toner cartridge 70m) is movable to a second setting position and a second retracted position with respect to the second storage frame (developing frame 53m).

In a state where the toner cartridge 70 is at the setting position with respect to the developing frame 53, the discharge opening 71b and the receiving opening 53b face each other as illustrated in FIG. 3. In this state, the toner cartridge 70 is configured to supply toner to the developing storage chamber 53a through the receiving opening 53b (the opening of the storage frame).

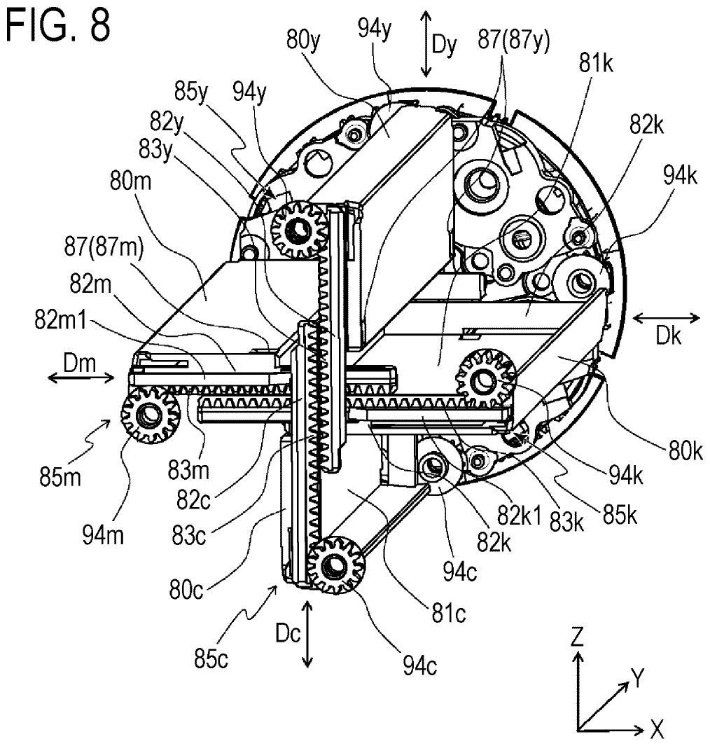

The apparatus main body 1A includes a moving device 85 configured to move the toner cartridge 70 from the setting position to the retracted position with respect to the rotary main body 90 (more specifically, with respect to the developing frame 53 of the developing unit 50). The moving device 85 will be described later with reference to FIG. 8 and the like. In the present example, a plurality of moving devices 85y to 85k corresponding to the plurality of toner cartridges 70y to 70k is disposed in the rotary main body 90. The trays 80y to 80k can be regarded as a part of the moving devices 85y to 85k.

In the present example, the toner cartridge 70k containing the black toner is larger in size than the toner cartridges 70y to 70c containing the yellow toner, the magenta toner, and the cyan toner, and can contain more toner. In other words, it can be said that the first toner cartridge can store a first amount of toner, the second toner cartridge can store a second amount of toner, and the first amount is larger than the second amount.

Specifically, the length of the black toner cartridge 70k in a first radial direction with respect to the rotation axis 90C of the rotary main body 90 is greater than the length of the magenta toner cartridge 70m in a second radial direction. Here, the first radial direction is a rotation radial direction of the rotary main body 90 (a radial direction of a virtual circle having the rotation axis 90C as a center), and is a direction in which the toner cartridge 70k extends with respect to the rotation axis 90C when viewed in the direction of the rotation axis 90C. The second radial direction is a rotation radial direction of the rotary main body 90, and is a direction in which the toner cartridge 70m extends with respect to the rotation axis 90C when viewed in the direction of the rotation axis 90C. Similarly, the length of the black toner cartridge 70k in the first radial direction is greater than the lengths of the toner cartridges 70y and 70c in the radial direction corresponding to the other toner cartridges 70y and 70c.

Therefore, the tray 80k holding the black toner cartridge 70k is larger in size than the trays 80y to 80c holding the other toner cartridges 70y, 70m, and 70c. That is, four toner cartridges 70y to 70k and trays 80y to 80k having different sizes are disposed in the rotary main body 90. In other words, the toner cartridge 70k as an example of the first toner cartridge and the toner cartridge 70y as an example of the second toner cartridge smaller in size than the first toner cartridge are removably installed in the rotary main body 90. In line with this, the rotary main body 90 is provided with the tray 80k as an example of a first support member that supports the first toner cartridge and the tray 80y as an example of a second support member smaller in size than the first support member. Further, the toner cartridges 70m and 70c as examples of a third toner cartridge and a fourth toner cartridge smaller in size than the first toner cartridge are removably installed in the rotary main body 90. In line with this, the rotary main body 90 is provided with the trays 80m and 80c as examples of a third support member and a fourth support member smaller in size than the first support member.

Here, rotational driving of the rotary main body 90 will be described with reference to FIG. 5. As shown in FIG. 5, disk gears 92L and 92R are formed at both end portions of the rotary main body 90. Further, rotary drive gears 93L and 93R are connected to both end portions of a swing shaft 91 so as to be drive-transmittable. Here, the driving force of the motor M1 is transmitted to the rotary drive gear 93R by a drive transmission mechanism. Next, the rotary main body 90 is rotationally driven by transmitting driving force to the disk gears 92L and 92R by the rotary drive gears 93L and 93R. The rotary main body 90 rotates about the rotation axis 90C clockwise in FIG. 1.

Further, the rotary main body 90 is supported to be swingable about the swing shaft 91. The rotary main body 90 is biased counterclockwise in FIGS. 4A and 4B about the swing shaft 91 by a biasing member (not illustrated). This direction can be referred to as a direction in which each of the developing rollers 51y to 51k approaches the photosensitive drum 2. As a result, in a state where the rotary main body 90 takes the developing posture, each of the developing rollers 51y to 51k is in contact with the photosensitive drum 2.

On the other hand, as shown in FIG. 5, rotary cams 90eL and 90eR are provided at both ends of the rotary main body 90. When the rotary main body 90 rotates clockwise in FIGS. 4A and 4B about the rotation axis 90C, the rotary cams 90eL and 90eR are in contact with a roller 96 (FIGS. 4A and 4B) supported by the frame 16. Then, they move clockwise in FIGS. 4A and 4B around the swing shaft 91. This direction can be referred to as a direction in which each of the developing rollers 51y to 51k moves away from the photosensitive drum 2. Further, this direction can be referred to as a direction in which the rotary main body 90 approaches the opening 16a of the frame 16 and the door 14.

As a result, when the rotary main body 90 rotates and switches from the developing posture to the replacement posture, the rotary main body 90 swings about the swing shaft 91. In a state where the rotary main body 90 takes the replacement posture, the developing roller 51 is separated from the photosensitive drum 2.

As shown in FIG. 4B, in the black replacement posture, the toner cartridge 70k stops at a position facing the opening 16a provided on the side surface 16b of the apparatus main body 1A and the door 14. When the tray 80k is slid and moved from the setting position on the developing unit 50k to the outside of the rotary main body 90 from this state, the user can replace the toner cartridge 70k.

### Toner Cartridge Replacement Operation

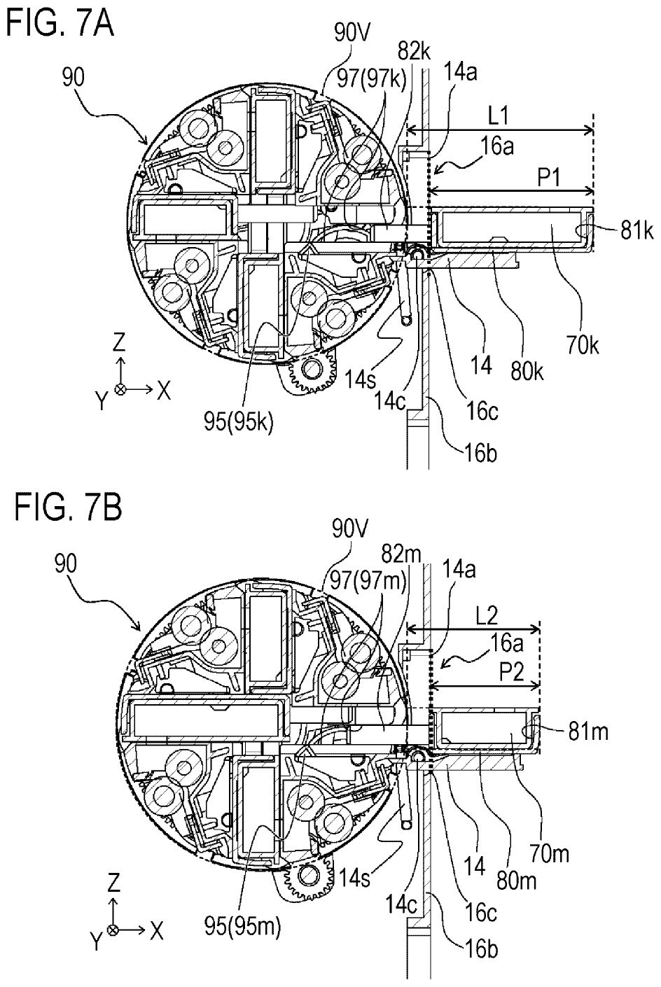

A toner cartridge replacement operation will be described with reference to FIG. 4A, FIGS. 6A to 6C, and FIGS. 7A and 7B. FIGS. 6A to 6C are external views of the apparatus main body 1A. FIGS. 7A and 7B are cross-sectional views of the periphery of the rotary main body 90 at the time of replacing the toner cartridge. FIGS. 7A and 7B are cross-sectional views of the apparatus in a virtual plane perpendicular to the rotation axis 90C of the rotary main body 90.

FIG. 6A shows an external appearance of the apparatus main body 1A during an image forming operation and in a standby state. The image forming operation is performed during a period in which the image forming apparatus 1 performs a series of operations from feeding the sheet S, forming an image on the sheet S, to discharging the sheet S as a product. The standby state is a state in which an image forming operation can be started when the image forming apparatus 1 receives an image forming instruction (print instruction), and is a state of waiting for an image forming instruction from a user. As shown in FIG. 6A, the door 14 is closed during the image forming operation and in the standby state.

FIG. 6B shows an external appearance of the apparatus main body 1A at the time of toner cartridge replacement. At the time of toner cartridge replacement, the door 14 is opened, and the tray 80 and the toner cartridge 70 are moved to the outside of the apparatus main body 1A.

The toner cartridge 70 is movable to a setting position and a retracted position retracted from the setting position with respect to the developing frame 53 of the developing unit 50. In a state where the toner cartridge 70 is at the setting position with respect to the developing frame 53, the discharge opening 71b and the receiving opening 53b face each other as illustrated in FIG. 3. As illustrated in FIGS. 4A and 4B, the rotary main body 90 rotates around the rotation axis 90C in a state where the toner cartridge 70 is at the setting position, and takes a developing posture or a replacement posture.

The toner cartridge replacement operation will be described. First, the user instructs a controller of the apparatus main body 1A to perform a toner cartridge replacement operation. The instruction for the toner cartridge replacement operation is performed, for example, by input through an operation panel (operation unit) provided in the apparatus main body 1A.

When the controller receives the instruction for the toner cartridge replacement operation, the rotary main body 90 rotates to a replacement posture of the toner cartridge 70 to be replaced (the toner cartridge 70 having no toner) and stops. That is, the controller rotates the rotary main body 90 to a toner cartridge replacement posture (black replacement posture for replacing the black toner cartridge 70k in FIG. 4B) designated in the instruction for the toner cartridge replacement operation. At the replacement posture, the tray 80 that supports the toner cartridge 70 instructed to be replaced faces the opening 16a of the frame 16 of the apparatus main body 1A.

For example, in the rotary main body 90 of FIG. 4A, the yellow developing roller 51y is at the yellow developing posture facing the photosensitive drum 2. At this time, the black toner cartridge 70k and the tray 80k may not face the opening 16a and the door 14. In other words, the toner cartridge 70 and the tray 80 may not face the opening 16a and the door 14 when the rotary main body 90 is at a replacement posture or a developing posture other than the replacement posture for the toner cartridge. Therefore, the opening 16a may have a size that allows each toner cartridge 70 to pass individually. When the rotary main body 90 rotates clockwise by a predetermined angle in the figure from the yellow developing posture, the black toner cartridge 70k and the tray 80k face the opening 16a and the door 14 as shown in FIG. 4B.

Here, “the tray 80 faces the opening 16a” means that the tray 80 is positioned so as to be movable to the outside of the apparatus main body 1A via the opening 16a. That is, when the tray 80 faces the opening 16a, the tray 80 is moved outward in the rotation radial direction of the rotary main body 90 by a moving mechanism which will be described later, and thus the tray 80 and the toner cartridge 70 supported by the tray 80 can protrude to the outside of the apparatus main body 1A. In FIG. 4A, none of the trays 80y to 80k faces the opening 16a. In FIG. 4B, only the black tray 80k faces the opening 16a, and the other trays 80y to 80c do not face the opening 16a.

When the rotary main body 90 is positioned at the replacement posture, the tray 80 supporting the toner cartridge 70 to be replaced is moved toward the outside of the apparatus main body 1A by the motor M2.

As a result, the toner cartridge 70 to be replaced moves from the setting position to the retracted position with respect to the rotary main body 90. As shown in FIGS. 6B and 6C and FIGS. 7A and 7B, the tray 80 and the toner cartridge 70 to be replaced supported by the tray 80 protrude to the outside of the apparatus main body 1A through the opening 16a.

More specifically, the tray 80 is movable to an accommodation position and a take-out position with respect to the rotary main body 90. The accommodation position is a position where the tray 80 is accommodated in the rotary main body 90. The take-out position is a position (removal position, replaceable position) where the tray 80 protrudes to the outside of the rotary main body 90 and the toner cartridge 70 can be taken out from the tray 80. An example of the accommodation position is the position of each of the trays 80y to 80k in FIGS. 4A and 4B. Examples of the take-out position are positions of the tray 80 in FIGS. 6B and 6C, the tray 80k in FIG. 7A, and the tray 80m in FIG. 7B.

When the tray 80 is at the accommodation position, the toner cartridge 70 installed in the tray 80 is at the setting position. When the tray 80 is at the take-out position, the toner cartridge 70 installed in the tray 80 is at the retracted position.

Here, as shown in FIGS. 7A and 7B, the rotary main body 90 has a protruded portion 95 for holding the tray 80 at the accommodation position and holding the toner cartridge 70 at the setting position. As shown in FIG. 8, the tray 80 is provided with a depressed portion 87 fitted to the protruded portion 95. Although FIGS. 7A and 7B illustrate the protruded portions 95k and 95m corresponding to the trays 80k and 80m and FIG. 8 illustrates the depressed portions 87y and 87m of the trays 80y and 80m, the protruded portion 95 and the depressed portion 87 are provided for each of the trays 80y to 80k. The protruded portion 95 is preferably biased in a direction of engaging with the depressed portion 87.

The tray 80 is locked to the rotary frame 90f by fitting the protruded portion 95 into the depressed portion 87 of the tray 80. As a result, even if the rotary main body 90 rotates, the tray 80 remains at the accommodation position, and the toner cartridge 70 is prevented from moving from the setting position. When the tray 80 is moved between the accommodation position and the take-out position by the moving device which will be described later, the protruded portion 95 is moved by the tray 80, and the protruded portion 95 can be configured to be detached from the depressed portion 87.

In the present example, the door 14 is rotatably supported with respect to the apparatus main body 1A. As shown in FIG. 7A, the door 14 is biased from the open position to the closed position by a spring 14s. The spring 14s is, for example, a tension spring, and biases the door 14 such that a moment in the counterclockwise direction in FIGS. 7A and 7B is generated around a support shaft 14c of the door 14.

When the tray 80 pushes the door 14, the door 14 is opened (state of FIG. 6B). This state can also be referred to as a state in which the tray 80 is supported by the door 14. At least a part of the tray 80 protruding to the outside of the apparatus main body 1A is supported by the door 14, and thus the toner cartridge 70 can be more stably supported. In other words, when the first toner cartridge (toner cartridge 70k) is at the first retracted position, the opening/closing member (door 14) at the open position supports the first support member (tray 80k). When the second toner cartridges (toner cartridges 70y to 70c) are at the second retracted position, the opening/closing member (door 14) at the open position supports the second support members (trays 80y to 80c).

The door 14 is in contact with a part of frame 16 of the apparatus main body 1A (for example, a lower edge 16c of the opening 16a) at the open position, and is configured not to rotate downward beyond the open position. When the tray 80 is pulled back from the outside to the inside of the apparatus main body 1A, the door 14 returns to the closed position by the biasing force of the spring 14s.

The toner cartridge 70 is detachably held on the tray 80. Therefore, as shown in FIG. 6C, the user can perform an operation (replacement operation) of removing the toner cartridge 70 from the tray 80 and installing a new toner cartridge 70 therein. When the plurality of toner cartridges 70 are replaced, the replacement operation can be performed by repeating the aforementioned operation.

FIGS. 7A and 7B show cross sections around the rotary main body 90 at the time of toner cartridge replacement. FIG. 7A shows a state at the time of replacement of the black toner cartridge 70k. FIG. 7B shows a state at the time of replacement of the magenta toner cartridge 70m.

The image forming apparatus 1 includes the moving device 85 (FIG. 8) that moves the toner cartridge 70 from the setting position to the retracted position. In the present example, it can be said that the moving device 85 includes the tray 80. The moving device 85k including the tray 80k can be said to be an example of a first moving device including the first support member. The moving device 85m including the tray 80m can be said to be an example of a second moving device including the second support member.

Even when the toner cartridge 70 is at the retracted position, the tray 80 is connected to the rotary main body 90 (supported by the rotary main body 90). In order to easily perform the operation of removing the toner cartridge 70 from the rotary main body 90, it is preferable that the length of the toner cartridge 70 protruding from the rotary main body 90 at the retracted position be long. Since the toner cartridge 70 is configured to be removably installed in the rotary main body 90 via the tray 80, the toner cartridge 70 can be stably supported by the tray 80 even when the length of the toner cartridge 70 protruding from the rotary main body 90 is long.

A moving direction of the toner cartridge 70 when the toner cartridge 70 moves from the setting position to the retracted position is referred to as a retraction direction. In the present example, the retraction direction of the toner cartridge 70 is a direction intersecting the direction of the rotation axis 90C (Y direction). Therefore, as shown in FIGS. 7A and 7B, when viewed in the direction of the rotation axis 90C (Y direction), the retraction direction of the toner cartridge 70 is a direction orthogonal to the direction of the rotation axis 90C (Y direction). In addition, it can be said that the retraction direction of the toner cartridge 70 is a direction toward the outside in the rotation radial direction of the rotary main body 90 (a direction away from the rotation axis 90C).

As shown in FIGS. 7A and 7B, since the user performs the operation of removing the toner cartridge 70 from the rotary main body 90, it is preferable that at least a part of the toner cartridge 70 protrude from the rotary main body 90 when the toner cartridge 70 is removed. In the present example, when the toner cartridge 70 is at the retracted position, the entire toner cartridge 70 protrudes from the rotary main body 90.

When the rotary main body 90 rotates about the rotation axis 90C, the rotation locus of the rotary main body 90 can be said to coincide with the circumscribed circle (virtual circle 90V indicated by a broken line in FIGS. 7A and 7B) of the rotary main body 90 about the rotation axis 90C. When the toner cartridge 70 is at the retracted position, it is preferable that at least half of the length of the toner cartridge 70 in the retraction direction be outside the rotation locus of the rotary main body 90. That is, when viewed in the rotation axis direction of the rotary, in a state where the toner cartridge is at the retracted position, it is preferable that at least half of the total length of the toner cartridge be located outside the rotation locus of the rotary in the moving direction of the toner cartridge from the setting position to the retracted position. This applies to each toner cartridge 70 including the toner cartridge 70k as an example of the first cartridge and the toner cartridge 70m as an example of the second cartridge. Further, in the present example, as shown in FIGS. 7A and 7B, when the toner cartridge 70 is at the retracted position, the entire toner cartridge 70 is outside the rotation locus (virtual circle 90V) of the rotary main body 90.

Furthermore, in order to make it easy for the user to grasp the toner cartridge 70, it is preferable that at least a part of the toner cartridge 70 be outside the image forming apparatus 1 (outside the apparatus main body 1A) when the toner cartridge 70 is at the retracted position. Here, the outside of the apparatus refers to a space outside the image forming apparatus 1 (outside the apparatus main body 1A) when the image forming apparatus 1 is used, such as an image forming operation on the sheet S.

In the present example, the external appearance surface of the apparatus main body 1A is formed by the external appearance surface of the frame 16. That is, the outside of the apparatus can also be referred to as the outside of the frame 16. Therefore, the state in which at least a part of the toner cartridge 70 is outside the apparatus can also be referred to as a state in which at least a part of the toner cartridge 70 protrudes from the opening 16a of the frame 16 of the apparatus main body 1A toward the outside of the frame 16.

In the present example, when the door 14 is at the closed position, the opening 16a of the frame 16 of the apparatus main body 1A is covered with the door 14. In addition, a part of the external appearance surface of the apparatus main body 1A is formed by the external appearance surface 14a of the door 14 at the closed position. In this case, the outside of the apparatus refers to the outside of the external appearance surface 14a of the door 14 at the closed position. That is, assuming that the position of the external appearance surface 14a of the door 14 at the closed position is an external appearance position, when the toner cartridge 70 is at the retracted position, at least a part of the toner cartridge 70 is located outside the apparatus main body 1A from this external appearance position.

In other words, at least a part of the toner cartridge 70 is positioned in a space outside the apparatus main body 1A if the door 14 is at the closed position. In the retraction direction of the toner cartridge 70, at least a part of the toner cartridge 70 is located on the downstream side of the external appearance position.

In addition, when the side surface 16b provided with the opening 16a is defined as the front surface of the apparatus main body 1A and the toner cartridge 70 is at the retracted position, at least a part of the toner cartridge 70 can be said to protrude toward the front side from the external appearance surface on the front side of the apparatus main body 1A. In this case, the user can easily access the toner cartridge 70 from the front side of the image forming apparatus to replace the toner cartridge 70.

Note that when the toner cartridge 70 is at the retracted position, it is preferable that at least half of the length of the toner cartridge 70 in the retraction direction be outside the apparatus. That is, when viewed in the rotation axis direction of the rotary, in a state where the toner cartridge is at the retracted position, it is preferable that at least half of the total length of the toner cartridge be located outside the main body frame in the moving direction of the toner cartridge from the setting position to the retracted position. This applies to each toner cartridge 70 including the toner cartridge 70k as an example of the first cartridge and the toner cartridge 70m as an example of the second cartridge. Further, when the toner cartridge 70 is at the retracted position, it is more preferable that the entire toner cartridge 70 be outside the apparatus. In the present example, the external appearance surface 14a and the side surface 16b of the door 14 form the external appearance surface on the front side of the apparatus main body 1A, but the configuration of the door 14 is not limited thereto. For example, the size of the door 14 may be set to a size that covers the entire side surface 16b. In this case, the external appearance surface 14a of the door 14 forms the external appearance surface on the front side of the apparatus main body 1A.

The tray 80 includes a cartridge holder 81 (refer to FIGS. 3 and 6C) that holds the toner cartridge 70. The cartridge holder 81 is a part in which the toner cartridge 70 is set. When the tray 80 is at the take-out position, it is preferable that the entire cartridge holder 81 be outside the rotation locus of the rotary main body 90 in the retraction direction. When the tray 80 is at the take-out position, it is preferable that at least half of the length of the cartridge holder 81 be outside the apparatus in the retraction direction.

Here, as described above, the toner cartridge 70k and the tray 80k are larger in size than the other toner cartridges 70y to 70c and the trays 80y to 80c. Therefore, as shown in FIGS. 7A and 7B, the amount of movement of the tray 80 at the time of toner cartridge replacement is changed in accordance with the size of the toner cartridge 70 in the present example.

Specifically, as shown in FIG. 7A, the moving distance when the tray 80k (first support member) moves from the accommodation position (first accommodation position) to the take-out position (first take-out position) is L1. The moving distance when the tray 80m (second support member) moves from the accommodation position to the take-out position (third take-out position) is L2. FIG. 7B shows a state where the toner cartridge 70m and the tray 80m have moved, and the moving distance when the trays 80y and 80c move from the accommodation position to the take-out position is also L2. At this time, L1 is larger than L2. In other words, it can be said that the moving distance of the first support member when the first toner cartridge moves from the first setting position to the first retracted position is longer than the moving distance of the second support member when the second toner cartridge moves from the second setting position to the second retracted position.

Further, as shown in FIG. 7A, in a state where the tray 80k is at the take-out position and the toner cartridge 70k is at the retracted position, the toner cartridge 70k protrudes to the outside of the apparatus from the external appearance surface of the apparatus main body 1A by a distance P1. In the present example, the tray 80k also protrudes to the outside of the apparatus from the external appearance surface of the apparatus main body 1A by the distance P1.

Further, as shown in FIG. 7B, in a state where the tray 80m is at the take-out position and the toner cartridge 70m is at the retracted position, the toner cartridge 70m protrudes to the outside of the apparatus from the external appearance surface of the apparatus main body 1A by a distance P2. In the present example, the tray 80m also protrudes to the outside of the apparatus from the external appearance surface of the apparatus main body 1A by the distance P2. The toner cartridges 70y and 70c also protrude to the outside of the apparatus from the external appearance surface of the apparatus main body 1A by the distance P2.

The distance P1 is greater than the distance P2. That is, a length by which the first toner cartridge at the first retracted position protrudes from the opening 16a of the apparatus main body 1A is defined as a first length (P1), and a length by which the second toner cartridge at the second retracted position protrudes from the opening 16a is defined as a second length (P2). In this case, it can be said that the first length is greater than the second length.

In the toner cartridges 70y to 70c having a size smaller than that of the toner cartridge 70k, it is preferable in terms of strength that the distance P2 protruding to the outside of the apparatus at the retracted position be shorter than the distance P1 protruding to the outside of the apparatus at the retracted position of the toner cartridge 70k. This is for the following reason. When the toner cartridge 70 is located at the retracted position, at least a part of the toner cartridge 70 protrudes to the outside of the rotation locus of the rotary main body 90 or the outside of the apparatus from the external appearance surface of the apparatus main body 1A. At this time, the tray 80 supports the weight of the toner cartridge 70 in a state of being cantilevered by the rotary main body 90. Therefore, when the distance P2 by which the toner cartridges 70y to 70c protrude to the outside of the apparatus at the retracted position is shortened, the load applied to the trays 80y to 80c and the guide portion 97 of the rotary main body 90 that supports the trays 80y to 80k can be reduced. In addition, since the toner cartridges 70y to 70c are smaller in size than the toner cartridge 70k, it is possible to maintain the workability of cartridge replacement with respect to the trays 80y to 80c even if the distance P2 is shorter than the distance P1.

### Tray Disposition in Rotary

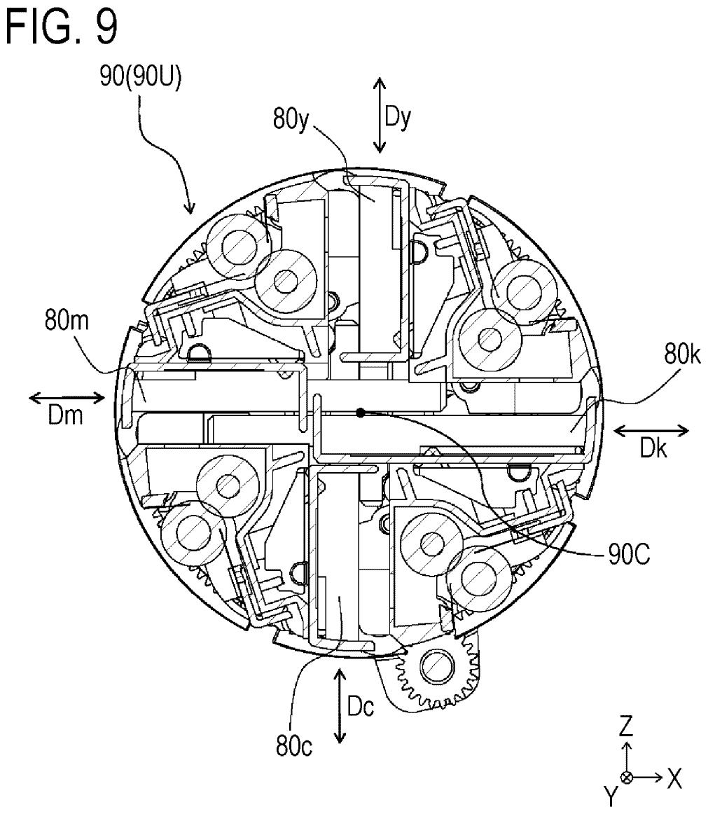

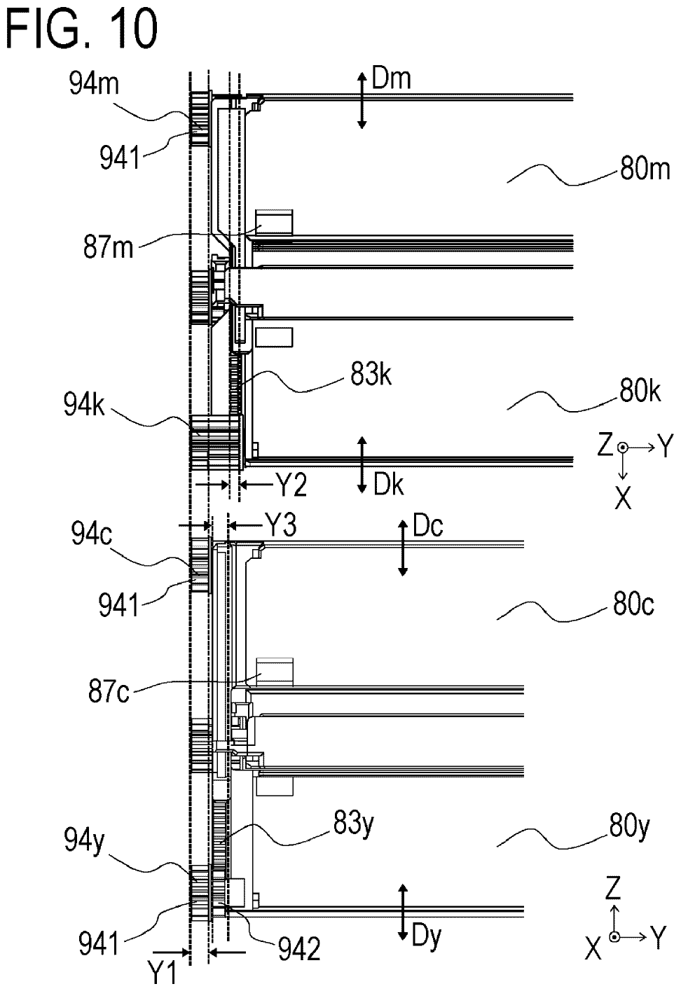

The disposition of the trays 80y to 80k in the rotary main body 90 will be described with reference to FIGS. 8, 9, and 10. FIG. 8 is a perspective view showing the disposition of the trays 80y to 80k in the rotary main body 90. FIG. 9 is a cross-sectional view showing the disposition of the trays 80y to 80k in the rotary main body 90. FIG. 10 is a diagram showing member disposition on one end side of the trays 80y to 80k in the Y direction. FIG. 9 shows a cut surface of the rotary main body 90 in a virtual plane perpendicular to the rotation axis 90C of the rotary main body 90. The upper half portion of FIG. 10 is a view of the rotary main body 90 and the trays 80m and 80k in FIG. 8 as viewed from the upper right side (+Z side) of FIG. 8, and the lower half portion of FIG. 10 is a view of the rotary main body 90 and the trays 80c and 80y in FIG. 8 as viewed from the left side (−X side) of FIG. 8.

As shown in FIG. 8, each of the trays 80y to 80k is provided with cartridge holders 81y to 81k and guided portions 82y to 82k.

The toner cartridges 70y to 70k are mounted on the cartridge holders 81y to 81k, respectively. Each of the cartridge holders 81y to 81k accommodates at least a part of each of the toner cartridges 70y to 70k mounted thereon.

The guided portions 82y to 82k are provided at both ends of the trays 80y to 80k sandwiching the cartridge holding portions 81y to 81k in the Y direction. The guided portions 82y to 82k are members elongated in a direction orthogonal to the rotation axis of the rotary main body 90.

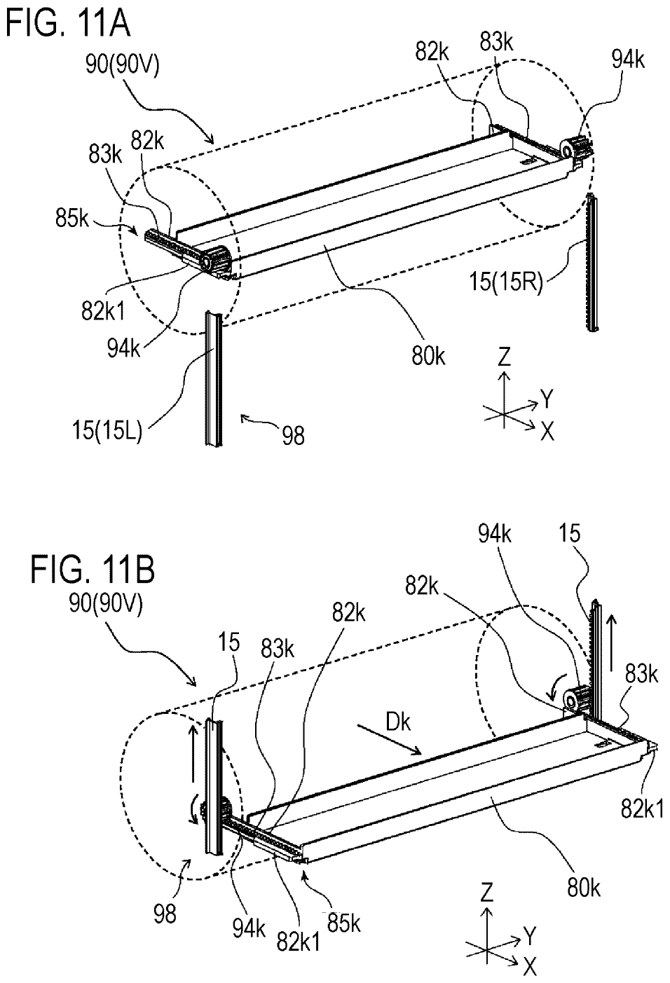

In the present example, a reinforcement rib 82k1 is formed in a part of the guided portion 82k in the moving direction Dk of the tray 80k, and a reinforcement rib 82m1 is formed in a part of the guided portion 82m in the moving direction Dm of the tray 80m (refer to FIGS. 11A and 11B). The reinforcement ribs 82k1 and 82m1 have rib shapes (ridges) protruding outward in the Y direction from guided portions 82k and 82m provided at both ends of the trays 80k and 80m in the Y direction and elongated in the moving directions Dk and Dm of the trays 80k and 80m. The rigidity of the guided portions 82k and 82m is improved by the reinforcement ribs 82k1 and 82m1.

Although the lengths of the reinforcement ribs 82m1 and 82k1 are limited while avoiding the guided portions 82y and 82c in the present example, the reinforcement ribs 82m1 and 82k1 may be provided over the entire lengths of the guided portions 82m and 82k when interference with the guided portions 82y and 82c does not occur. Reinforcement ribs may be added to the guided portions 82y and 82c. When the guided portions 82m and 82k have sufficient rigidity, the reinforcement ribs 82m1 and 82k1 may not be provided.

Rack portions 83y to 83k (rack gears) are formed on the guided portions 82y to 82k. Further, pinion gears 94y to 94k are rotatably held in the rotary main body 90. The pinion gears 94y to 94k are engaged with the rack portions 83y to 83k so as to be drive-transmittable.

The rack portions 83y to 83k and the pinion gears 94y to 94k are parts of the moving devices 85y to 85k configured to move the toner cartridges 70y to 70k from the setting positions to the retracted positions. Further, the rack portions 83y to 83k and the pinion gears 94y to 94k can be regarded as parts of a driven device driven by the drive device 98 of the apparatus main body 1A. The pinion gears 94y to 94k can be referred to as rotating bodies (rotating members) that move the trays 80y to 80k with respect to the rotary main body 90 by rotating.

The pinion gears 94y to 94k and the rack portions 83y to 83k function as driven portions for the moving devices 85y to 85k of the rotary main body 90 to receive a driving force from the drive device 98 of the apparatus main body 1A. The pinion gear 94k and the rack 83k are examples of a first pinion gear and a first rack gear constituting at least a part of a first driven part included in the first moving device. The pinion gear 94m and the rack 83m are examples of a second pinion gear and a second rack gear constituting at least a part of a second driven part included in the second moving device.

The rotary main body 90 has a guide portion 97 (refer to FIGS. 7A and 7B) engaged with each of the guided portions 82y to 82k. FIG. 7A shows the guide portion 97 (97k) engaged with the guided portion 82k of the tray 80k, and FIG. 7B shows the guide portion 97 (97m) engaged with the guided portion 82m of the tray 80m. The rotary main body 90 is provided with similar guides that engage with the guided portions 82y and 82c of the trays 80y and 80c. Although FIGS. 7A and 7B show the guide portion 97 provided on one side (+Y side) of the rotary main body 90 in the Y direction, the same guide portion 97 is also provided on the other side (−Y side) of the rotary main body 90 in the Y direction.

When the tray 80 moves between the accommodation position and the take-out position, the guide portion 97 maintains the state of being engaged with the guided portion 82 in at least a part of the movement range, and guides the moving direction of the tray 80. In the present example, the guide portion 97 maintains a state of being engaged with the guided portion 82k in the entire movement range between the accommodation position and the take-out position of the tray 80k. In addition, in the present example, the guide portion 97 maintains a state of being engaged with the guided portion 82m in the entire movement range between the accommodation position and the take-out position of the tray 80m.

As illustrated in FIGS. 8 and 9, the four trays 80y to 80k are disposed in the rotary main body 90 so as to overlap each other as will be specifically described below.

When the pinion gears 94y to 94k rotate, the racks 83y to 83k and the trays 80y to 80k move with respect to the rotary main body 90. As illustrated in FIG. 9, the four trays 80y to 80k are disposed to be rotated by 90 degrees with respect to the rotary main body 90. Therefore, the tray 80y and the tray 80c, and the tray 80m and the tray 80k are slidably held in substantially the same direction (parallel direction). The moving direction of each of the trays 80y to 80k at the time of sliding movement is regulated by engagement between the guided portions 82y to 82k and the guide portions 97y to 97k described above.

The trays 80y to 80k move to the outside of the apparatus through the opening 16a. When each of the trays 80y to 80k moves from the opening 16a to the outside of the apparatus, the moving directions of the trays are substantially the same direction (parallel).

As illustrated in FIG. 9, in the moving direction Dk of the tray 80k, the range in which the tray 80k is disposed is arranged to overlap the range in which the tray 80y is disposed and the range in which the tray 80c is disposed. Further, in the moving direction Dk of the tray 80k, the range in which the tray 80k is disposed overlaps the rotation axis 90C of the rotary main body 90. That is, the toner cartridge 70k held by the cartridge holding portion 81k of the tray 80k overlaps the rotation axis 90C of the rotary main body 90 (FIG. 4B).

On the other hand, in the moving direction Dm of the tray 80m, the range in which the tray 80m is disposed is shifted and arranged so as not to overlap the range in which the tray 80y is disposed and the range in which the tray 80c is disposed. Further, in the moving direction Dy of the tray 80y, the range in which the tray 80y is disposed is shifted and arranged so as not to overlap the range in which the tray 80m is disposed and the range in which the tray 80k is disposed. Similarly, in the moving direction Dc of the tray 80c, the range in which the tray 80c is disposed is shifted and arranged so as not to overlap the range in which the tray 80m is disposed and the range in which the tray 80k is disposed.

The positional relationship between the trays 80 can also be represented as follows. When viewed in the moving direction Dy of the tray 80y, the tray 80y and the tray 80k overlap, but the tray 80y and the tray 80m do not overlap. When viewed in the moving direction Dm of the tray 80m, the tray 80m and the tray 80k overlap, but the tray 80m and the trays 80y and 80c do not overlap. When viewed in the moving direction Dc of the tray 80c, the tray 80c and the tray 80k overlap, but the tray 80c and the tray 80m do not overlap.

Here, the fact that two elements (members, parts, units, and the like) overlap when viewed in a specific direction means that a projection area of one element and a projection area of the other element at least partially overlap when each element is vertically projected on a virtual plane perpendicular to the specific direction.

As illustrated in FIGS. 8 and 10, a range in which the rack 83m and the guided portion 82m are disposed and a range in which the rack 83k and the guided portion 82k are disposed at least partially overlap each other in the direction of the rotation axis 90C (Y direction). That is, in the present example, it can be said that a range in which the first rack gear (rack portion 83k) is disposed and a range in which the second rack gear (rack portion 83m) is disposed at least partially overlap with each other in the rotation axis direction (Y direction) of the rotary. Therefore, as compared with the arrangement in which the rack portion 83m and the guided portion 82m do not overlap the rack portion 83k and the guided portion 82k, the rack portions 83m and 83k and the guided portions 82m and 82k can be disposed in a space-saving manner in the Y direction.

In the direction of the rotation axis 90C (Y direction), a range in which the rack portion 83y and the guided portion 82y are disposed and a range in which the rack portion 83c and the guided portion 82c are disposed at least partially overlap each other. That is, in the present example, a range in which the third rack gear (rack portion 83y) is disposed and a range in which the fourth rack gear (rack portion 83c) is disposed at least partially overlap each other in the rotation axis direction (Y direction) of the rotary. Therefore, as compared with the arrangement in which the rack portion 83y and the guided portion 82y do not overlap the rack portion 83c and the guided portion 82c, the rack potions 83y and 83c and the guided portions 82y and 82c can be disposed in a space-saving manner in the Y direction.

Here, the meshing position of the rack portion 83 with the pinion gear 94 will be described with reference to FIG. 10. An upper half portion of FIG. 10 shows an engagement position of the rack portion 83k and the pinion gear 94k. A lower half portion of FIG. 10 shows an engagement position of the rack portion 83y and the pinion gear 94y.

In the direction (Y direction) of the rotation axis 90C of the rotary main body 90, the driving force transmitted from the motor M2 (FIG. 2) as a drive source by a transmission device which will be described later is transmitted to the pinion gears 94y to 94k in an area Y1 in the figure. In an area Y2 in the figured in the Y direction, the pinion gear 94k engages with the rack portion 83k so as to be drive-transmittable. In an area Y3 in the figure in the Y direction, the pinion gear 94y engages with the rack portion 83y so as to be drive-transmittable. Similarly to the rack portion 83k, the rack portion 83m engages with the pinion gear 94m (FIG. 8) in the area Y2 so as to be drive-transmittable. Similarly to the rack portion 83y, the rack 83c engages with the pinion gear 94c (FIG. 8) in the area Y3 so as to be drive-transmittable.

Here, the area Y2 and the area Y3 are at different positions in the Y direction (shifted in the Y direction). Further, the area Y1 is at a position different from both the area Y2 and the area Y3 in the Y direction. That is, the area Y1 is shifted in the Y direction with respect to the area Y2 and the area Y3.

Further, in a state where the toner cartridges 70y and 70c are at the setting positions, a range in which the rack portion 83y is disposed and a range in which the rack portion 83c is disposed at least partially overlap each other in the moving direction of the rack portion 83y (the moving direction Dy of the tray 80y). In the present example, since the moving directions Dy and Dc of the trays 80y and 80c are substantially the same direction (parallel), the range in which the rack portion 83y is disposed and the range in which the rack portion 83c is disposed also at least partially overlap each other in the moving direction Dc of the tray 80c. Therefore, in a state where the toner cartridges 70y and 70c are at the setting positions, a tooth surface of the rack portion 83y and a tooth surface of the rack portion 83c face each other in the direction (the left-right direction in FIG. 8) orthogonal to the moving directions Dy and Dc of the rack portions 83y and 83c.

Further, in a state where the toner cartridges 70m and 70k are at the setting positions, a range in which the rack 83m is disposed and a range in which the rack portion 83m is disposed at least partially overlap each other in the moving direction of the rack portion 83k (the moving direction Dm of the tray 80m). In the present example, since the moving directions Dm and Dk of the trays 80m and 80k are substantially the same direction (parallel), the range in which the rack portion 83m is disposed and the range in which the rack portion 83k is disposed also at least partially overlap each other in the moving direction Dk of the tray 80k. Therefore, in a state where the toner cartridges 70m and 70k are at the setting positions, a tooth surface of the rack portion 83m and a tooth surface of the rack portion 83k face each other in the direction (the vertical direction in FIG. 8) orthogonal to the moving directions Dm and Dk of the rack portions 83m and 83k.

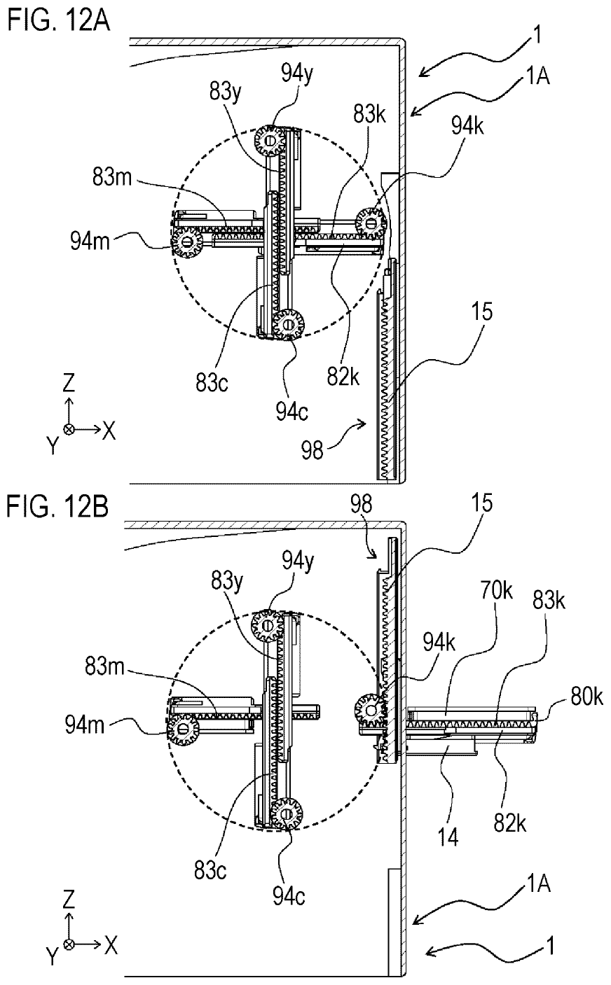

As illustrated in FIG. 12A which will be described later, when viewed in the direction of the rotation axis 90C (Y direction), the rack portion 83y overlaps the rack portion 83m and the rack portion 83k. When viewed in the direction of the rotation axis 90C (Y direction), the rack portion 83m overlaps the rack portion 83y and the rack portion 83c. When viewed in the direction of the rotation axis 90C (Y direction), the rack portion 83c overlaps the rack portion 83m and the rack portion 83k. When viewed in the direction of the rotation axis 90C (Y direction), the rack portion 83k overlaps the rack portion 83y and the rack portion 83c. In other words, it can be said that the range in which the first rack gear (rack portion 83k) is disposed and the range in which the second rack gear (rack portion 83y) is disposed do not overlap each other in the rotation axis direction (Y direction) of the rotary. Further, when viewed in the rotation axis direction (Y direction) of the rotary, it can be said that the first rack gear (rack portion 83k) and the second rack gear (rack portion 83y) overlap in a state where the first toner cartridge 70k is at the first setting position and the second toner cartridge 70y is at the second setting position.

As described above, since the positions where the rack portions 83k and 83m are disposed are different from the positions where the rack portions 83y and 83c are disposed in the Y direction, the rack portions 83y and 83c and the rack portions 83m and 83k can be disposed to overlap each other when viewed in the Y direction.

As a result, space saving in disposition of the four trays in the rotary main body 90 can be achieved, and miniaturization of the rotary main body 90 in the rotation radial direction can be realized. That is, when the rack portions 83 are disposed such that they do not overlap when viewed in the Y direction while keeping the moving distance of each of the trays 80y to 80k the same as in the present example, the area required to dispose the four racks when viewed in the Y direction increases. As compared with such a configuration, the plurality of rack portions 83 is disposed such that the positions thereof in the Y direction are shifted, and the rack portions 83 are caused to overlap each other when viewed in the Y direction, whereby the area in which the rack portions 83 are disposed when viewed in the Y direction can be reduced.

Further, in the present example, the four rack portions 83y to 83k are disposed in two sets of two by two with their positions shifted in the Y direction. That is, it can be said that the ranges in which the first rack gear and the second rack gear are disposed overlap each other and the ranges in which the third rack gear and the fourth rack gear are disposed overlap each other in the rotation axis direction (Y direction) of the rotary. In addition, it can be said that the ranges in which the first rack gear and the second rack gear are disposed and the ranges in which the third rack gear and the fourth rack gear are disposed are arranged so as not to overlap each other in the Y direction. As a result, it is possible to downsize the rotary main body 90 in the Y direction as compared with the case where the positions of the four rack portions 83y to 83k are shifted in the Y direction.

### Configuration for Movement of Tray

A configuration related to movement of the trays 80y to 80k disposed in the rotary main body 90 will be described with reference to FIGS. 11A and 11B and FIGS. 12A and 12B. FIGS. 11A and 11B are perspective views showing a configuration related to movement of the tray 80k. FIGS. 12A and 12B are cross-sectional views showing a configuration related to movement of the tray 80k.

In the present example, the trays 80y to 80k are each driven by a driving force of the motor M2 transmitted to the pinion gears 94y to 94k via the drive racks 15L and 15R serving as a transmission device. Here, the configuration of moving the tray 80k with respect to the rotary main body 90 will be described, and the configuration of moving the trays 80y to 80c with respect to the rotary main body 90 is substantially similar to the configuration of moving the tray 80k, and thus the description thereof will be omitted.

FIG. 11A illustrates a state where the tray 80k is inside the rotary main body 90 (that is, the toner cartridge 70k is set in the developing unit 50k). That is, FIG. 11A illustrates a state in which the tray 80k is at the accommodation position, and corresponds to a state in which the toner cartridge 70k is at the setting position with respect to the developing frame 53k (FIG. 4A). FIG. 11B illustrates a state in which the tray 80k has been slid to the outside of the rotary main body 90. That is, FIG. 11B illustrates a state in which the tray 80k is at the take-out position, and corresponds to a state in which the toner cartridge 70k is at the retracted position with respect to the developing frame 53k (FIG. 4B).

The apparatus main body 1A of the present example includes drive racks 15L and 15R as drive gears for driving the pinion gear 94. Each drive rack 15 is driven by the motor M2 via a drive transmission mechanism (not illustrated).

As described above, two rack portions 83k are formed at both ends of the tray 80k in the Y direction. Two pinion gears 94k and two drive racks 15L and 15R are disposed at positions corresponding to the rack portions 83k at both ends, respectively. That is, the apparatus main body 1A of the present example includes the drive racks 15L and 15R as a first drive gear and a second drive gear. It can be said that the drive rack 15L is an example of the first drive gear, and the drive rack 15R is an example of the second drive gear.

However, such numbering is merely used for convenience of description, and can be appropriately changed in principle. When it is not necessary to distinguish between the drive racks 15L and 15R, the drive racks are referred to as a “drive rack 15.”

The rack portion 83 of the present example is configured as a rack gear pair, and the pinion gear 94 of the present example is configured as a pinion gear pair. In the present example, the rack gear pair and the pinion gear pair are disposed on one end side and the other end side of a support member (tray 80) in the Y direction, but may be disposed at other positions. It can be said that the rack portion 83k and the pinion gear 94k of the moving device 85k corresponding to the tray 80k are examples of a first rack gear pair and a first pinion gear pair.

The rack portions 83y to 83c and the pinion gears 94y to 94c of the moving devices 85y to 85c corresponding to any one of the other trays 80y to 80c can be said to be examples of a second rack gear pair and a second pinion gear pair.

One rack gear of the rack gear pair meshes with one pinion gear of the pinion gear pair and the other rack gear of the rack gear pair meshes with the other pinion gear of the pinion gear pair. At least one pinion gear of the pinion gear pair is driven by the drive rack 15L as a first drive rack. In the present example, both pinion gears of the pinion gear pair are simultaneously driven by the drive racks 15L and 15R as the first drive rack and the second drive rack. As a result, the rotation of the tray 80 is less likely to occur, and the toner cartridge 70 can be stably moved. The tray 80 may have one rack 83 and may be moved by one drive rack 15 via one pinion gear 94.

The tray 80 may have one rack portion 83 and may be moved by one drive rack 15 via one pinion gear 94.

The tray 80k is slidably held in a direction (that is, the moving direction Dk) parallel to the guided portion 82k with respect to the rotary main body 90. The drive rack 15 is slidably held in a direction intersecting the moving direction Dk of the tray 80k with respect to the apparatus main body 1A. The drive rack 15 is configured to slide (reciprocate) in a first direction (vertically upward in the present example) and a second direction (vertically downward in the present example) opposite to the first direction with respect to the apparatus main body 1A. That is, the moving direction of the drive rack 15 of the present example is a direction intersecting (preferably, a direction orthogonal to) both the moving direction Dk of the tray 80k and the direction (Y direction) of the rotation axis 90C of the rotary main body 90.

A tray moving operation of sliding the tray 80k between the accommodation position and the take-out position will be described with reference to FIGS. 11A and 11B. The tray moving operation for the tray 80k is performed by the motor M2 (FIG. 2), a drive transmission mechanism (not illustrated), the drive rack 15, the pinion gear 94k, and the rack portion 83k.

First, a tray moving operation (tray pull-out operation) when the toner cartridge 70k is removed from the rotary main body 90 will be described. In a state before the tray pull-out operation is started, the drive rack 15 is located below the position at which it meshes with the pinion gear 94k (FIG. 11A). Further, as described above, in the operation of replacing the toner cartridge 70k, the rotary main body 90 takes the position for replacement of the toner cartridge 70k (FIG. 4B).

When the tray pull-out operation is started, the drive rack 15 slides upward in the apparatus main body 1A by the driving force of the motor M2. While the drive rack 15 moves, the drive rack 15 meshes with the pinion gear 94k, and the pinion gear 94k is rotationally driven.

As illustrated in FIG. 11B, the pinion gear 94k is rotationally driven in an arrow direction in the figure, and thus driving force is input to the rack portion 83k meshing with the pinion gear 94k. As a result, the tray 80k is pushed out of the apparatus and moves from the accommodation position to the take-out position with respect to the rotary main body 90. The moving direction of the tray 80k at this time is guided in a predetermined moving direction Dk according to engagement between the guided portion 82k and the guide portion 97k (FIG. 7A) of the rotary main body 90. As a result of the tray 80k moving from the accommodation position to the take-out position, the toner cartridge 70k is moved from the setting position to the retracted position with respect to the developing unit 50k.

In a state where the tray 80k is located at a take-out position and the toner cartridge 70k is located at the retracted position, the user can install and remove the toner cartridge 70k in and from the tray 80k.

A tray moving operation (tray pull-in operation and tray inserting operation) when the toner cartridge 70 is installed in the rotary main body 90 is performed in a process opposite to the tray pull-out operation. For example, when the user operates a predetermined operation part, the tray pull-in operation is started. When the tray pull-in operation is started, the drive rack 15 slides downward in the apparatus main body 1A according to the driving force of the motor M2. Here, the rotation direction of the motor M2 in the tray pull-in operation is a direction opposite to the tray pull-out operation.

When the pinion gear 94k is rotationally driven in a direction opposite to the arrow in FIG. 11B, driving force is input to the rack portion 83k meshing with the pinion gear 94k. As a result, the tray 80k is drawn into the apparatus and moves from the take-out position to the accommodation position with respect to the rotary main body 90.

The moving direction of the tray 80k is guided in the moving direction Dk (the direction opposite to the arrow in FIG. 11B) by engagement of the guided portion 82k with the guide portion 97k of the rotary main body 90 (FIG. 7A). As a result of the tray 80k moving from the take-out position to the accommodation position, the toner cartridge 70k is moved from the retracted position to the setting position with respect to the developing unit 50k.

Although the movement of the black tray 80k and the toner cartridge 70k has been described above, the other trays 80y to 80c and toner cartridges 70y to 70c are also moved by a similar mechanism. That is, at the posture for replacement of each toner cartridge, the drive rack 15 transmits the drive to the pinion gears 94y to 94c.

The motor M2 provided in the apparatus main body 1A and the transmission device including the drive rack 15 (15L and 15R) and the drive transmission mechanism constitute the drive device 98 for driving the moving device 85 provided in the rotary main body 90.

As described above, in the present example, the plurality of moving devices 85k to 85y corresponding to the plurality of toner cartridges 70k to 70y are disposed in the rotary main body 90. The drive device 98 of the apparatus main body 1A is a common drive device that drives the plurality of moving devices 85k to 85y (a plurality of driven devices) of the rotary main body 90.

In the present example, a drive target of the drive device 98 is switched according to rotation of the rotary main body 90. In other words, the drive device of the present example includes the drive rack 15 as a transmission member that transmits the driving force of the drive source. The drive device can take a state in which the transmission member engages with a first driven portion (pinion gear 94k) so as to be drive-transmittable and a state in which the transmission member engages with a second driven portion (pinion gear 94m) so as to be drive-transmittable. Further, the drive device can take a state in which the transmission member is separated from the first driven portion and the second driven portion.

As described above, the pinion gears 94y to 94k are held by the rotary main body 90. Therefore, when the rotary main body 90 rotates, it is preferable that engagement between the pinion gears 94y to 94k and the drive rack 15 be released.

FIG. 12A shows a state in which the tray 80k is inside the rotary main body 90 (a state in which the tray is at the accommodation position). FIG. 12B shows a state in which the tray 80k has moved to the outside of the rotary main body 90 (a state in which the tray has moved to the take-out position).

As illustrated in FIG. 12A, when the tray 80k is inside the rotary main body 90, the drive rack 15 is located at a lower portion in the apparatus main body 1A. At this time, the drive rack 15 is retracted from the pinion gear 94k. Therefore, the rotary main body 90 can be rotated without being obstructed by the drive rack 15. More specifically, the drive rack 15 can be retracted out of the rotation locus of the rotary main body 90 indicated by a dotted line in FIGS. 12A and 12B.

As described above, by rotationally driving the motor M2 in the forward and reverse directions, the tray 80 set in the rotary main body 90 can be moved from the accommodation position to the take-out position and from the take-out position to the accommodation position with respect to the rotary main body 90. That is, the drive device of the present example can drive each moving device of the rotary such that the toner cartridge moves from the setting position to the retracted position, and can drive each moving device such that the toner cartridge moves from the retracted position to the setting position.

Here, as described above, in the present example, the amount of movement of the tray 80 at the time of toner cartridge replacement is changed in accordance with the size of the toner cartridge 70. Specifically, as illustrated in FIGS. 7A and 7B, the moving distance L1 when the black tray 80k moves from the accommodation position to the take-out position is longer than the moving distance L2 when the other trays 80y to 80c move from the accommodation position to the take-out position.

Therefore, in the present example, when the toner cartridges 70y to 70k are moved from the setting positions to the retracted positions, the value obtained by dividing the speed of the rack portion 83k by the speed of the drive rack 15 is greater than the value obtained by dividing the speed of the rack portions 83y to 83c by the speed of the drive rack 15.

For example, as illustrated in FIG. 10, the pinion gear 94y is a stepped gear, and the pitch circle radius of a small-diameter gear 942 meshing with the rack portion 83y is made smaller than the pitch circle radius of a large-diameter gear 94l meshing with the drive rack 15. The pinion gears 94m and 94c are similarly stepped gears. On the other hand, the pinion gear 94k has the same pitch circle radius at a portion meshing with the drive rack 15 and a portion meshing with the rack portion 83k. At this time, the pitch circle radius of the pinion gear 94k can be the same as the pitch circle radius of the large-diameter gear 94l of the pinion gears 94y to 94c. According to this configuration, even if the moving distance of drive rack 15 is the same, the moving distance of rack portion 83k can be made larger than the moving distances of other rack portions 83y to 83c. That is, the moving distance L1 when the black tray 80k moves from the accommodation position to the take-out position can be made greater than the moving distance L2 when the other trays 80y to 80c move from the accommodation position to the take-out position.

Further, since the pinion gears 94y to 94c are stepped gears, the moving distance L1 of the tray 80k can be made greater than the moving distance L2 of the other trays 80y to 80c while the pinion gears 94y to 94k receive the driving force from the same drive rack 15.

Instead of (or in combination with) the configuration in which the pinion gears 94y to 94c are stepped gears, the pinion gear 94k may be a stepped gear. In this case, a portion of the pinion gear 94k that meshes with the drive rack 15 may be a small-diameter gear, and a portion of the pinion gear 94k that meshes with the rack portion 83k may be a large-diameter gear having a larger pitch circle radius than the small-diameter gear. In addition, the stepped gear is an example of a speed reduction mechanism, and may be replaced with a known speed reduction mechanism in which the amount of movement of a member on the output side (side of the tray 80) is smaller than the amount of movement of a member on the input side (drive source side).

The amount of movement of the drive rack 15 when the toner cartridge 70k moves from the setting position to the retracted position may be greater than the amount of movement of drive rack 15 when the toner cartridges 70y to 70c move from the setting positions to the retracted positions.

Meanwhile, as the distance by which the toner cartridge 70 moves from the setting position to the retracted position is shorter, the moving time of the toner cartridge 70 can be shortened, and the time for the user to wait for the toner cartridge 70 to move can be shortened. If the amount of movement of the drive rack 15 with respect to the toner cartridge 70k is greater than the amount of movement of the drive rack 15 with respect to the toner cartridges 70y to 70c as described above, the time for the user to wait for the toner cartridges 70y to 70c to move can be shortened.

With the above configuration, the moving distance L1 can be made longer than the moving distance L2. These configurations can be used in combination.

Although the configuration in which the driven part includes the pinion gear 94 that meshes with both the drive rack 15 and the rack portion 83 has been described, the driven part may include a gear that meshes with the drive rack 15 and a gear that meshes with the rack 83.

The configuration of the moving device 85 that moves the tray 80 is not limited to a so-called rack and pinion configuration. For example, a member corresponding to the pinion gear 94 may be replaced with a roller that rotates by being driven by the motor M2, and the tray 80 may be moved by friction between the roller and the tray 80.

In the case of using a roller that rotates by being driven by the motor M2, the roller and the toner cartridge 70 may be brought into contact with each other. In this case, the toner cartridges 70y to 70k can be directly installed in and removed from the rotary main body 90 without passing through the trays 80y to 80k. In this case, the moving device 85 includes a roller. Further, it can be said that the rotary assembly 90A includes the rotary main body 90 and the toner cartridges 70y to 70k.

### Guide of Toner to Discharge Opening of Toner Cartridge

The toner stored in the toner storage portion 71a of the toner cartridge 70 is discharged from the discharge opening 71b, and the toner discharged from the discharge opening 71b is stored in the developing storage chamber 53a through the receiving opening 53b of the developing unit 50. That is, the developing storage chamber 53a (first storage chamber) of the developing unit 50 and the toner storage portion 71a (second storage chamber) of the toner cartridge 70 communicate with each other. The opening of the communication hole on the side of the developing storage chamber 53a is the receiving opening 53b (receiving opening), and the opening on the side of the toner storage 71a is the discharge opening 71b (discharge opening).

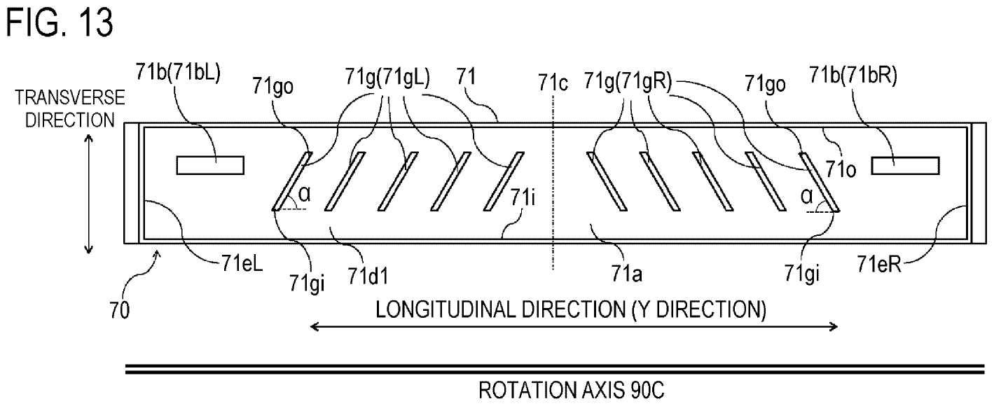

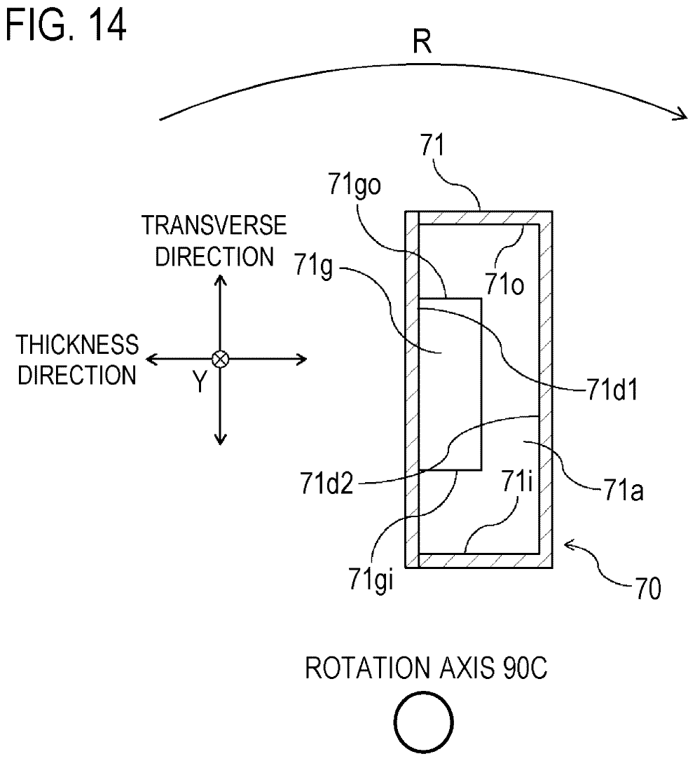

A configuration for discharging the toner stored in the toner storage portion 71a from the discharge opening 71b will be described with reference to FIGS. 13 and 14. In the following description, it is assumed that the toner cartridge 70 is installed in the rotary main body 90.

FIG. 13 is a diagram showing an internal structure of the toner cartridge 70, and illustrates a configuration when viewed in a thickness direction orthogonal to both the longitudinal direction and the transverse direction of the toner cartridge 70. FIG. 14 is a cross-sectional view showing the internal structure of the toner cartridge 70, and specifically, is a cross-sectional view of a cross section of the toner cartridge 70 in a direction orthogonal to the rotation axis 90C as viewed in the Y direction.

In the following description of the toner cartridge 70, the Y direction which is the rotation axis direction is referred to as a longitudinal direction. In addition, a direction that is a rotation radial direction of the rotary and is orthogonal to the longitudinal direction is referred to as a transverse direction. Further, a direction orthogonal to the longitudinal direction and the transverse direction of the toner cartridge 70 is referred to as a thickness direction of the toner cartridge 70.

As illustrated in FIG. 13, the toner frame 71 of the present example includes a plurality of discharge openings 71b including a discharge opening (first opening, first discharge opening) 71bL and a discharge opening (second opening, second discharge opening) 71bR, and a plurality of guide portions 71g (second guide portions) including a left-side guide 71gL and a right-side guide 71gR. As illustrated in FIG. 14, the inner surface of the toner frame 71 forming the toner storage portion 71a includes an inner surface 71d1 (second surface) facing a direction from the upstream toward the downstream in a turning movement direction (R direction) of the toner cartridge 70 about the rotation axis 90C according to rotation of the rotary. In the present example, the discharge openings 71b are provided on the inner surface 71d1, and the guides 71g are provided on the inner surface 71d1 to guide at least the moving direction of the toner moving along the inner surface 71d1 in a predetermined direction.

As illustrated in FIG. 13, each of the discharge openings 71bL and 71bR has a function as a discharge opening 71b that communicates the toner storage portion 71a, which is the inside of the toner frame 71, with respect to the outside of the toner frame 71 on both longitudinal end sides of the toner storage portion 71a. The discharge opening 71bL is located on one end side with respect to a central portion 71c of the toner frame 71 (toner storage portion 71a) in the longitudinal direction, and is located between the central portion 71c and a left side surface 71eL. The discharge opening 71bR is located on the other end side with respect to the central portion 71c of the toner frame 71 (toner storage portion 71a) in the longitudinal direction, and is located between the central portion 71c and a right side surface 71eR. The discharge opening 71bL is closer to the left side surface 71eL than to the central portion 71c in the longitudinal direction, and the discharge opening 71bR is closer to the right side surface 71eR than to the central portion 71c in the longitudinal direction.

As illustrated in FIG. 14, in the present example, the guide portion 71g is disposed on the inner surface 71d1 of the toner frame 71. That is, the root of the guide portion 71g is connected to the inner surface 71d1 of the toner frame 71. As a configuration of the inner surface 71d1 of the toner frame 71, a part where the discharge opening 71bL is formed, a part where the discharge opening 71bR is formed, and a part where the guide portion 71g is connected may be discontinuous. The inner surface of the toner frame 71 includes an inner surface 71d2 facing the direction from the downstream toward the upstream in the turning movement direction of the toner cartridge 70 and facing the inner surface 71d1, and a gap is formed between the guide portion 71g provided on the inner surface 71d1 and the inner surface 71d2. Note that the guide portion 71g may not necessarily be disposed on the inner surface 71d1 as long as the same effect is exhibited as the toner guiding function.

As illustrated in FIG. 13, in the present example, the toner frame 71 includes at least one left-side guide 71gL and at least one right-side guides 71gR as a plurality of guide portions arranged in the longitudinal direction. The left-side guide 71gL and the right-side guide 71gR are rib-shaped protrusions protruding from the inner surface 71d1 and extending in directions inclined with respect to the longitudinal direction (the axial direction of the rotation axis 90C), and the directions inclined with respect to the longitudinal direction are different from each other. The left-side guide 71gL is configured to be inclined to guide the toner toward the discharge opening 71bL in the Y direction (in a direction approaching the discharge opening 71bL). The right-side guide 71gR is configured to be inclined to guide the toner toward the discharge opening 71bR in the Y direction (in a direction approaching the discharge opening 71bR).

The left-side guide 71gL and the right-side guide 71gR have different toner guide directions, but have substantially the same basic configuration and function. Therefore, hereinafter, the left-side guide 71gL and the right-side guide 71gR may be collectively referred to as a guide portion 71g, and the discharge opening 71bL and the discharge opening 71bR may be collectively referred to as a discharge opening 71b unless it is necessary to distinguish and describe the same.

Each guide portion 71g is configured to guide toner moving by its own weight in a direction intersecting the longitudinal direction toward the discharge opening 71b in the longitudinal direction.

As illustrated in FIGS. 13 and 14, the guide portion 71g has an outer end 71go (second outer end) far from the rotation axis 90C and an inner end 71gi (second inner end) close to the rotation axis 90C. In the transverse direction, the inner end 71gi is closer to the rotation axis 90C than the outer end 71go is to the rotation axis 90C. In the longitudinal direction, the inner end 71gi is closer to the discharge opening 71b than the outer end 71go is to the discharge opening 71b. When viewed in a direction perpendicular to the inner surface 71d1 as a second receiving surface, an angle α formed by the longitudinal direction and a straight line passing through the inner end 71gi and the outer end 71go is preferably larger than a repose angle of the toner.

As illustrated in FIG. 13, the guide portion 71g is disposed side by side with the discharge opening 71b in the axial direction of the rotation axis 90C. The guide portion 71g has a portion closer to the rotation axis 90C than to the discharge opening 71b when viewed in the axial direction of the rotation axis 90C, and the inner end 71gi is located closer to the rotation axis 90C than to the discharge opening 71b.

As illustrated in FIGS. 13 and 14, the toner frame 71 has an outer side surface 71o far from the rotation axis 90C and an inner side surface 71i close to the rotation axis 90C as inner surfaces forming the toner storage portion 71a. The outer side surface 710 and the inner side surface 71i are surfaces expanding in the thickness direction and face each other in the transverse direction. In the transverse direction, the inner side surface 71i is closer to the rotation axis 90C than the outer side surface 710 is to the rotation axis 90C. In the transverse direction, the outer side surface 710 is located at one end of the toner storage portion 71a, and the inner side surface 71i is located at the other end of the toner storage portion 71a. The outer side surface 710 and the inner side surface 71i face the toner storage portion 71a, and can be said to be surfaces that form the toner storage chamber portion 71a.

As illustrated in FIGS. 13 and 14, the toner frame 71 has an inner surface 71d1 and an inner surface 71d2 as inner surfaces forming the toner storage portion 71a. The inner surface 71d1 and the inner surface 71d2 are surfaces extending in a direction intersecting the thickness direction (preferably, a direction orthogonal to the thickness direction) and face each other in the thickness direction and the turning movement direction (R direction) of the toner cartridge 70 around the rotation axis 90C. In the thickness direction, the inner surface 71d1 of the toner frame 71 is located at one end of the toner storage 71a, and the inner surface 71d2 is located at the other end of the toner storage portion 71a. The inner surface 71d1 and the inner surface 71d2 face the toner storage portion 71a, and can be said to be surfaces that form the toner storage chamber portion 71a.

The guide portion 71g guides the toner moving from the outer end 71go toward the inner end 71gi in the transverse direction toward the discharge opening 71b in the longitudinal direction.

When the inner surface 71d1 receives the weight of the toner and is inclined with respect to the horizontal direction, and the inclination angle of the inner surface 71d1 with respect to the horizontal direction exceeds a predetermined angle, the toner moves on the inner surface 71d1 along the inner surface 71d1. The inclined posture of the inner surface 71d at this time is an inclined posture at which the normal line of the inner surface 71d1 includes a component in the vertically upward direction, and the outer end of the inner surface 71d1 far from the rotation axis 90C is positioned vertically lower than the inner end close to the rotation axis 90C. At this time, the guide portion 71g guides the toner moving along the inner surface 71d1 toward the discharge opening 71b in the longitudinal direction.

On the other hand, when the inner surface 71d2 receives the weight of the toner and is inclined with respect to the horizontal direction, and the inclination angle of the inner surface 71d2 with respect to the horizontal direction exceeds a predetermined angle, the toner moves on the inner surface 71d2 along the inner surface 71d2. At this time, the toner moves from one of the outer end 71go and the inner end 71gi to the other of the outer end 71go and the inner end 71gi in the transverse direction through a gap between the guide portion 71g and the inner surface 71d2. The toner moving through the gap between the guide portion 71g and the inner surface 71d2 moves without being guided by the guide portion 71g.

The discharge opening 71b communicates with the receiving opening 53b of the developing unit 50, and the toner guided by the guide portion 71g is received in the receiving opening 53b through the discharge opening 71b and stored in the developing storage chamber 53a.

Guide of Toner from Receiving Opening of Developing Unit

The toner stored in the toner cartridge 70 is discharged from the discharge opening 71b and stored in the developing storage chamber 53a through the receiving opening 53b of the developing unit 50.

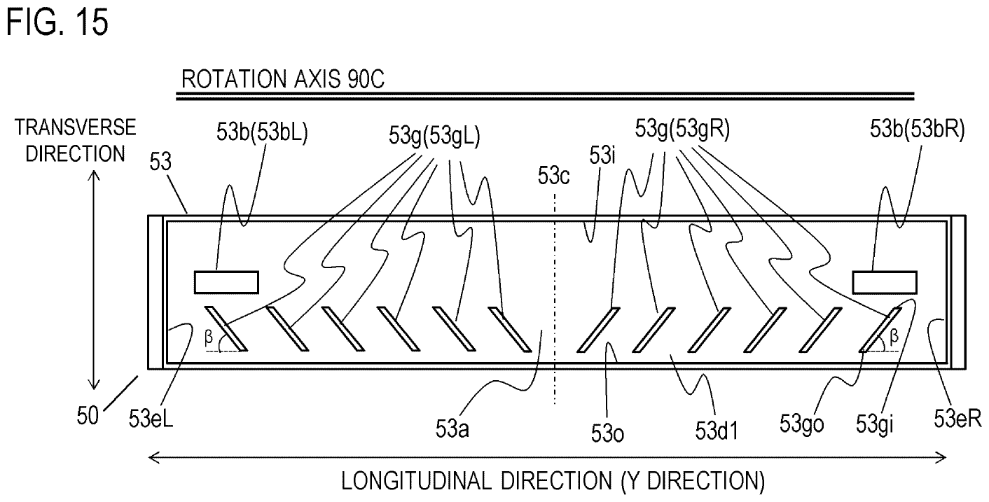

A configuration for efficiently moving the toner received through the receiving opening 53b in the longitudinal direction in the developing storage chamber 53a will be described with reference to FIGS. 15, 16, and 18.

In each figure, the longitudinal direction, the transverse direction, and the thickness direction of the developing unit 50 are defined by the same method as the longitudinal direction, the transverse direction, and the thickness direction of the toner cartridge 70.

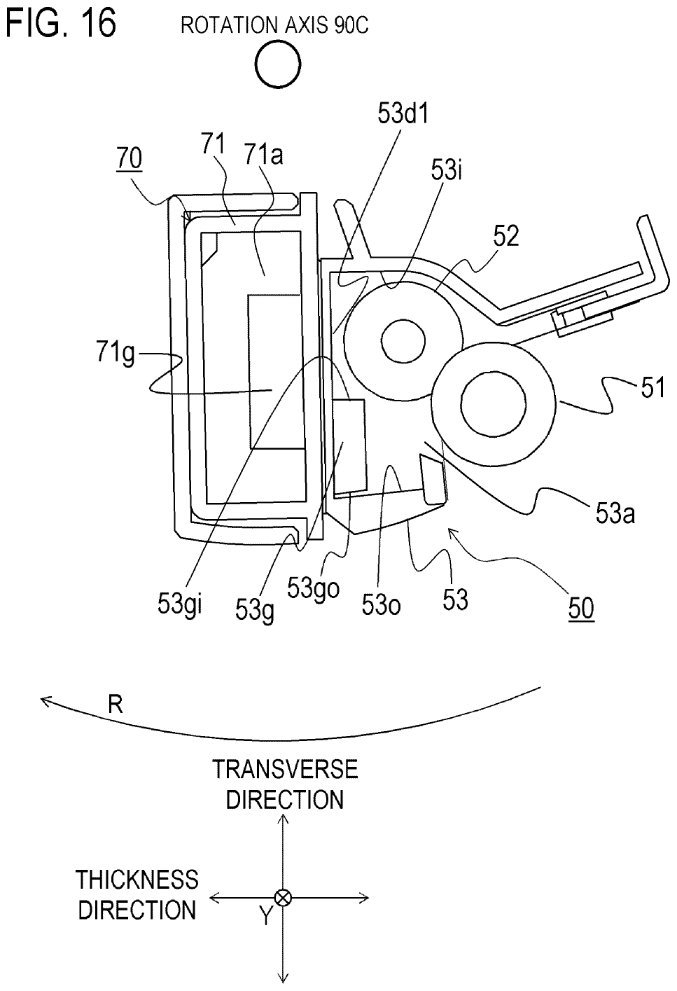

FIG. 15 is a diagram showing an internal structure of the developing unit 50, and illustrates a configuration when viewed in the thickness direction. FIG. 16 is a cross-sectional view showing the internal structure of the developing unit 50 as viewed in the longitudinal direction of the developing unit 50.

As illustrated in FIG. 15, the developing frame 53 of the present example includes a plurality of receiving openings 53b including a receiving opening (first opening) 53bL and a receiving opening (second opening) 53bR, and a plurality of developing guide portions 53g (first guide portions) including a developing left-side guide 53gL and a developing right-side guide 53gR. As illustrated in FIG. 16, the inner surface of the developing frame 53 forming the developing storage chamber 53a includes an inner surface 53d1 (first surface) facing a direction from the downstream to the upstream (a direction opposite to the R direction) in the turning movement direction (R direction) of the developing unit 50 about the rotation axis 90C according to rotation of the rotary. In the present example, the receiving openings 53b are provided in the inner surface 53d1, and the developing guide portions 53g are provided on the inner surface 53d1 to guide at least the moving direction of the toner moving along the inner surface 53d1 in a predetermined direction.

As illustrated in FIG. 15, the receiving openings 53bL and 53bR have a function as the receiving openings 53b that communicates the developing storage chamber 53a, which is the inside of the developing frame 53, with respect to the outside of the developing frame 53 on both longitudinal end sides of the developing storage chamber 53a. The receiving opening 53bL is located on one end side with respect to the developing central portion 53c of the developing frame 53 (developing storage chamber 53a) in the longitudinal direction, and is located between the developing central portion 53c and a developing left-side surface 53eL. The receiving opening 53bR is located on the other end side with respect to the developing central portion 53c of the developing frame 53 (developing storage chamber 53a) in the longitudinal direction, and is located between the developing central portion 53c and a developing right-side surface 53eR. In the present example, the receiving opening 53bL is closer to the developing left-side surface 53eL than to the developing central portion 53c in the longitudinal direction, and the receiving opening 53bR is closer to the developing right-side surface 53eR than to the developing central portion 53c in the longitudinal direction.

As illustrated in FIGS. 15 and 16, the developing frame 53 has a developing outer side surface 530 far from the rotation axis 90C and a developing inner side surface 53i close to the rotation axis 90C as inner surfaces forming the developing storage chamber 53a. The developing outer side surface 530 and the developing inner side surface 53i are surfaces expanding in the thickness direction and face each other in the transverse direction. In the transverse direction, the developing inner side surface 53i is closer to the rotation axis 90C than the developing outer side surface 530 is to the rotation axis 90C. In the transverse direction, the developing outer side surface 530 is located at one end of the developing storage chamber 53a, and the developing inner side surface 53i is located at the other end of the developing storage chamber 53a.

As illustrated in FIG. 16, in the present example, the developing guide portion 53g is disposed on the inner surface 53d1 of the developing frame 53. That is, the root of the developing guide portion 53g is connected to the inner surface 53d1 of the developing frame 53. The receiving opening 53bL and the receiving opening 53bR are also formed on the inner surface 53d1 of the developing frame 53. As a configuration of the inner surface 53d1 of the developing frame 53, a portion where the receiving opening 53bL is formed, a portion where the receiving opening 53bR is formed, and a portion to which the developing guide portion 53g is connected may be discontinuous. Note that the developing guide portion 53g is not necessarily disposed on the inner surface 53d1 as long as the same effect is exhibited as the toner guiding function.

As illustrated in FIG. 15, in the present example, the developing frame 53 includes at least one developing left-side guide 53gL and at least one developing right-side guide 53gR as a plurality of guide portions arranged in the longitudinal direction. The developing left-side guide 53gL and the developing right-side guide 53gR are rib-shaped protruding portions protruding from the inner surface 53d1 and extending in directions inclined with respect to the longitudinal direction (the axial direction of the rotation axis 90C), and the directions inclined with respect to the longitudinal direction are different from each other. The developing left-side guide 53gL is configured to be inclined to guide the toner such that the toner is away from the receiving opening 53bL in the Y direction (in a direction away from the receiving opening 53bL). The developing right-side guide 71gR is configured to be inclined to guide the toner such that the toner is away from the receiving opening 53bR in the Y direction (in a direction away from the receiving opening 53bR).

The developing left-side guide 53gL and the developing right-side guide 53gR have different toner guide directions, but have substantially the same basic configuration and function. Therefore, hereinafter, the developing left-side guide 53gL and the developing right-side guide 53gR may be collectively referred to as a developing guide 53g, and the receiving opening 53bL and the receiving opening 53bR may be collectively referred to as a receiving opening 53b unless it is necessary to distinguish and describe the same.

Each of the developing guide portions 53g is configured to guide the toner moving in the transverse direction by its own weight toward the developing central portion 53c in the longitudinal direction (so as to be away from the receiving opening 53b).

As illustrated in FIGS. 15 and 16, the developing guide portion 53g has an outer end 53go (first outer end) far from the rotation axis 90C and an inner end 53gi (first inner end) close to the rotation axis 90C. In the transverse direction, the inner end 53gi is closer to the rotation axis 90C than the outer end 53go is to the rotation axis 90C. When viewed in a direction perpendicular to the inner surface 53d1 as a first receiving surface, an angle β formed by the longitudinal direction and a straight line passing through the inner end 53gi and the outer end 53go is preferably larger than a repose angle of the toner.

As illustrated in FIG. 15, the developing guide portion 53g is at a position further from the rotation axis 90C than the receiving opening 53b is from the rotation axis 90C when viewed in the axial direction of the rotation axis 90C.

As illustrated in FIG. 15, at least one of the plurality of developing right-side guides 53gR is disposed on the developing frame inner surface 53d1 to overlap the receiving opening 53bR in the transverse direction. That is, at least one of the plurality of developing right-side guides 53gR is disposed to have a portion overlapping the receiving opening 53bR when viewed in a direction orthogonal to the axial direction of the rotation axis 90C. In other words, a virtual plane orthogonal to the axial direction of the rotation axis 90C intersects both of at least one of the plurality of developing right-side guides 53gR and the receiving opening 53bR. In addition, it can also be said that the position of at least one of the plurality of developing right-side guides 53gR and the position of the receiving opening 53bR overlap in the axial direction of the rotation axis 90C.

The plurality of developing right-side guides 53gR include a guide (first guide portion) having a portion overlapping the receiving opening 53bR and a guide (second guide portion) that does not overlap the receiving opening 53bR when viewed in the direction orthogonal to the axial direction. Among these, the latter developing right-side guide 53gR is inclined with respect to the axial direction such that the outer end 53go far from the rotation axis 90C is located further away from the receiving opening 53bR than the inner end 53gi close to the rotation axis 90C in the axial direction. Further, the latter developing right-side guide 53gR is inclined with respect to the axial direction such that the outer end 53go far from the rotation axis 90C is located closer to the longitudinal center of the developing storage chamber 53a than the inner end 53gi close to the rotation axis 90C. That is, the latter developing right-side guide 53gR is inclined with respect to the axial direction such that the outer end 53go is located further away from the receiving opening 53bR disposed at the longitudinal end than the inner end 53gi.

Similarly, as illustrated in FIG. 15, at least one of the plurality of developing left-side guides 53gL is disposed on the developing frame inner surface 53d1 to overlap the receiving opening 53bL in the transverse direction. That is, at least one of the plurality of developing left-side guides 53gL is disposed to have a portion overlapping the receiving opening 53bL when viewed in a direction orthogonal to the axial direction of the rotation axis 90C. In other words, a virtual plane orthogonal to the axial direction of the rotation axis 90C intersects both of at least one of the plurality of developing left-side guides 53gL and the receiving opening 53bL. Further, in the axial direction of the rotation axis 90C, the position of at least one of the plurality of developing left-side guides 53gL and the position of the receiving opening 53bL overlap each other.

The plurality of developing left-side guides 53gL include a guide (first guide portion) having a portion overlapping with the receiving opening 53bL and a guide (second guide portion) not overlapping when viewed in the direction orthogonal to the axial direction. Among these, the latter developing left-side guide 53gL is inclined with respect to the axial direction such that the outer end 53go far from the rotation axis 90C is located further away from the receiving opening 53bL than the inner end 53gi close to the rotation axis 90C in the axial direction. Further, the latter developing left-side guide 53gL is inclined with respect to the axial direction such that the outer end 53go far from the rotation axis 90C is located closer to the longitudinal center of the developing storage chamber 53a than the inner end 53gi close to the rotation axis 90C. That is, the latter developing left-side guide 53gL is inclined with respect to the axial direction such that the outer end 53go is located further away from the receiving opening 53bL disposed at the longitudinal end than the inner end 53gi.

The developing left-side guide 53gL guides the toner received through the receiving opening 53bL on one longitudinal end side in a direction away from the receiving opening 53bL in the longitudinal direction, that is, in a direction of the developing central portion 53C. In addition, the developing right-side guide 53gR guides the toner received through the receiving opening 53bR on the other longitudinal end side in a direction away from the receiving opening 53bR in the longitudinal direction, that is, in a direction of the developing central portion 53C.

When the inner surface 53d1 receives the weight of the toner and is inclined with respect to the horizontal direction, and the inclination angle of the inner surface 53d1 with respect to the horizontal direction exceeds a predetermined angle, the toner moves on the inner surface 53d1 along the inner surface 53d1. The inclined posture of the inner surface 53d at this time is an inclined posture at which the normal line of the inner surface 53d1 includes a component in the vertically upward direction, and the outer end of the inner surface 53d1 far from the rotation axis 90C is positioned vertically lower than the inner end close to the rotation axis 90C. At this time, the developing guide portions 53g guide the toner moving along the inner surface 53d1 such that the toner is away from the receiving opening 53b in the longitudinal direction.

### Rotation of Rotary Assembly and Movement of Toner

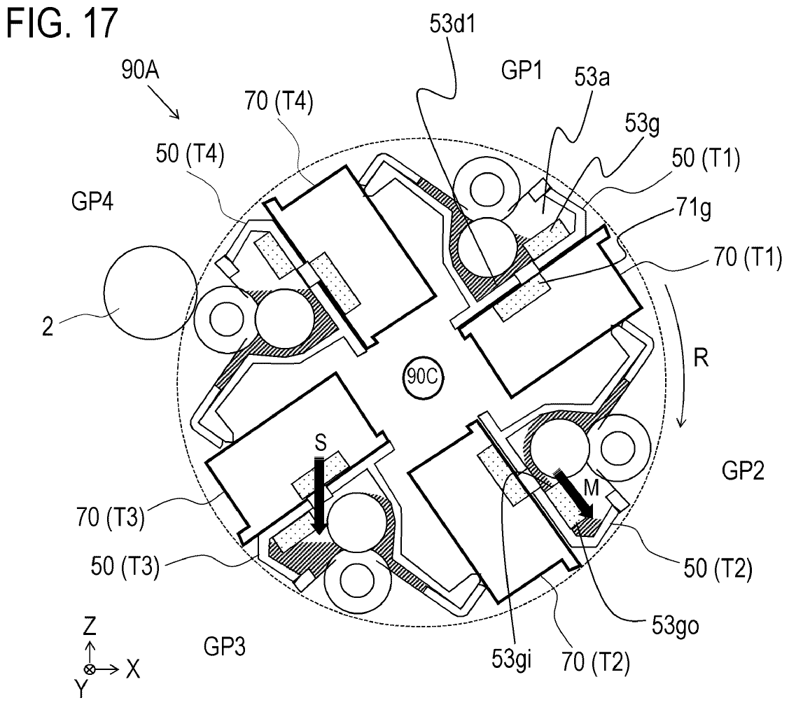

The movement of the toner accompanying the rotation of the rotary assembly 90A will be described with reference to FIG. 17. FIG. 17 is a schematic diagram showing the developing unit 50 rotating around the rotation axis 90C as viewed in the Y direction, and directions are defined by arrows X, Y, and Z illustrated in the figure similarly to FIG. 1 to FIGS. 12A and 12B. In FIG. 17, hatched lines drawn inside the developing storage chamber 53a indicate the agent surface of the toner (the upper surface of the toner) stored in the developing storage chamber 53a or the range in which the toner is present.

In FIG. 17, the rotary assembly 90A rotates in the R direction which is clockwise as viewed in the Y direction. FIG. 17 illustrates only one developing unit 50 among the developing units 50y, 50m, and 50c. That is, FIG. 17 is a diagram schematically illustrating the movement focusing on one of the plurality of developing units 50. The illustrated developing unit 50 may be any of the developing units 50y, 50m, and 50c. Furthermore, in FIG. 17, in order to facilitate understanding, the state of the developing unit 50 at four timings (T1, T2, T3, and T4) is virtually illustrated in one figure. For example, the developing unit 50 at timing T1 is indicated as 50 (T1) in the figure. In the case of the developing unit 50k, the size in the rotary assembly 90A is different from those of the developing units 50y, 50m, and 50c, but the behavior of the toner is similar to that in FIG. 17.

As illustrated in FIG. 17, when the developing unit 50 makes one rotation from a position GP1, the developing unit 50 moves in the order of positions GP1, GP2, GP3, and GP4, and returns to the position GP1. Here, GP4 is a position of the developing unit 50 at timing T4, and is a developing position (developing phase) at which the developing unit 50 develops the electrostatic latent image on the photosensitive drum 2. Furthermore, a position (installation/removal phase) at which the toner cartridge 70 is installed or removed as illustrated in FIGS. 7A and 7B and the like is located between the position GP1 and the position GP2.

### Moving Phase of Toner in Y Direction: Positions GP1 and GP2

While the developing unit 50 moves from the position GP1 to the position GP2, the toner in the developing storage chamber 53a moves toward the developing central portion 53c in the Y direction as illustrated in FIG. 15. As illustrated in FIG. 17, while the developing unit 50 moves to the positions GP1 to GP2, the inner surface 53d1 takes an angle at which the normal line includes a component in the vertically upward direction. As illustrated in FIGS. 7A and 7B, the developing unit 50 takes a posture at which the inner surface 53d1 is parallel to the X direction in the middle between the positions GP1 and GP2. As the developing unit 50 moves from the position GP1 to the position GP2, the inner surface 53d1 is inclined with respect to the horizontal direction such that an outer end far from the rotation axis 90C is positioned vertically lower than an inner end close to the rotation axis 90C. When the inclination angle of the inner surface 53d1 with respect to the horizontal direction exceeds a predetermined angle, the toner moves (slides down) on the inner surface 53d1 by gravity acting on the toner (arrow M).

At this time, the toner moving on the inner surface 53d1 by its own weight comes into contact with the developing guide portion 53g and moves from the inner end 53gi of the developing guide portion 53g toward the outer end 53go. As described above, in the developing guide portion 53g, since the outer end 53go is located closer to the developing central portion 53c than the inner end 53gi, the toner guided by the developing guide portion 53g moves in the direction toward the developing central portion 53c. In other words, the toner in the developing storage chamber 53a moves away from the receiving opening 53b by the action of the developing guide portion 53g.

### Toner Replenishment Phase: Positions GP3 and GP4

While the developing unit 50 moves from the position GP3 to the position GP4, the toner in the toner cartridge 70 is replenished to the developing unit 50. In the present example, the receiving opening 53b of the developing unit 50 is provided on the inner surface 53d1 of the developing frame 53, and the vertical positional relationship with the discharge opening 71b of the toner cartridge 70 is switched while the developing unit 50 rotates from GP2 to the position GP3. That is, at the position GP3, the discharge opening 71b of the toner cartridge 70 is positioned above the receiving opening 53b of the developing unit 50. As a result, the toner stored in the toner storage 71a of the toner cartridge 70 is discharged from the discharge opening 71b and supplied to the developing storage chamber 53a of the developing unit 50 through the receiving opening 53b (arrow S).

Before passing through the positions GP3 and GP4 which are the toner replenishment phases, the developing unit 50 passes through the positions GP1 and GP2 which are toner Y-direction movement phases. The rotation phase of the rotary assembly 90A at the positions GP1 and GP2 becomes a rotation phase (first rotation phase) in which the toner is guided in a direction away from the receiving opening 53b by the action of the developing guide portions 53g in the developing storage chamber 53a. The rotation phase of the rotary assembly 90A at the positions GP3 and GP4 becomes a rotation phase (second rotation phase) in which the positional relationship between the toner cartridge 70 and the developing unit 50 becomes a positional relationship in which the toner can move from the discharge opening 71b to the receiving opening 53b. In the present example, for example, the first rotation phase is followed by the second rotation phase during one rotation of the rotary assembly 90A from the installation/removal phase. As a result, in the first rotation phase before the second rotation phase, the toner in the vicinity of the receiving opening 53b in the developing storage chamber 53a moves toward the developing central portion 53c in the Y direction, and a space for receiving the toner from the receiving opening 53b is secured in the developing storage chamber 53a. As a result, in the second rotation phase, the toner can be efficiently received from the receiving opening 53b into the developing storage chamber 53a.

### Guide Effect of Developing Guide

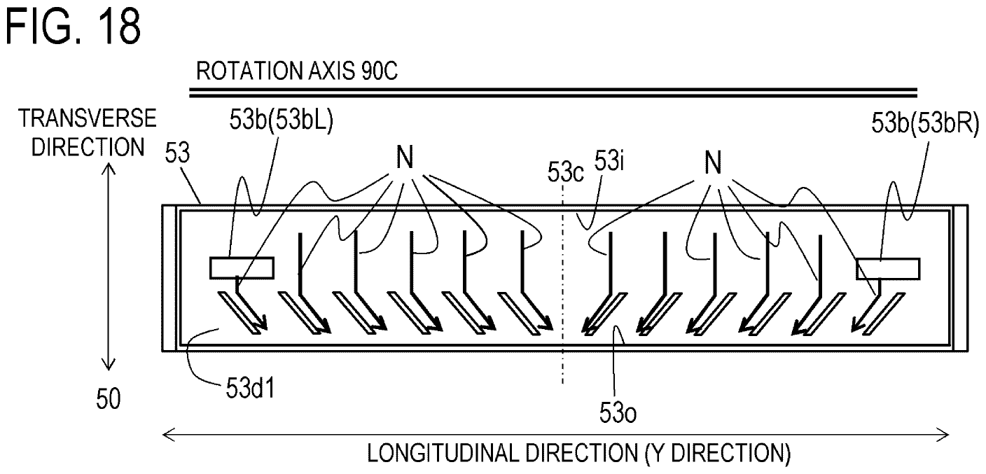

FIG. 18 is a schematic diagram showing a state in which the developing guide portion 53g guides toner moving in the developing storage chamber 53a of the developing unit 50. When the inner surface 53d1 receives the weight of the toner and is inclined with respect to the horizontal direction, and the inclination angle of the inner surface 53d1 with respect to the horizontal direction exceeds a predetermined angle, the toner moves along the inner surface 53d1 from the inner end 53gi toward the outer end 53go of the developing guide portion 53g. While moving along the inner surface 53d1, the toner comes into contact with the developing guide portion 53g and is guided in the direction of the arrow N, thereby being guided toward the developing central portion 53c in the longitudinal direction.

As described above, according to the configuration of the present example, since the toner replenished from the toner cartridge 70 moves away from the receiving opening 53b in the longitudinal direction, the toner does not stay in the vicinity of the receiving opening 53b in the developing storage chamber 53a of the developing unit 50. Therefore, the toner distribution in the developing storage chamber 53a of the developing unit 50 is kept uniform.

### Example 2

In example 2 of the present invention, one discharge opening 71b of a toner cartridge 170 and one receiving opening 53b of a developing unit 150 communicate with each other on one end side in the longitudinal direction. The guide portion in the developing unit 150 guides the toner in the vicinity of the receiving opening 53b such that the toner moves away from the receiving opening 53b in the longitudinal direction.

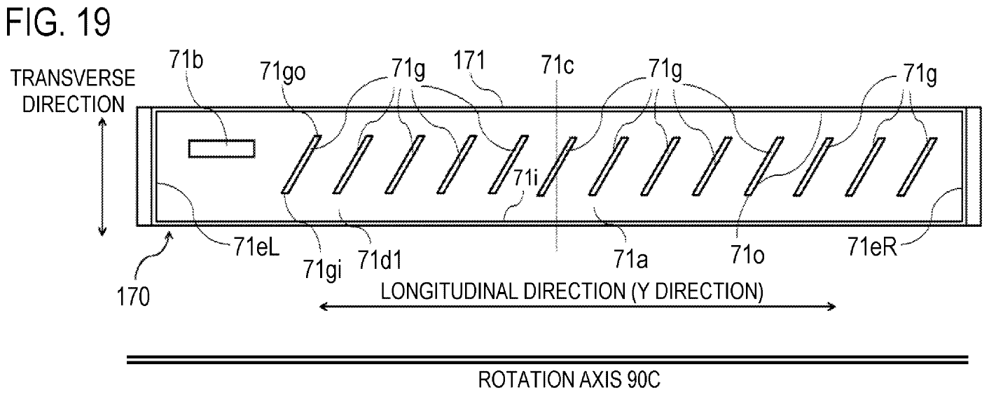

The toner cartridge 170 according to example 2 will be described with reference to FIG. 19. In example 2, the same components as those described in example 1 are denoted by the same reference numerals, and detailed description thereof is omitted in principle. FIG. 19 is a diagram showing an internal structure of the toner cartridge 170 according to example 2.

The toner cartridge 170 according to example 2 is different from the toner cartridge 70 according to example 1 with respect to disposition of the guide portion 70g and the discharge opening 71b. That is, the toner frame 71 of the toner cartridge 70 of example 1 includes the two discharge openings 71bL and 71bR. On the other hand, a toner frame 171 of the toner cartridge 170 of the present example includes one discharge opening 71b. The shape and disposition of the discharge opening 71b of the present example are the same as the shape and disposition of the discharge opening 71bL of example 1.

The toner frame 171 includes at least one guide portion 71g. In the toner frame 171 of the present example, a plurality of guide portions 71g is arranged in the longitudinal direction. The guide portion 71g in the present example has the same shape as the left-side guide 71gL of example 1. In the longitudinal direction, the guide portion 71g is disposed between the central portion 71c of the toner frame 171 and the discharge opening 71b and between the central portion 71c and a right-side surface 71eR. As in example 1, there is a gap between an inner surface 71d2 as a second receiving surface and the guide portion 71g.

### Developing Unit of Example 2

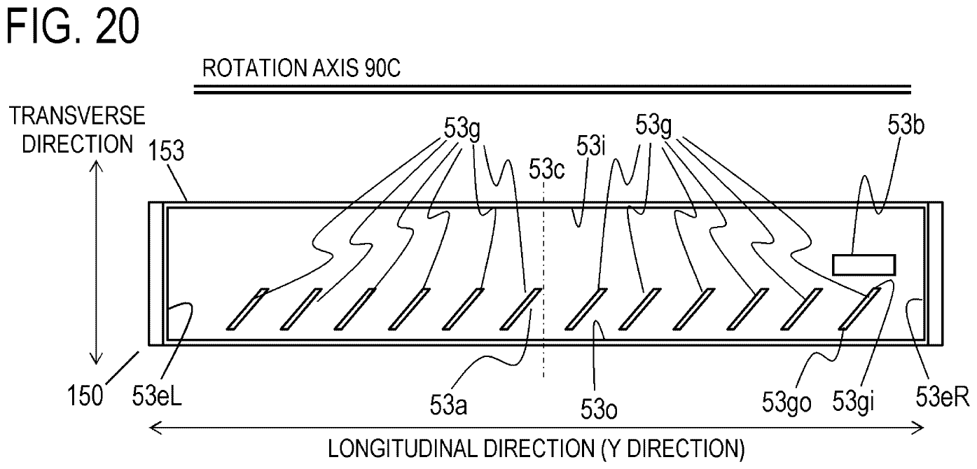

The developing unit 150 according to example 2 will be described with reference to FIG. 20. FIG. 20 is a diagram showing an internal structure of the developing unit 150, and illustrates a configuration when viewed in the thickness direction.

The developing unit 150 according to example 2 is different from the developing unit 50 according to example 1 with respect to disposition of the developing guide portion 53g and the receiving opening 53b. That is, the developing frame 53 of the developing unit 50 of example 1 includes the receiving openings 53bL and 53bR. On the other hand, a developing frame 153 of the developing unit 150 of example 2 includes one receiving opening 53b. When the toner cartridge 170 is set in the rotary, the discharge opening 71b of the toner cartridge 170 and the receiving opening 53b communicate with each other. The shape of the receiving opening 53b of example 2 is the same as the shape of the receiving opening 53bL of example 1.

The developing frame 153 of example 2 includes a plurality of developing guide portions 53g. The developing guide portions 53g in example 2 have the same shape as the developing left-side guide 53gL in example 1. In the longitudinal direction, the developing guide portion 53g is disposed between the developing central portion 53c and the receiving opening 53b of the developing frame 153 and between the developing central portion 53c and the developing right-side surface 53eR. The developing guide portions 53g are inclined with respect to the axial direction such that an outer end 53go far from the rotation axis 90C is located on one end side of the developing storage chamber 53a in the axial direction, and an inner end 53gi close to the rotation axis 90C is located on the other end side.

As illustrated in FIG. 20, at least one of the plurality of developing guide portions 53g is disposed on the developing frame inner surface 53d1 to overlap the receiving opening 53b in the transverse direction. That is, at least one of the plurality of developing guide portions 53g is disposed to have a portion overlapping the receiving opening 53b when viewed in a direction orthogonal to the axial direction of the rotation axis 90C. In other words, it can also be said that a virtual plane orthogonal to the axial direction of the rotation axis 90C intersects both of at least one of the plurality of developing guide portions 53g and the receiving opening 53b, and in the axial direction of the rotation axis 90C, the position of at least one of the plurality of developing guide portions 53g and the position of the receiving opening 53b overlap each other.

In the present example, the rotary main body 90 (the rotary assembly 90A) also rotates, and the toner also moves from the developing inner side surface 53i of the developing storage chamber 53a toward the developing outer side surface 530 in the transverse direction. When the toner moves from the developing inner side surface 53i to the developing outer side surface 530 of the developing storage chamber 53a, the toner is guided by the developing guide portions 53g in a direction away from the receiving opening 53b in the longitudinal direction.

The shape and disposition of the discharge opening 71b and the receiving opening 53b may be the same as the shape and disposition of the discharge opening 71bR and the receiving opening 53bR in example 1. In this case, the guide portion 71g of the toner frame 171 has the same shape as the right-side guide 71gR in example 1, and the developing guide portions 53g of the developing frame 153 have the same shape as the developing right-side guide 53gR in example 1. The guide portion 71g can be disposed between the central portion 71c of the toner frame 171 and the discharge opening 71b and between the central portion 71c and the left side surface 71eL. Further, the developing guide portions 53g can be disposed between the developing central portion 53c and the receiving opening 53b of the developing frame 153 and between the developing central portion 53c and the developing left-side surface 53eL.

### Example 3

In example 3 of the present invention, one discharge opening 71b of a toner cartridge 270 and one receiving opening 53b of the developing unit 250 communicate with each other at the center in the longitudinal direction. A guide portion in the developing unit 250 guides the toner in the vicinity of the receiving opening 53b such that the toner moves away from the receiving opening 53b in the longitudinal direction.

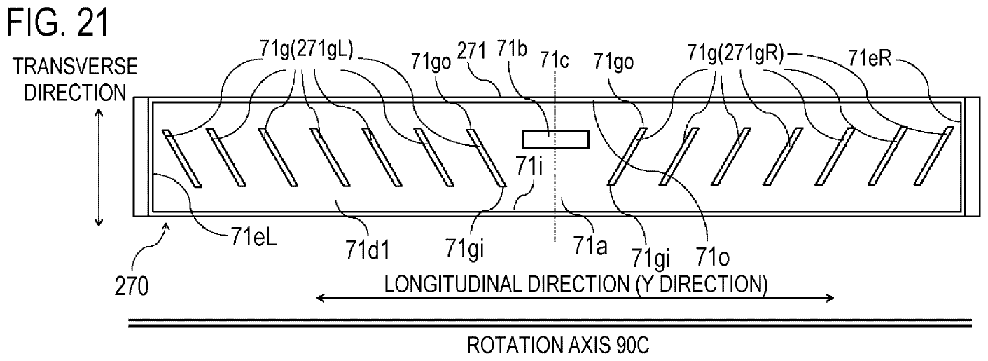

The toner cartridge 270 according to example 3 will be described with reference to FIG. 21. In example 3, the same components as those described in example 1 are denoted by the same reference numerals, and detailed description thereof is omitted in principle. FIG. 21 is a diagram showing an internal structure of the toner cartridge 270 according to example 3.

The toner cartridge 270 according to example 3 is different from the toner cartridge 70 according to example 1 with respect to disposition of the guide portions 70g and the discharge opening 71b. That is, the toner frame 71 of the toner cartridge 70 of example 1 includes the two discharge openings 71bL and 71bR. On the other hand, a toner frame 271 of the toner cartridge 270 of the present example includes one discharge opening 71b. The shape of the discharge opening 71b of the present example is the same as the shape of the discharge opening 71b of example 1. The discharge opening 71b of the present example is disposed at a position overlapping the central portion 71c of the toner frame 271 in the longitudinal direction.

In addition, the toner frame 271 of the present example includes a plurality of guide portions 71g. More specifically, the toner frame 271 of the present example includes at least one left-side guide 71gL and at least one right-side guide 71gR. In the present example, the toner frame 271 includes a plurality of left-side guides 71gL and a plurality of right-side guides 71gR. The left-side guides 71gL and the right-side guides 71gR guide the toner toward the discharge opening 71bR in the Y direction.

In the present example, the right-side guides 71gR have the same shape as the left-side guide 71gL in example 1, and the left-side guides 71gL have the same shape as the right-side guide 71gR in example 1. In the longitudinal direction, the left-side guides 271gL are disposed between a left side surface 71eL of the toner frame 271 and the discharge opening 71b, and the right-side guides 271gR are disposed between a right side surface 71eR and the discharge opening 71b. As in example 1, there is a gap between an inner surface 71d2 as the second receiving surface and the guide portion 71g.

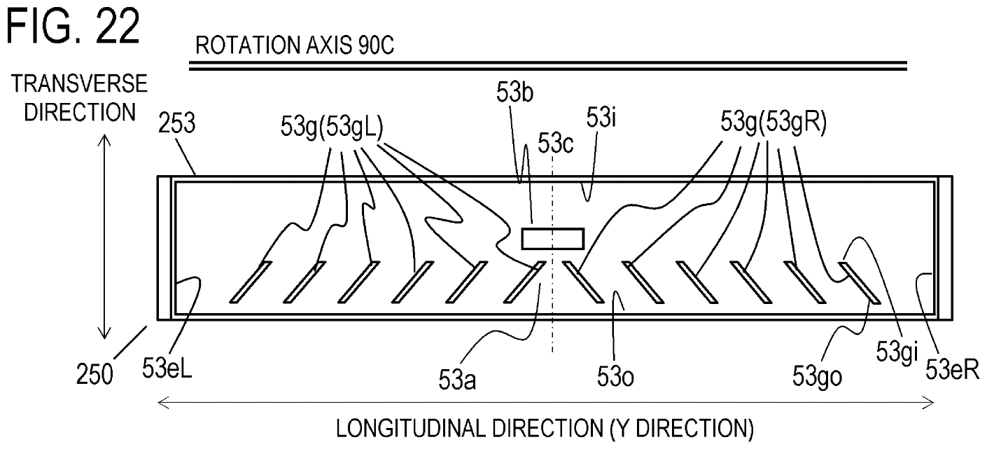

The developing unit 250 according to example 3 will be described with reference to FIG. 22. In example 3, the same components as those described in example 1 are denoted by the same reference numerals, and detailed description thereof is omitted in principle. FIG. 22 is a diagram showing an internal structure of the developing unit 250 according to example 3.

The developing unit 250 according to example 3 is different from the developing unit 50 according to example 1 with respect to disposition of the developing guide portion 50g and the receiving opening 53b. That is, the developing frame 53 of the developing unit 50 of example 1 includes the receiving openings 53bL and 53bR. On the other hand, the developing frame 253 of the developing unit 250 of the present example includes one receiving opening 53b. The shape of the receiving opening 53b of the present example is the same as the shape of the receiving opening 53b of example 1. In addition, the receiving opening 53b of the present example is disposed at a position overlapping the developing central portion 53c of a developing frame 253 in the longitudinal direction.

The developing frame 253 of the present example includes a plurality of developing guide portions 53g. More specifically, the developing frame 253 of the present example includes at least one developing left-side guide 53gL and at least one developing right-side guide 53gR. The developing guide portions 53g of the developing unit 250 according to example 3 are inclined with respect to the axial direction such that the inner end 53gi close to the rotation axis 90C is located closer to the center of the developing storage chamber 53a in the axial direction than the outer end 53go far from the rotation axis 90C.

As illustrated in FIG. 22, at least one of the plurality of developing left-side guides 53gL is disposed on the inner surface 53d1 to overlap the receiving opening 53b in the transverse direction. At least one of the plurality of developing right-side guides 53gR is disposed on the inner surface 53d1 to overlap the receiving opening 53b in the transverse direction. That is, at least one of the plurality of developing left-side guides 53gL is disposed to have a portion overlapping the receiving opening 53b when viewed in a direction orthogonal to the axial direction of the rotation axis 90C. In other words, a virtual plane orthogonal to the axial direction of the rotation axis 90C intersects both of at least one of the plurality of developing left-side guides 53gL and the receiving opening 53b. Further, in the axial direction of the rotation axis 90C, the position of at least one of the plurality of developing left-side guides 53gL and the position of the receiving opening 53b overlap each other. Similarly, at least one of the plurality of developing right-side guides 53gR is disposed to have a portion overlapping the receiving opening 53b when viewed in a direction orthogonal to the axial direction of the rotation axis 90C. In other words, a virtual plane orthogonal to the axial direction of the rotation axis 90C intersects both of at least one of the plurality of developing right-side guides 53gR and the receiving opening 53b. Further, in the axial direction of the rotation axis 90C, the position of at least one of the plurality of developing right-side guides 53gR and the position of the receiving opening 53b overlap each other.

The developing left-side guides 53gL and the developing right-side guides 53gR guide the toner in a direction away from the receiving opening 53b. In the present example, the developing right-side guides 53gR have the same shape as the developing left-side guide 53gL of example 1, and the developing left-side guides 353gL have the same shape as the developing right-side guide 71gR of example 1. In the longitudinal direction, the developing left-side guides 53gL are disposed between the developing left-side surface 53eL of the developing frame 253 and the receiving opening 53b, and the developing right-side guides 53gR are disposed between the developing right-side surface 53eR and the receiving opening 53b.

In the present example, the rotary main body 90 (the rotary assembly 90A) also rotates, and the toner also moves from the developing inner side surface 53i of the developing storage chamber 53a toward the developing outer side surface 530 in the transverse direction. When the toner moves from the developing inner side surface 53i to the developing outer side surface 530 of the developing storage chamber 53a, the toner is guided by the developing guide portions 53g in a direction away from the receiving opening 53b in the longitudinal direction.

In examples 1 to 3 described above, the developing guide portions 53g in the developing unit are configured to be continuous only with the inner surface 53d1, but may be configured to be continuous with the developing outer side surface 530.

Further, the number of discharge openings of the toner cartridge and the number of receiving openings of the developing unit communicating with the discharge openings may be appropriately selected depending on the configuration of the image forming apparatus.

### Example 4

Example 4 will be described.

### Guide of Toner of Developing Unit

The toner stored in the toner cartridge 70 is discharged from the discharge opening 71b, and is stored in the developing storage chamber 53a through the receiving opening 53b. A configuration for efficiently moving the toner received through the receiving opening 53b in the longitudinal direction will be described.

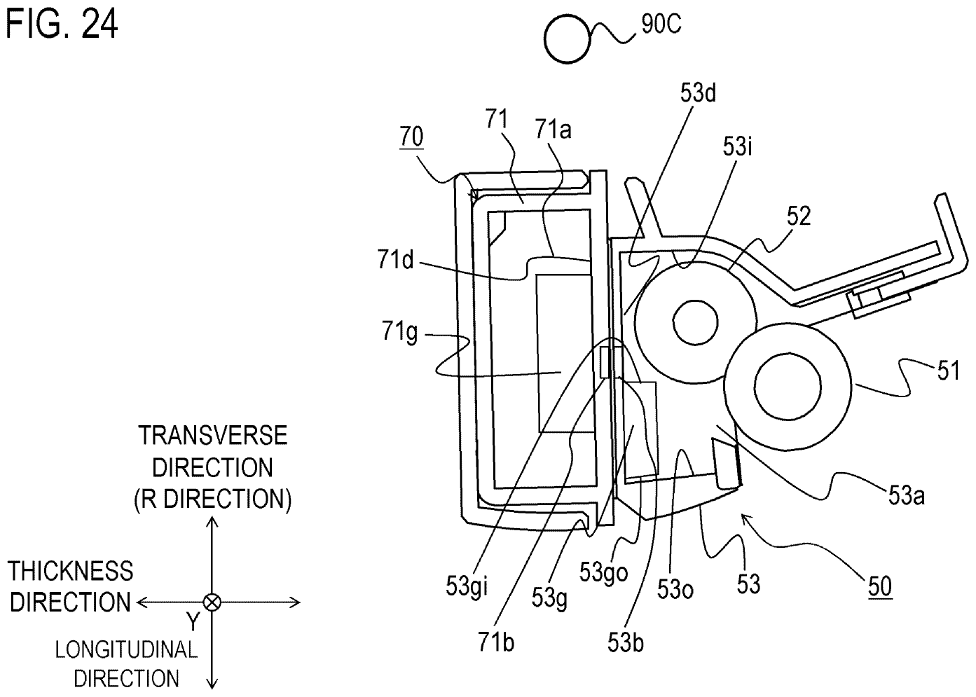

The developing unit 50 will be described with reference to FIG. 24. In the above figures, the longitudinal direction, the transverse direction, and the thickness direction of the developing unit 50 are defined by the same method as the longitudinal direction, the transverse direction, and the thickness direction of the toner cartridge 70. FIG. 24 is a cross-sectional view showing an internal structure of the developing unit 50 as viewed in the longitudinal direction of the developing unit 50.

As illustrated in FIG. 24, the developing frame 53 has the developing storage chamber 53a, and the developing storage chamber 53a has a developing outer side surface 530 and a developing inner side surface 53i facing each other as inner wall surfaces. The developing storage chamber 53a has a developing frame inner surface 53d which is an inner wall surface intersecting the rotation direction of the rotary main body 90. In example 4, the developing frame inner surface 53d is orthogonal to the rotation direction of the rotary main body 90. In other words, the developing frame inner surface 53d faces the rotation direction of the rotary main body 90.

The developing outer side surface 530 and the developing inner side surface 53i are surfaces expanding in the thickness direction and the longitudinal direction and face each other in the transverse direction. In the transverse direction, the developing inner side surface 53i is closer to the rotation axis 90C than the developing outer side surface 530 is to the rotation axis 90C. In the transverse direction, the developing outer side surface 530 is located at one end of the developing storage chamber 53a, and the developing inner side surface 53i is located at the other end of the developing storage chamber 53a.

As illustrated in FIG. 24, the developing guide portion 53g is disposed on the developing frame inner surface 53d in the developing frame 53 in example 4. That is, the root of the developing guide portion 53g is connected to the developing frame inner surface 53d. The developing guide portion 53g is a rib provided to protrude from the developing frame inner surface 53d. The receiving opening 53b is also formed in the developing frame inner surface 53d. That is, the receiving opening 53b is provided in the inner wall surface of the developing storage chamber 53a on which the developing guide portion 53g is provided. Note that the developing frame inner surface 53d in which the receiving opening 53b is formed and the developing frame inner surface 53d to which the developing guide portion 53g is connected may be discontinuous.

As the rotary main body 90 rotates, the toner stored in the developing storage chamber 53a moves in the transverse direction by its own weight. Each developing guide portion 53g is configured to guide the toner moving in the transverse direction by its own weight toward the developing central portion 53c in the longitudinal direction in a direction away from the receiving opening 53b.

The developing guide portion 53g has a developing guide outer end 53go and a developing guide inner end 53gi. The developing guide portion 53g is provided to extend in a direction inclined with respect to the axial direction (longitudinal direction). The developing guide inner end 53gi is a first end that is one end of the developing guide portion 53g in the direction in which the developing guide portion 53g extends, and the developing guide outer end 53go is a second end that is the other end.

In the transverse direction, the developing guide inner end 53gi is closer to the rotation axis 90C than the developing guide outer end 53go is to the rotation axis 90C. In the longitudinal direction, the developing guide outer end 53go is further from the receiving opening 53b than the developing guide inner end 53gi is from the receiving opening 53b. In other words, in the longitudinal direction, the developing guide outer end 53go is closer to the developing central portion 53c than the developing guide inner end 53gi is to the developing central portion 53c.

### Rotation of Rotary Assembly and Movement of Toner

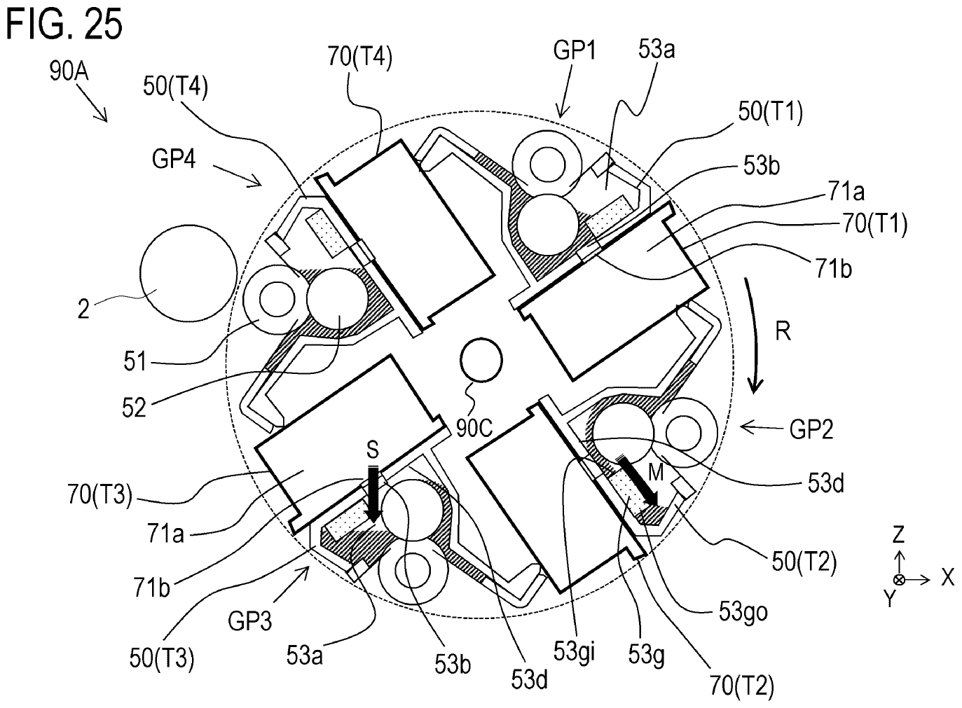

The movement of the toner accompanying the rotation of the rotary assembly 90A will be described with reference to FIG. 25. The definitions of the X direction, the Y direction, and the Z direction in FIG. 25 are the same as those in FIG. 1 to FIGS. 12A and 12B. FIG. 25 is a cross-sectional view of a cross section taken along a virtual plane perpendicular to the rotation axis 90C of the rotary main body 90 as viewed in the Y direction. In FIG. 25, the agent surface of the toner (the upper surface of the toner) stored in the developing storage chamber 53a or the range where the toner is present is indicated by hatching.

The rotary assembly 90A rotates in a direction indicated by arrow R (clockwise in FIG. 25). Here, FIG. 25 virtually illustrates a state at four timings (T1, T2, T3, and T4) of any one (for example, the developing unit 50y) of the developing units 50y, 50m, and 50c in one figure. For example, the state of the developing unit 50y at the timing T1 is represented by a diagram indicated by a reference numeral 50 (T1), and the state of the developing unit 50y at the timing T2 is represented by a diagram indicated by a reference numeral 50 (T2). The state of the developing unit 50y at the timing T3 is represented by a diagram indicated by a reference numeral 50 (T3), and the state of the developing unit 50y at the timing T4 is represented by a diagram indicated by reference numeral 50 (T4). In the case of the developing unit 50k, the size in the rotary assembly 90A is different from those of the developing units 50y, 50m, and 50c, but the behavior of the toner is similar to that in FIG. 25.

The position GP4 is a position of the developing unit 50 at the timing T4 and is a developing position at which the developing unit 50 develops the electrostatic latent image on the photosensitive drum 2. The position GP1 is a position of the developing unit 50 at the timing T1 after the timing T4. The position GP2 is a position of the developing unit 50 at the timing T2 after the timing T1. The position GP3 is a position of the developing unit 50 at the timing T3 after the timing T2. When the developing unit 50 further rotates in the R direction from the position GP3, the developing unit 50 returns to the position GP4.

The rotary assembly 90A rotates clockwise (indicated by arrow R). When the rotary assembly 90A makes one rotation, the developing unit 50 at the position GP1 moves in the order of the positions GP2, GP3, and GP4, and returns to the position GP1.

### Moving Phases GP1 and GP2

There is a position where the developing frame inner surface 53d of the developing unit 50 is parallel to the X direction (horizontal direction) between the positions GP1 and GP2. The inclination angle of the developing frame inner surface 53d with respect to the horizontal direction increases from the position toward the position GP2. The developing frame inner surface 53d has a component whose normal line is vertically upward in the moving phase including the positions GP1 and GP2. Therefore, when the inclination angle of the developing frame inner surface 53d with respect to the horizontal direction exceeds a predetermined angle, the toner moves on the developing frame inner surface 53d by gravity acting on the toner. The movement of the toner is indicated by arrow M.

At this time, the toner moving on the developing frame inner surface 53d by its own weight comes into contact with the developing guide portion 53g provided on the developing frame inner surface 53d, and moves from the developing guide inner end 53gi toward the developing guide outer end 53go. Since the developing guide outer end 53go is located closer to the developing central portion 53c than the developing guide inner end 53gi, the toner guided by the developing guide portion 53g moves to approach the developing central portion 53c in the longitudinal direction (Y direction). As a result, the toner in the developing storage chamber 53a moves toward the developing central portion 53c. In other words, the toner in the developing storage chamber 53a moves away from the receiving opening 53b.

Therefore, the moving phase in which the toner in the developing unit 50 moves to approach the developing central portion 53c in the longitudinal direction is included between the positions GP1 and GP2. The moving phase is a first rotation phase in which the developing guide portion 53g guides the toner in a direction away from the receiving opening 53b in the axial direction (longitudinal direction, Y direction) among rotation phases of the rotary assembly 90A.

At the positions GP1 and GP2, the developing storage chamber 53a is above the toner storage 71a, and the receiving opening 53b is above the discharge opening 71b, but a backflow prevention mechanism is provided such that the toner in the developing storage chamber 53a does not flow into the toner storage 71a.

### Toner Replenishment Phases GP2 to GP4

The toner moves by its own weight from the discharge opening 71b provided in the toner frame inner surface 71d1 of the toner storage 71a to the receiving opening 53b provided in the developing frame inner surface 53d of the developing frame 53. Therefore, the toner is replenished when the discharge opening 71b is located above the receiving opening 53b in the direction of gravity.

In example 4, when the developing unit 50 is at the position GP2, the discharge opening 71b is lower than the receiving opening 53b in the direction of gravity. After the timing (timing at which the toner frame inner surface 71d1 and the developing frame inner surface 53d are along the Z direction) at which the developing unit 50 rotates in the R direction and moves to the position GP3, the discharge opening 71b is located above the receiving opening 53b. Thereafter, during a period during which the developing unit 50 rotationally moves to the position GP4 through the position GP3, the discharge opening 71b of the toner cartridge 70 is located above the receiving opening 53b. Therefore, mainly in this period, the toner is discharged from the discharge opening 71b and supplied to the developing unit 50 (arrow S at the position GP3). Thereafter, at a timing during the movement of the developing unit 50 from the position GP4 to the position GP1, the discharge opening 71b is positioned below the receiving opening 53b in the direction of gravity, and the replenishment is not performed.

Therefore, the replenishment phase in which the toner is replenished is included between the positions GP2 and GP1, and the main replenishment phase is between the positions GP2 to GP4. The replenishment phase is a second rotation phase in which the positional relationship between the toner cartridge 70 and the developing unit 50 is a positional relationship in which the toner can move from the discharge opening 71b to the receiving opening 53b among the rotation phases of the rotary assembly 90A.

The moving phase (between the positions GP1 and GP2) includes an installation/removal phase which is a rotation phase in which the toner cartridge 70 is installed in and removed from the rotary assembly 90A. Further, the replenishment phase (between positions GP2 to GP4) includes a developing phase that is a rotation phase in which the developing roller 51 develops the electrostatic latent image formed on the photosensitive drum 2.

Before passing through the replenishment phase (between positions GP2 to GP4) in which the toner is replenished to the developing storage chamber 53a, the developing unit 50 passes through the moving phase (between positions GP1 and GP2) in which the toner moves toward the developing central portion 53c in the longitudinal direction. In other words, when the rotary assembly 90A makes one rotation from the installation/removal phase, the replenishment phase (second rotation phase) is located after the moving phase (first rotation phase), and the developing phase is located after the moving phase (first rotation phase) and the replenishment phase (second rotation phase).

Therefore, when the developing unit 50 reaches the position GP3, the toner in the developing storage chamber 53a moves toward the developing central portion 53c to be separated from the vicinity of the receiving opening 53b in the longitudinal direction. Therefore, a space for receiving the toner from the toner cartridge 70 is secured in the vicinity of the receiving opening 53b. As a result, the toner can be efficiently received from the toner cartridge 70 to the developing storage chamber 53a via the receiving opening 53b.

### Shape and Toner Guide Amount of Developing Guide

When viewed in a direction perpendicular to the developing frame inner surface 53d, an angle formed by the longitudinal direction (Y direction) and a straight line passing through the developing guide inner end 53gi and the developing guide outer end 53go of the developing guide portion 53g is defined as a developing guide angle β of the developing guide portion 53g. The developing guide angle β is preferably larger than the repose angle of the toner.

A shortest distance between a straight line parallel to the transverse direction passing through the developing guide inner end 53gi and the developing guide outer end 53go is defined as a toner guide distance. The toner guide distance is a maximum moving distance in which the toner is guided toward the developing central portion 53c in the longitudinal direction by the developing guide portion 53g.

The length of the developing guide portion 53g when viewed in the thickness direction is defined as a developing guide length. The developing guide length is the length of the developing guide portion 53g along the direction in which the developing guide portion 53g extends.

The height of the developing guide portion 53g protruding from the developing frame inner surface 53d is defined as a developing guide height.

A maximum amount of toner that can be moved in the axial direction (longitudinal direction) by the developing guide 53g along with the rotation of the rotary main body 90 is defined as a toner guide amount. The longer the toner guide distance, the larger the toner guide amount. The higher the developing guide height, the larger the toner guide amount.

### Plurality of Developing Guide Portions

A plurality of developing guide portions 53g is provided in the developing storage chamber 53a of the developing unit 50 of the present embodiment. The plurality of developing guide portions 53g include a first guide portion and a second guide portion, and in the axial direction (longitudinal direction), the first guide portion is positioned between the second guide portion and the receiving opening 53b and the second guide portion is further from the receiving opening 53b than the first guide portion is from the receiving opening 53b. In the present embodiment, the second guide portion is closer to the developing central portion 53c than the first guide portion is to the developing central portion 53c. The first guide portion and the second guide portion are configured to guide the toner stored in the developing storage chamber 53a in a direction away from the receiving opening 53b in the axial direction (longitudinal direction) as the rotary main body 90 rotates. In the present embodiment, the first guide portion and the second guide portion are configured to guide the toner stored in the developing storage chamber 53a toward the developing central portion 53c in the axial direction (longitudinal direction) as the rotary main body 90 rotates.

The developing guide portions 53g of the present embodiment are characterized in that the toner guide amount by the second guide portion is less than the toner guide amount by the first guide portion. Various examples for realizing this feature will be described below. In example 4, the developing guide length of the first guide portion and the developing guide length of the second guide portion are equal to each other, and the developing guide angle β of the second guide portion is greater than the developing guide angle β of the first guide portion. Therefore, the toner guide distance of the second guide portion is shorter than the toner guide distance of the first guide portion, and the toner guide amount of the second guide portion is less than the toner guide amount of the first guide portion.

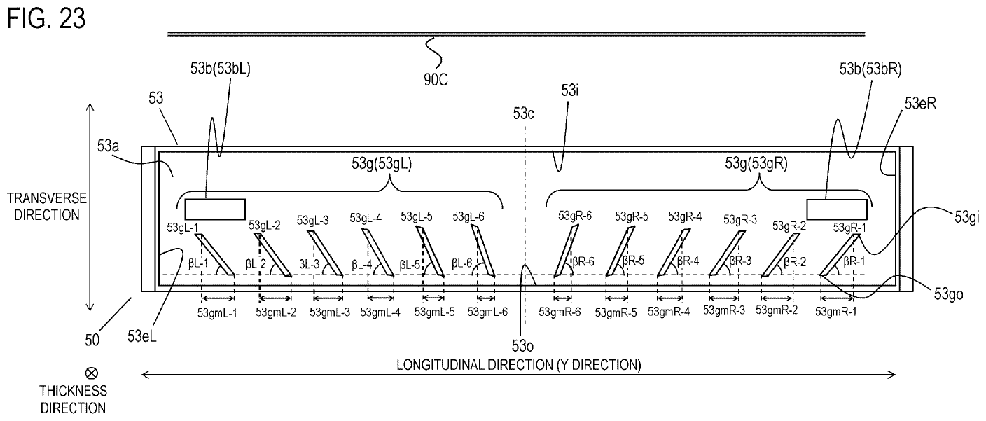

FIG. 23 is a diagram showing an internal structure of the developing unit 50 of example 4 as viewed in the thickness direction. As illustrated in FIG. 23, the developing frame 53 of example 4 includes the developing storage chamber 53a and a plurality of receiving openings including a first receiving opening (first opening) 53bL and a second receiving opening (second opening) 53bR.

Each of the first receiving opening 53bL and the second receiving opening 53bR has a function as the receiving opening 53b communicating with the developing storage chamber 53a.

In the longitudinal direction, the first receiving opening 53bL is located on one end side with respect to the developing central portion 53c of the developing frame 53, and is located between the developing central portion 53c and the developing left-side surface 53eL. The second receiving opening 53bR is located on the other end side with respect to the developing central portion 53c of the developing frame 53, and is located between the developing central portion 53c and the developing right-side surface 53eR.

In example 4, in the longitudinal direction, the first receiving opening 53bL is provided at a position closer to one end (developing left-side surface 53eL) than the developing central portion 53c in the axial direction (longitudinal direction). The second receiving opening 53bR is provided at a position closer to the other end (developing right-side surface 53eR) than the developing central portion 53c in the axial direction (longitudinal direction).

The first receiving opening 53bL and the second receiving opening 53bR are also formed in the developing frame inner surface 53d. That is, the first receiving opening 53bL and the second receiving opening 53bR are provided on the inner wall surface of the developing storage chamber 53a on which the developing guide portions 53g are provided. Note that the developing frame inner surface 53d in which the first receiving opening 53bL is formed, the developing frame inner surface 53d in which the second receiving opening 53bR is formed, and the developing frame inner surface 53d to which the developing guide portions 53g are connected may be discontinuous.

The developing frame 53 of the developing unit 50 includes at least one developing left-side guide portion 53gL and at least one developing right-side guide portion 53gR. The developing left-side guide portion 53gL and the developing right-side guide portion 53gR are provided on the developing frame inner surface 53d.

Although the developing left-side guide portion 53gL and the developing right-side guide portion 53gR have different toner guide directions, the basic configuration and function thereof are substantially the same. Therefore, hereinafter, the developing left-side guide portion 53gL and the developing right-side guide portion 53gR may be collectively referred to as a developing guide portion 53g, and the first receiving opening 53bL and the second receiving opening 53bR may be collectively referred to as a receiving opening 53b.

In the developing frame 53, six developing left-side guide portions 53gL-1, 53gL-2, 53gL-3, 53gL-4, 53gL-5, and 53gL-6 are provided in order from the side closer to the developing left-side surface 53eL. In addition, in the developing frame 53, six developing right-side guide portions 53gR-1, 53gR-2, 53gR-3, 53gR-4, 53gR-5, and 53gR-6 are provided in order from the side closer to the developing right-side surface 53eR.

In the longitudinal direction (axial direction), the position of at least one of the plurality of developing left-side guide portions 53gL and the position of the first receiving opening 53bL are arranged to at least partially overlap with each other. In the longitudinal direction (axial direction), the position of at least one of the plurality of developing right-side guide portions 53gR and the position of the second receiving opening 53bR are arranged to at least partially overlap each other.

The developing left-side guide portion 53gL is configured to guide the toner received from the first receiving opening 53bL in a direction away from the first receiving opening 53bL in the longitudinal direction, that is, in a direction of the developing central portion 53c. The developing right-side guide portion 53gR is configured to guide the toner received from the second receiving opening 53bR in a direction away from the second receiving opening 53bR in the longitudinal direction, that is, in a direction of the developing central portion 53c.

The plurality of developing guide portions 53g have the same developing guide length. On the other hand, the developing guide angle β is larger as the developing guide portion 53g is further from the receiving opening 53b (closer to the developing central portion 53c) in the axial direction (longitudinal direction). As a result, the toner guide distance 53gm is shorter in the developing guide portion 53g far from the receiving opening 53b (close to the developing central portion 53c) than in the developing guide portion 53g close to the ends (developing left-side surface 53eL and developing right-side surface 53eR) in the axial direction (longitudinal direction). Therefore, the toner guide amount in the longitudinal direction is smaller in the developing guide portion 53g far from the receiving opening 53b (close to the developing central portion 53c) than in the developing guide portion 53g close to the ends (developing left-side surface 53eL and developing right-side surface 53eR) in the axial direction (longitudinal direction).

The developing left-side guide portions 53gL-1, 53gL-2, 53gL-3, 53gL-4, 53gL-5, and 53gL-6 have developing guide angles βL-1, βL-2, βL-3, βL-4, βL-5, and βL-6, respectively. These developing guide angles satisfy βL-1<βL-2<βL-3<βL-4<βL-5 <βL-6.

The toner guide distances of the developing left-side guide portions 53gL-1, 53gL-2, 53gL-3, 53gL-4, 53gL-5, and 53gL-6 are 53gmL-1, 53gmL-2, 53gmL-3, 53gmL-4, 53gmL-5, and 53gmL-6, respectively. These toner guide distances satisfy 53gmL-1>53gmL-2>53gmL-3>53gmL-4>53gmL-5>53gmL-6.

The developing right-side guide portions 53gR-1, 53gR-2, 53gR-3, 53gR-4, 53gR-5, and 53gR-6 have developing guide angles βR-1, βR-2, βR-3, βR-4, βR-5, and βR-6, respectively. These developing guide angles satisfy βR-1<βR-2<βR-3<βR-4<βR-5<βR-6.

The toner guide distances of the developing right-side guide portions 53gR-1, 53gR-2, 53gR-3, 53gR-4, 53gR-5, and 53gR-6 are 53gmR-1, 53gmR-2, 53gmR-3, 53gmR-4, 53gmR-5, and 53gmR-6, respectively. These toner guide distances satisfy 53gmR-1>53gmR-2>53gmR-3>53gmR-4>53gmR-5>53gmR-6.

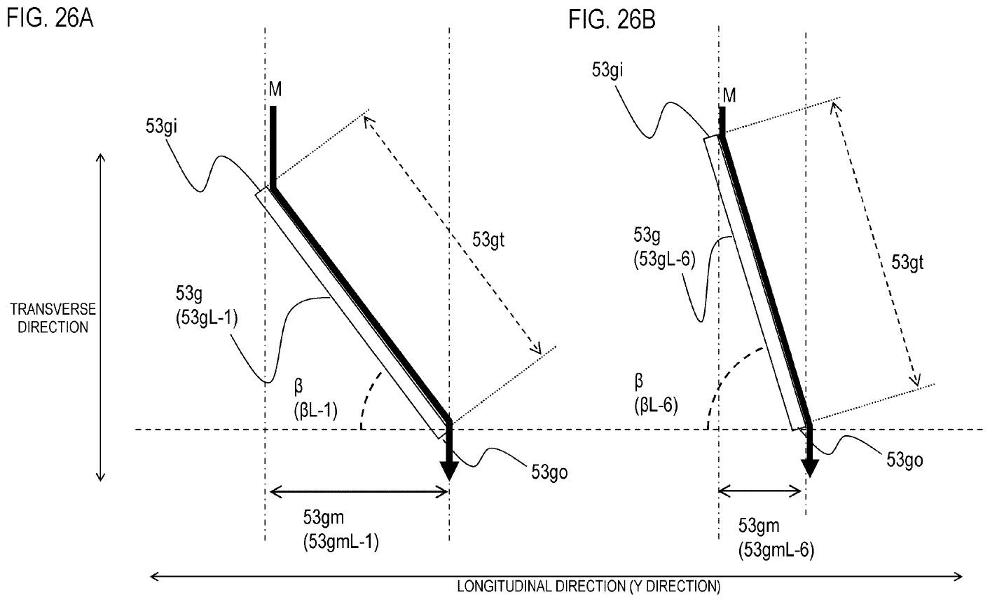

FIGS. 26A and 26B are diagrams showing a state in which the developing guide portions 53g guides the toner moving in the developing unit 50. An arrow M indicates a toner moving direction. FIG. 26A shows the developing left-side guide portion 53gL-1 having the smallest developing guide angle βL-1 and the longest toner guide distance 53gmL-1 among the developing left-side guide portions 53gL. FIG. 26B shows the developing left-side guide portion 53gL-6 having the largest developing guide angle βL-6 and the shortest toner guide distance 53gmL-6 among the developing left-side guide portions 53gL.

When the toner moving on the developing frame inner surface 53d comes into contact with the developing guide portions 53g, the toner moves along the developing guide portions 53g from the developing guide inner end 53gi toward the developing guide outer end 53go.

Since the developing guide angle βL-6 of the developing left-side guide portion 53gL-6 is larger than the developing guide angle βL-1 of the developing left-side guide portion 53gL-1, the toner guide distance 53gmL-6 is shorter than the toner guide distance 53gmL-1. That is, the toner guide distance 53gm is shorter in the developing left-side guide portion 53gL-6 than in the developing left-side guide portion 53gL-1. The developing left-side guide portion 53gL-1 is an example of a first guide portion, and the developing left-side guide portion 53gL-6 is an example of a second guide portion. In example 4, for any n<m (n and m=1 to 6), the developing left-side guide portion 53gL-n is an example of the first guide portion, and the developing left-side guide 53gL-m is an example of the second guide portion. The same relationship is established in the developing right-side guide portions 53gR.

As illustrated in FIG. 23, among the developing left-side guide portions 53gL, the developing left-side guide portion 53gL-1 closest to the first receiving opening 53bL has the smallest developing guide angle βL-1. The developing left-side guide portion 53gL closer to the developing central portion 53c has a larger developing guide angle β. The developing left-side guide portion 53gL-6 closest to the developing central portion 53c has the largest developing guide angle βL-6. As a result, the toner guide distance 53gmL-1 of the developing left-side guide portion 53gL-1 is the longest among the developing left-side guide portions 53gL. The developing left-side guide portion 53gL closer to the developing central portion 53c has a shorter toner guide distance 53gm. The developing left-side guide portion 53gL-6 closest to the developing central portion 53c has the shortest toner guide distance 53gmL-6.

Similarly, the developing right-side guide portion 53gR-1 closest to the second receiving opening 53bR has the smallest developing guide angle βR-1 among the developing right-side guide portions 53gR. The developing right-side guide portion 53gR closer to the developing central portion 53c has a larger developing guide angle β. The developing right-side guide portion 53gR-6 closest to the developing central portion 53c has the largest developing guide angle βR-6. As a result, the developing right-side guide portion 53gR-1 has the longest toner guide distance 53gmR-1 among the developing right-side guide portions 53gR. The developing right-side guide portion 53gR closer to the developing central portion 53c has a shorter toner guide distance 53gm. The developing right-side guide portion 53gR-6 closest to the developing central portion 53c has the shortest toner guide distance 53gmR-6.

When the toner moving by its own weight in the developing storage chamber 53a is guided to the developing guide portions 53g, the toner guide distance 53gm of the developing guide portion 53g near the developing central portion 53c is shorter than the toner guide distance 53gm of the developing guide portion 53g near the receiving opening 53b.

As described above, according to example 4, the toner replenished from the toner cartridge 70 is guided by the developing guide portions 53g and moves away from the receiving opening 53b in the longitudinal direction. Therefore, it is possible to prevent the toner from staying in the vicinity of the receiving opening 53b in the developing unit 50. In addition, since the developing guide portion 53g closer to the developing central portion 53c has a shorter toner guide distance, it is possible to prevent the toner from being concentrated on the developing central portion 53c and the toner distribution in the developing storage chamber 53a from becoming uneven. Therefore, the toner distribution in the developing storage chamber 53a can be made uniform, and image defects such as density unevenness can be curbed.

### Example 5

In example 5, the developing guide angle β of the first guide portion and the developing guide angle β of the second guide portion are equal to each other, and the developing guide length of the second guide portion is shorter than the developing guide length of the first guide portion. Therefore, the toner guide distance of the second guide portion is shorter than the toner guide distance of the first guide portion, and the toner guide amount of the second guide portion is smaller than the toner guide amount of the first guide portion. In the following description, the same components as those in example 4 are denoted by the same reference numerals, and a detailed description thereof will be omitted.

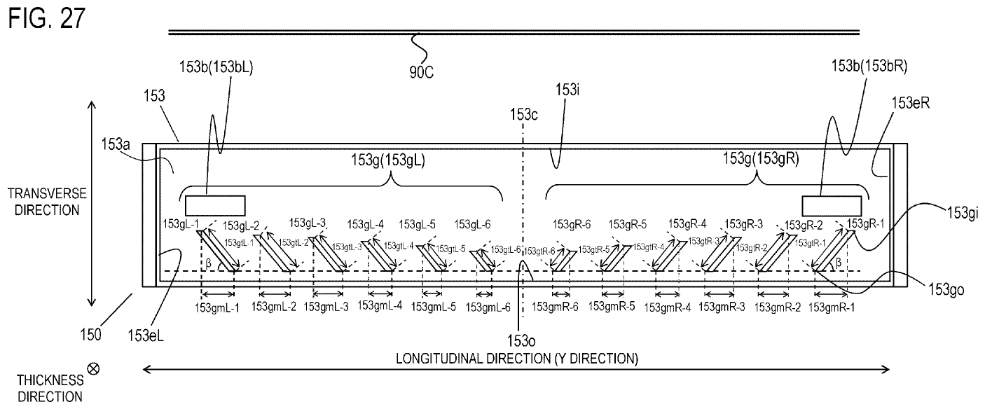

FIG. 27 is a diagram showing an internal structure of the developing unit 150 of example 5 as viewed in the thickness direction. The developing frame 153 of the developing unit 150 includes at least one developing left-side guide portion 153gL and at least one developing right-side guide portion 153gR. The developing left-side guide portion 153gL and the developing right-side guide portion 153gR are provided on the developing frame inner surface 153d.

In the developing frame 153, six developing left-side guide portions 153gL-1, 153gL-2, 153gL-3, 153gL-4, 153gL-5, and 153gL-6 are provided in order from the side closer to the developing left-side surface 153eL. In addition, in the developing frame 153, six developing right-side guide portions 153gR-1, 153gR-2, 153gR-3, 153gR-4, 153gR-5, and 153gR-6 are provided in order from the side closer to the developing right-side surface 153eR.

The developing guide angles β of the plurality of developing guide portions 53g of the developing unit 50 in example 4 are different depending on the positions in the longitudinal direction, whereas the developing guide lengths 153gt of the plurality of developing guide portions 153g of the developing unit 150 in example 5 are different depending on the positions in the longitudinal direction.

The plurality of developing guide portions 153g have the same developing guide angle β. On the other hand, the developing guide length 153gt is shorter as the developing guide portion 153g is further from the receiving opening 153b (closer to the developing central portion 153c) in the axial direction (longitudinal direction). As a result, the toner guide distance 153gm is shorter in the developing guide portion 153g far from the receiving opening 153b (close to the developing central portion 153c) than in the developing guide portion 153g close to the ends (developing left-side surface 153eL and developing right-side surface 153eR) in the axial direction (longitudinal direction). Therefore, the toner guide amount in the longitudinal direction is smaller in the developing guide portion 153g far from the receiving opening 153b (close to the developing central portion 153c) than in the developing guide portion 153g close to the ends (developing left-side surface 153eL and developing right-side surface 153eR) in the axial direction (longitudinal direction).

In example 5, as the rotary main body 90 (the rotary assembly 90A) rotates, the toner also moves from the developing inner side surface 153i toward the developing outer side surface 1530 in the transverse direction of the developing storage chamber 153a. When the toner moves from the developing inner side surface 153i to the developing outer side surface 1530, the toner is guided by the developing guide portion 153g toward the developing central portion 153c in a direction away from the receiving opening 153b in the longitudinal direction. The shapes and disposition of the discharge opening 71b and the receiving opening 153b may be the same as the shapes and disposition of the discharge opening 71b and the receiving opening 53b of example 1.

The developing guide portion 153g is configured to guide the toner moving in the transverse direction by its own weight toward the developing central portion 153c in the longitudinal direction. The developing guide portion 153g has a developing guide outer end 153go and a developing guide inner end 153gi. In the transverse direction, the developing guide inner end 153gi is closer to the rotation axis 90C than the developing guide outer end 153go is to the rotation axis 90C. In the longitudinal direction, the developing guide inner end 153gi is closer to the receiving opening 153b than the developing guide outer end 153go is to the receiving opening 153b. In other words, in the longitudinal direction, the developing guide outer end 153go is closer to the developing central portion 153c than the developing guide inner end 153gi is to the developing central portion 153c.

The developing guide lengths of the developing left-side guide portions 153gL-1, 153gL-2, 153gL-3, 153gL-4, 153gL-5, and 153gL-6 are 153gtL-1, 153gtL-2, 153gtL-3, 153gtL-4, 153gtL-5, and 153gtL-6, respectively. These developing guide lengths satisfy 153gtL-1>153gtL-2>153gtL-3>153gtL-4>153gtL-5>153gtL-6.

The toner guide distances of the developing left-side guide portions 153gL-1, 153gL-2, 153gL-3, 153gL-4, 153gL-5, and 153gL-6 are 153gmL-1, 153gmL-2, 153gmL-3, 153gmL-4, 153gmL-5, and 153gmL-6, respectively. These toner guide distances satisfy 153gmL-1>153gmL-2>153gmL-3>153gmL-4>153gmL-5>153gmL-6.

The developing guide lengths of the developing right-side guide portions 153gR-1, 153gR-2, 153gR-3, 153gR-4, 153gR-5, and 153gR-6 are 153gtR-1, 153gtR-2, 153gtR-3, 153gtR-4, 153gtR-5, and 153gtR-6, respectively. These developing guide lengths satisfy 153gtR-1>153gtR-2>153gtR-3>153gtR-4>153gtR-5>153gtR-6.

The toner guide distances of the developing right-side guide portions 153gR-1, 153gR-2, 153gR-3, 153gR-4, 153gR-5, and 153gR-6 are 153gmR-1, 153gmR-2, 153gmR-3, 153gmR-4, 153gmR-5, and 153gmR-6, respectively. These toner guide distances satisfy 153gmR-1>153gmR-2>153gmR-3>153gmR-4>153gmR-5>153gmR-6.

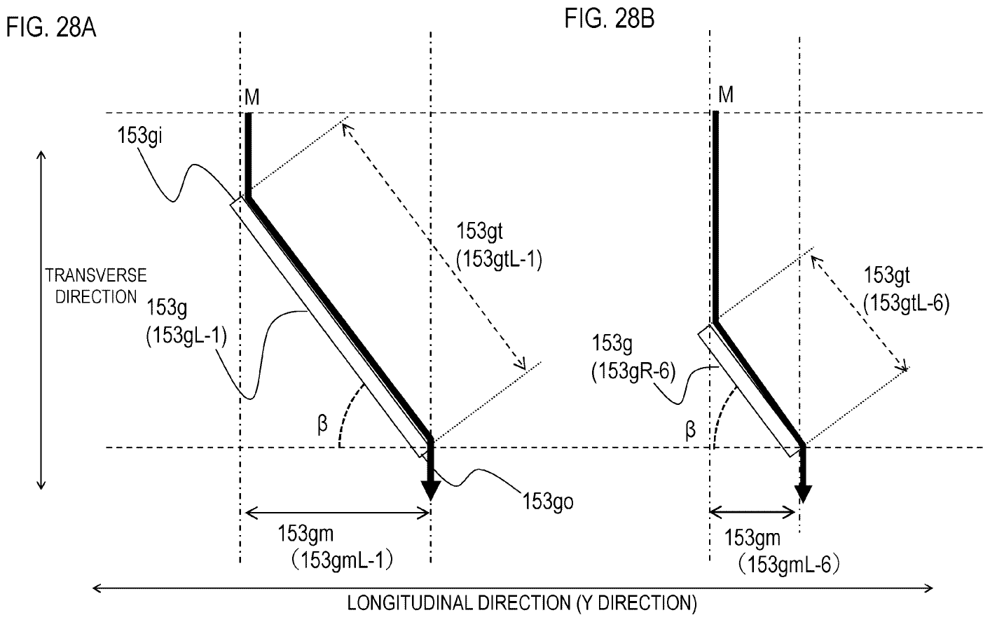

FIGS. 28A and 28B are diagrams showing a state in which the developing guide portions 153g guide the toner moving in the developing unit 150. An arrow M indicates a toner moving direction. FIG. 28A shows the developing left-side guide portion 153gL-1 having the longest developing guide length 153gtL-1 and the longest toner guide distance 153gmL-1 among the developing left-side guide portions 153gL. FIG. 28B shows the developing left-side guide portion 153gL-6 having the shortest developing guide length 153gtL-6 and the shortest toner guide distance 153gmL-6 among the developing left-side guide portions 153gL.

When the toner moving on the developing frame inner surface 153d comes into contact with the developing guide portions 153g, the toner moves along the developing guide portions 153g from the developing guide inner end 153gi toward the developing guide outer end 153go.

The developing guide angle β is an angle formed by the longitudinal direction (Y direction) and a straight line passing through the developing guide inner end 153gi and the developing guide outer end 153go of the developing guide portion 153g when viewed in a direction perpendicular to the developing frame inner surface 153d, and is preferably larger than the repose angle of the toner.

The toner guide distance 153gm is the shortest distance between a straight line parallel to the transverse direction and passing through the developing guide inner end 153gi and the developing guide outer end 153go. The toner guide distance 153gm is the maximum moving distance by which the toner is guided toward the developing central portion 153c in the longitudinal direction by the developing guide portions 153g.

It is assumed that two developing guide portions 153g have the same developing guide angle β and different developing guide lengths 153gt. In this case, the toner guide distance 153gm of the developing guide portion 153g having the shorter developing guide length 153gt is shorter than the toner guide distance 153gm of the developing guide portion 153g having the longer developing guide length 153gt.

Since the developing guide length 153gtL-6 of the developing left-side guide portion 153gL-6 is shorter than the developing guide length 153gtL-1 of the developing left-side guide portion 153gL-1, the toner guide distance 53gmL-6 is shorter than the toner guide distance 53gmL-1. That is, the toner guide distance 153gm is shorter in the developing left-side guide portion 153gL-6 than in the developing left-side guide portion 153gL-1. The developing left-side guide portion 153gL-1 is an example of a first guide portion, and the developing left-side guide portion 153gL-6 is an example of a second guide portion. Note that, in example 5, for any nem (n and m=1 to 6), the developing left-side guide portion 153gL-n is an example of the first guide portion, and the developing left-side guide portion 153gL-m is an example of the second guide portion. The same relationship is established in the developing right-side guide portions 153gR.

As illustrated in FIG. 27, among the developing left-side guide portions 153gL, the developing left-side guide portion 153gL-1 closest to the first receiving opening 153bL has the longest developing guide length 153gtL-1. The developing left-side guide portion 153gL closer to the developing central portion 153c has a shorter developing guide length 153gt. The developing left-side guide portion 153gL-6 closest to the developing central portion 153c has the shortest developing guide length 153gtL-6. As a result, the developing left-side guide portion 153gL-1 has the longest toner guide distance 53gmL-1 among the developing left-side guide portions 153gL. The developing left-side guide portion 153gL closer to the developing central portion 153c has a shorter toner guide distance 153gm. The developing left-side guide portion 153gL-6 closest to the developing central portion 153c has the shortest toner guide distance 153gmL-6.

Similarly, the developing right-side guide portion 153gR-1 closest to the second receiving opening 153bR has the longest developing guide length 153gtR-1 among the developing right-side guide portions 153gR. The developing right-side guide portion 153gR closer to the developing central portion 153c has a shorter developing guide length 153gt. The developing right-side guide portion 153gR-6 closest to the developing central portion 153c has the shortest developing guide length 153gtR-6. As a result, the developing right-side guide portion 153gR-1 has the longest toner guide distance 53gmR-1 among the developing right-side guide portions 153gR. The developing right-side guide portion 153gR closer to the developing central portion 153c has a shorter toner guide distance 153gm. The developing right-side guide portion 153gR-6 closest to the developing central portion 153c has the shortest toner guide distance 153gmR-6.

The toner moving by its own weight in the developing storage chamber 153a is guided to the developing guide portions 153g. In this case, the toner guide distance 153gm of the developing guide portion 153g near the developing central portion 153c is shorter than the toner guide distance 153gm of the developing guide portion 153g near the receiving opening 153b.

As described above, according to example 5, the toner replenished from the toner cartridge 70 is guided by the developing guide portions 153g and moves away from the receiving opening 153b in the longitudinal direction. Therefore, it is possible to prevent the toner from staying in the vicinity of the receiving opening 153b in the developing unit 150. In addition, since the developing guide portion 153g closer to the developing central portion 153c has a shorter toner guide distance, it is possible to prevent the toner from being concentrated on the developing central portion 153c and the toner distribution in the developing storage chamber 153a from becoming uneven. Therefore, the toner distribution in the developing storage chamber 153a can be made uniform, and image defects such as density unevenness can be curbed.

In example 5, the shape of the receiving opening 153b is also the same as the shape of the receiving opening 53b in example 4. In addition, the first receiving opening 153bL and at least one developing left-side guide portion 153gL are disposed on the developing frame inner surface 153d to at least partially overlap each other in the longitudinal direction. The second receiving opening 153bR and at least one developing right-side guide portion 153gR are disposed on the developing frame inner surface 153d to at least partially overlap each other in the longitudinal direction.

Note that, although the example in which each of the developing left-side guide portion 153gL and the developing left-side guide portion 153gL includes six developing guide portions has been described, the number of developing guide portions is not limited to thereto as long as the number is plural. In addition, although the example in which the developing guide lengths of the plurality of developing guide portions are all different has been described, some of the plurality of developing guide portions may have the same developing guide length. In this case, among the plurality of developing guide portions, there may be a pair of developing guide portions that satisfies the condition that the developing guide length of one developing guide portion located far from the receiving opening is shorter than the developing guide length of the other developing guide portion. Note that, among the plurality of developing guide portions, it is also preferable that there is no pair of developing guide portions that satisfies the condition that the developing guide length of one developing guide portion located far from the receiving opening is longer than the developing guide length of the other developing guide portion.

### Example 6

In example 6, the developing guide angle β of the first guide portion and the developing guide angle β of the second guide portion are equal to each other, and the developing guide length of the first guide portion and the developing guide length of the second guide portion are equal to each other. On the other hand, the developing guide height of the second guide portion is less than the developing guide height of the first guide portion. Therefore, although the toner guide distance of the first guide portion is equal to the toner guide distance of the second guide portion, the toner guide amount of the second guide portion is less than the toner guide amount of the first guide portion. In the following description, the same components as those in example 4 are denoted by the same reference numerals, and a detailed description thereof will be omitted.

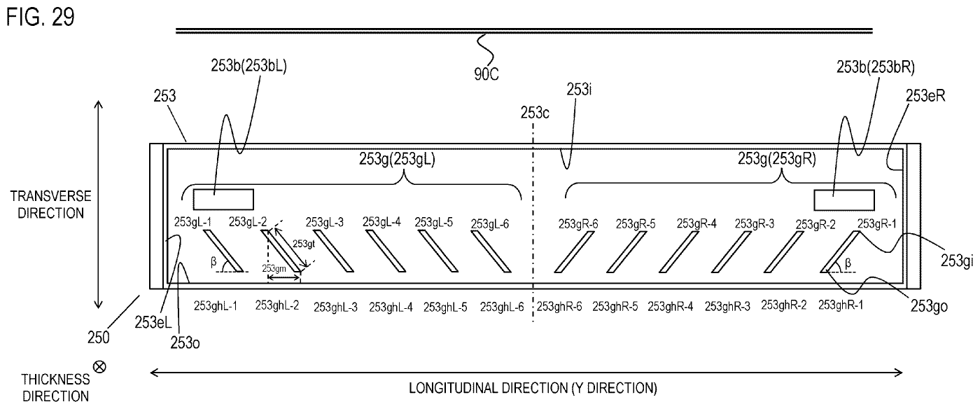

FIG. 29 is a diagram showing an internal structure of the developing unit 250 of example 6 as viewed in the thickness direction. The developing frame 253 of the developing unit 250 includes at least one developing left-side guide portion 253gL and at least one developing right-side guide portion 253gR. The developing left-side guide portion 253gL and the developing right-side guide portion 253gR are provided on the developing frame inner surface 253d.

In the developing frame 253, six developing left-side guide portions 253gL-1, 253gL-2, 253gL-3, 253gL-4, 253gL-5, and 253gL-6 are provided in order from the side closer to the developing left-side surface 253eL. In addition, in the developing frame 253, six developing right-side guide portions 253gR-1, 253gR-2, 253gR-3, 253gR-4, 253gR-5, and 253gR-6 are provided in order from the side closer to the developing right-side surface 253eR.

The developing guide angles β of the plurality of developing guide portions 53g of the developing unit 50 in example 4 are different depending on the positions in the longitudinal direction, whereas the developing guide heights 253gh of the plurality of developing guide portions 253g of the developing unit 250 in example 6 are different depending on the positions in the longitudinal direction.

The plurality of developing guide portions 253g have the same developing guide angle β and the same developing guide length 253gt. Therefore, the plurality of developing guide portions 253g have the same toner guide distance 253gm in the longitudinal direction. On the other hand, the developing guide height 253gh in the thickness direction is lower as the developing guide portion 253g is further from the receiving opening 253b (closer to the developing central portion 253c) in the axial direction (longitudinal direction). As a result, the toner guide amount in the longitudinal direction is smaller in the developing guide portion 253g far from the receiving opening 253b (close to the developing central portion 253c) than in the developing guide portion 253g close to the ends (developing left-side surface 253eL and developing right-side surface 253eR) in the axial direction (longitudinal direction).

In example 6, as the rotary main body 90 (the rotary assembly 90A) rotates, the toner also moves from the developing inner side surface 253i toward the developing outer side surface 2530 in the transverse direction of the developing storage chamber 253a. When the toner moves from the developing inner side surface 253i to the developing outer side surface 2530, the toner is guided by the developing guide portions 253g in a direction away from the receiving opening 253b in the longitudinal direction. The shapes and disposition of the discharge opening 71b and the receiving opening 253b may be the same as the shapes and disposition of the discharge opening 71b and the receiving opening 53b in example 4.

The developing guide portion 253g is configured to guide the toner moving in the transverse direction by its own weight toward the developing central portion 253c in the longitudinal direction. The developing guide portion 253g has a developing guide outer end 253go and a developing guide inner end 253gi. In the transverse direction, the developing guide inner end 253gi is closer to the rotation axis 90C than the developing guide outer end 253go is to the rotation axis 90C. In the longitudinal direction, the developing guide inner end 253gi is closer to the receiving opening 253b than the developing guide outer end 253go is to the receiving opening 253b. In other words, in the longitudinal direction, the developing guide outer end 253go is closer to the developing central portion 253c than the developing guide inner end 253gi is to the developing central portion 253c.

The developing guide heights of the developing left-side guide portions 253gL-1, 253gL-2, 253gL-3, 253gL-4, 253gL-5, and 253gL-6 are 253ghL-1, 253ghL-2, 253ghL-3, 253ghL-4, 253ghL-5, and 253ghL-6, respectively. These developing guide heights satisfy 253ghL-1>253ghL-2>253ghL-3>253ghL-4>253ghL-5>253ghL-6.

The developing guide heights of the developing right-side guide portions 253gR-1, 253gR-2, 253gR-3, 253gR-4, 253gR-5, and 253gR-6 are 253ghR-1, 253ghR-2, 253ghR-3, 253ghR-4, 253ghR-5, and 253ghR-6, respectively. These developing guide heights satisfy 253ghR-1>253ghR-2>253ghR-3>253ghR-4>253ghR-5>253ghR-6.

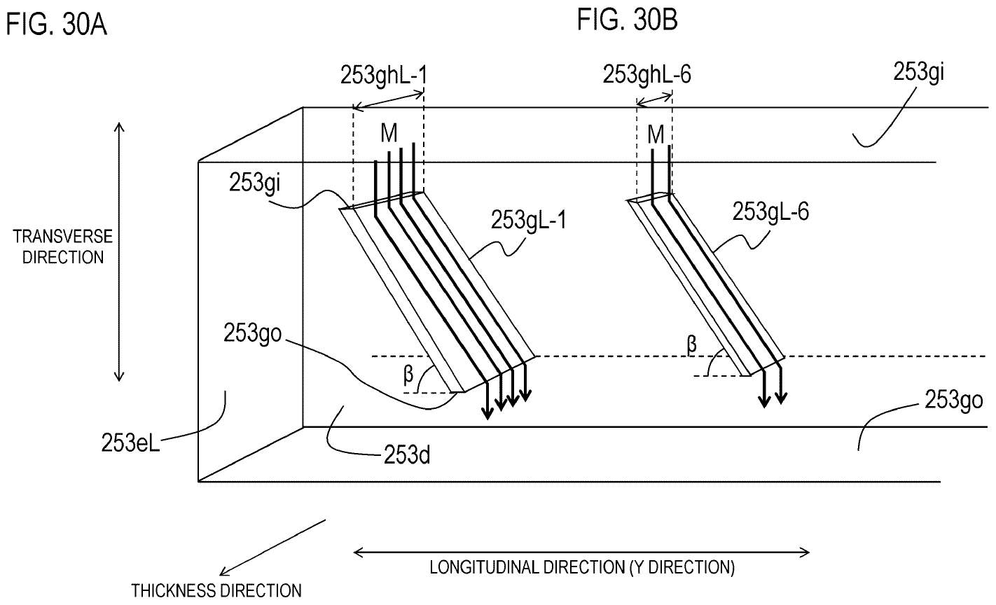

FIGS. 30A and 30B are diagrams showing a state in which the developing guide portions 253g guide the toner moving in the developing unit 250. An arrow M indicates a toner moving direction. FIG. 30A shows the developing left-side guide portion 253gL-1 having the highest developing guide height 253ghL-1 and the largest toner guide amount among the developing left-side guide portions 253gL. FIG. 30B shows the developing left-side guide portion 253gL-6 having the lowest developing guide height 253ghL-6 and the smallest toner guide amount among the developing left-side guide portions 253gL.

When the toner moving on the developing frame inner surface 253d comes into contact with the developing guide portions 253g, the toner moves along the developing guide portions 253g from the developing guide inner end 253gi toward the developing guide outer end 253go.

The developing guide height 253gh represents the height of the developing guide portion 253g in the thickness direction. It is assumed that two developing guide portions 253g have the same developing guide angle β and the same developing guide length 253gt and different developing guide heights 253gh. In this case, the toner guide amount of the developing guide portion 253g having the lower developing guide height 253gh is less than the toner guide amount of the developing guide portion 253g having the higher developing guide height 253gh.

The developing guide height 253ghL-6 of the developing left-side guide portion 253gL-6 is lower than the developing guide height 253ghL-1 of the developing left-side guide portion 253gL-1. Therefore, the toner guide amount is smaller in the developing left-side guide portion 253gL-6 than in the developing left-side guide portion 253gL-1. The developing left-side guide portion 253gL-1 is an example of the first guide portion, and the developing left-side guide portion 253gL-6 is an example of the second guide portion. Note that, in example 6, for any n<m (n and m=1 to 6), the developing left-side guide portion 253gL-n is an example of the first guide portion, and the developing left-side guide portion 253gL-m is an example of the second guide portion. The same relationship is established in the developing right-side guide portions 253gR.

As illustrated in FIG. 29, the developing left-side guide portion 253gL-1 closest to the first receiving opening 253bL has the highest developing guide height 253ghL-1 among the developing left-side guide portions 253gL. The developing left-side guide portion 253gL closer to the developing central portion 253c has a lower developing guide height 253gh. The developing left-side guide portion 253gL-6 closest to the developing central portion 253c has the lowest developing guide height 253ghL-6. As a result, the developing left-side guide portion 253gL-1 has the largest toner guide amount among the developing left-side guide portions 253gL. The developing left-side guide portion 253gL closer to the developing central portion 253c has a smaller toner guide amount. The developing left-side guide portion 253gL-6 closest to the developing central portion 253c has the smallest toner guide amount.

Similarly, the developing right-side guide portion 253gR-1 closest to the second receiving opening 253bR has the highest developing guide height 253ghR-1 among the developing right-side guide portions 253gR. The developing right-side guide portion 253gR closer to the developing central portion 253c has a lower developing guide height 253gh. The developing right-side guide portion 253gR-6 closest to the developing central portion 253c has the lowest developing guide height 253ghR-6. As a result, the developing right-side guide portion 253gR-1 has the largest toner guide amount among the developing right-side guide portions 253gR. The developing right-side guide portion 253gR closer to the developing central portion 253c has a smaller toner guide amount. The developing right-side guide portion 253gR-6 closest to the developing central portion 253c has the smallest toner guide amount.

When the toner moving by its own weight in the developing storage chamber 253a is guided to the developing guide portions 253g, the toner guide amount of the developing guide portion 253g near the developing central portion 253c is smaller than the toner guide amount of the developing guide portion 253g near the receiving opening 253b.

As described above, according to example 6, the toner replenished from the toner cartridge 70 is guided by the developing guide portions 253g and moves away from the receiving opening 253b in the longitudinal direction. Therefore, it is possible to prevent the toner from staying in the vicinity of the receiving opening 253b in the developing unit 250. In addition, since the developing guide portion 253g closer to the developing central portion 253c has a smaller toner guide amount, it is possible to prevent the toner from being concentrated on the developing central portion 253c and the toner distribution in the developing storage chamber 253a from becoming uneven. Therefore, the toner distribution in the developing storage chamber 253a can be made uniform, and image defects such as density unevenness can be curbed.

In Example 6, the shape of the receiving opening 253b is also the same as the shape of the receiving opening 53b in example 1. In addition, the first receiving opening 253bL and at least one developing left-side guide portion 253gL are disposed on the developing frame inner surface 253d to at least partially overlap each other in the longitudinal direction. The second receiving opening 253bR and at least one developing right-side guide portion 253gR are disposed on the developing frame inner surface 253d to at least partially overlap each other in the longitudinal direction.

### MODIFIED EXAMPLES

Although an example of the configuration in which the two receiving openings of the first receiving opening and the second receiving opening are provided on sides closer to both ends than the developing central portion in the axial direction has been described in the above example, the number and disposition of receiving openings are not limited to this example. For example, one or a plurality of receiving openings may be provided close to one end in the axial direction, or one or a plurality of receiving openings may be provided close to the developing central portion.

In addition, although an example in which six developing guide portions are included in each of the developing left-side guide portion and the developing right-side guide portion has been described, the number of developing guide portions is not limited to thereto as long as the number is plural. In addition, although an example in which the developing guide angles are different in all of the plurality of developing guide portions has been described, some of the plurality of developing guide portions may have the same developing guide angle. In this case, among the plurality of developing guide portions, there may be a pair of developing guide portions that satisfies the condition that the developing guide angle of one developing guide portion located far from the receiving opening is larger than the developing guide angle of the other developing guide portion. Note that, among the plurality of developing guide portions, it is also preferable that there is no pair of developing guide portions that satisfies the condition that the developing guide angle of one developing guide portion located far from the receiving opening is smaller than the developing guide angle of the other developing guide portion. The same applies to the developing guide length and the developing guide height.

Further, although an example in which the toner guide amount in the longitudinal direction is made different by making the developing guide angle, the developing guide length, and the developing guide height of the developing guide portions different has been described in the above example, the toner guide amount may be made different by combining these.

Further, although an example of the configuration in which the toner guide amount is smaller in the developing guide portion closer to the developing central portion (further from the receiving opening) has been described in the above example, the present invention is not limited to this configuration as long as the toner distribution in the developing storage chamber can be made uniform. For example, in an image forming apparatus in which the amount of toner used is large and the amount of toner at the developing central portion tends to decrease, a developing guide portion closer to the developing central portion has a larger toner guide amount.

Further, although an example in which the developing guide portions are provided on the developing frame inner surface has been described in the above example, the portion where the developing guide portions are provided is not limited thereto. The developing guide portions may be provided on any inner wall surface of the developing storage chamber as long as the toner in the developing storage chamber can be guided in the axial direction as the rotary main body rotates.

For example, in the rotation phase GP2 of FIG. 25, the radially inner end (developing inner side surface 53i) of the developing frame inner surface 53d is vertically above the radially outer end (developing outer side surface 530), and the normal line of the developing frame inner surface 53d includes a component in the vertically upward direction. Therefore, in the rotation phase GP2, the toner moves along the developing frame inner surface 53d from the radially inner side toward the radially outer side, and the developing guide portions 53g guide the toner moving in the rotation phase GP2. The present invention is not limited to this configuration. For example, guide portions may be configured to guide the toner flowing from the radially outer side to the radially inner side in the rotation phase GP4 of FIG. 25.

In each of the above examples, the respective configurations can be combined.

According to the present invention, in the toner replenishment type rotary developing method, the toner in the developing unit can be uniformly distributed, and image defects caused by non-uniform distribution can be curbed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2024-075157, filed on May 7, 2024, and No. 2024-075203, filed on May 7, 2024, which are hereby incorporated by reference herein in their entirety.

What is claimed is:

1. An image forming apparatus comprising:
a rotary rotatable about a rotation axis extending in an axial direction;
a toner cartridge supported by the rotary and having a discharge opening, the toner cartridge configured to discharge toner from the discharge opening; and
a developing unit supported by the rotary and including a receiving opening configured to receive the toner discharged from the discharge opening, a storage chamber configured to store the toner received from the receiving opening, and a developing roller configured to bear the toner stored in the storage chamber,
wherein the developing unit includes a guide portion, and the guide portion is configured to guide the toner stored in the storage chamber away from the receiving opening in the axial direction in a case where the rotary rotates,
wherein, in a case where a rotation phase of the rotary in which the guide portion guides the toner in a direction away from the receiving opening in the axial direction is a first rotation phase, a rotation phase of the rotary in which a positional relationship between the toner cartridge and the developing unit is a positional relationship in which the toner is able to move from the discharge opening to the receiving opening is a second rotation phase, and a rotation phase of the rotary in which the toner cartridge is installed in and removed from the rotary is an installation/removal phase, the second rotation phase is located after the first rotation phase during one rotation of the rotary from the installation/removal phase.

2. The image forming apparatus according to claim 1,
wherein the guide portion extends in a direction inclined with respect to the axial direction.

3. The image forming apparatus according to claim 2,
wherein the guide portion has a part overlapping the receiving opening as viewed in a direction orthogonal to the axial direction.

4. The image forming apparatus according to claim 2,
wherein the developing unit includes a plurality of guides disposed side by side in the axial direction, the plurality of guides includes the guide portion.

5. The image forming apparatus according to claim 4,
wherein the plurality of the guides include:
a first guide portion having a part overlapping the receiving opening as viewed in a direction orthogonal to the axial direction; and
a second guide portion that does not overlap the receiving opening as viewed in the direction orthogonal to the axial direction, and
wherein the second guide portion includes an outer end and an inner end, the outer end is further from the rotation axis than the inner end is from the rotation axis, and the second guide portion is inclined with respect to the axial direction such that the outer end is further from the receiving opening than the inner end is from the receiving opening.

6. The image forming apparatus according to claim 1,
wherein an inner surface of the storage chamber includes a first surface facing a direction from downstream to upstream in a moving direction of the developing unit according to rotation of the rotary,
wherein the receiving opening is provided to the first surface, and
wherein in the first rotation phase, the guide portion guides the toner moving along the first surface in a direction away from the receiving opening.

7. The image forming apparatus according to claim 6,
wherein in the first rotation phase, a normal line of the first surface includes a component in a vertically upward direction, and an outer end of the first surface far from the rotation axis is located vertically below an inner end close to the rotation axis.

8. The image forming apparatus according to claim 1,
wherein the guide portion is provided at a position further from the rotation axis than the receiving opening is from the rotation axis as viewed in the axial direction.

9. An image forming apparatus comprising:
a rotary rotatable about a rotation axis extending in an axial direction;
a toner cartridge supported by the rotary and having a discharge opening, the toner cartridge configured to discharge toner from the discharge opening; and
a developing unit supported by the rotary, including a receiving opening configured to receive the toner discharged from the discharge opening, a storage chamber configured to store the toner received from the receiving opening, and a developing roller configured to bear the toner stored in the storage chamber,
wherein the developing unit includes a first guide portion, and the first guide portion is configured to guide the toner stored in the storage chamber away from the receiving opening in the axial direction in a case where the rotary rotates, and
wherein the toner cartridge includes a second storage chamber configured to store the toner and a second guide portion, and the second guide portion is configured to guide the toner stored in the second storage chamber in a direction in which the toner approaches the discharge opening in the axial direction in a case where the rotary rotates.

10. The image forming apparatus according to claim 9,
wherein the second guide portion extends in a direction inclined with respect to the axial direction.

11. The image forming apparatus according to claim 9,
wherein the second guide portion has a part closer to the rotation axis than the discharge opening is to the rotation axis as viewed in the axial direction.

12. The image forming apparatus according to claim 9,
wherein the toner cartridge includes a plurality of second guides disposed side by side in the axial direction, the plurality of second guides includes the second guide portion.

13. The image forming apparatus according to claim 9,
wherein, in a case where a rotation phase of the rotary in which the first guide portion guides the toner in a direction away from the receiving opening in the axial direction is a first rotation phase, a rotation phase of the rotary in which the second guide portion guides the toner in a direction in which the toner approaches the discharge opening in the axial direction is a second rotation phase, a rotation phase of the rotary in which the toner cartridge is installed in and removed from the rotary is an installation/removal phase, and the rotary makes one rotation from the installation/removal phase, the second rotation phase is located after the first rotation phase.

14. The image forming apparatus according to claim 13,
wherein an inner surface of the second storage chamber includes a second surface facing a direction from upstream to downstream in a moving direction of the toner cartridge according to rotation of the rotary,
wherein the discharge opening is provided to the second surface, and
wherein in the second rotation phase, the second guide portion guides the toner moving along the second surface in a direction in which the toner approaches the discharge opening.

15. The image forming apparatus according to claim 14,
wherein in the second rotation phase, a normal line of the second surface includes a component in a vertically upward direction, and an outer end of the second surface far from the rotation axis is located vertically below an inner end close to the rotation axis.

16. An image forming apparatus comprising:
a rotary rotatable about a rotation axis extending in an axial direction;
a toner cartridge supported by the rotary, the toner cartridge having a discharge opening, the toner cartridge configured to discharge toner from the discharge opening; and
a developing unit supported by the rotary, the developing unit including a receiving opening configured to receive the toner discharged from the discharge opening, a storage chamber configured to store the toner received from the receiving opening, and a developing roller configured to bear the toner stored in the storage chamber,
wherein a plurality of guide portions is provided in the storage chamber, the plurality of guide portions include a first guide portion and a second guide portion, the first guide portion is positioned between the second guide portion and the receiving opening in the axial direction, and the second guide portion is further from the receiving opening than the first guide portion is from the receiving opening,
wherein the first guide portion and the second guide portion are configured to guide the toner stored in the storage chamber in a direction away from the receiving opening in the axial direction as the rotary rotates, and
wherein a maximum amount of toner that is able to be moved in the axial direction by the second guide portion is less than a maximum amount of toner that is able to move in the axial direction by the first guide portion as the rotary rotates.

17. The image forming apparatus according to claim 16,
wherein in a case where a rotation phase of the rotary in which the guide portion guides the toner in a direction away from the receiving opening in the axial direction is a first rotation phase, a rotation phase of the rotary in which a positional relationship between the toner cartridge and the developing unit is a positional relationship in which the toner is able to move from the discharge opening to the receiving opening is a second rotation phase, and a rotation phase of the rotary in which the toner cartridge is installed in and removed from the rotary is an installation/removal phase, the second rotation phase is located after the first rotation phase in one rotation of the rotary from the installation/removal phase.

18. The image forming apparatus according to claim 17,
further comprising a photosensitive drum,
wherein in a case where a rotation phase of the rotary where the developing roller develops an electrostatic latent image formed on the photosensitive drum is a developing phase, the developing phase is located after the first rotation phase in one rotation of the rotary from the installation/removal phase.

19. The image forming apparatus according to claim 18,
wherein the developing phase is located after the second rotation phase in one rotation of the rotary from the installation/removal phase.

20. The image forming apparatus according to claim 16,
wherein the guide portion extends in a direction inclined with respect to the axial direction.

21. The image forming apparatus according to claim 20,
wherein, in a direction in which the guide portion extends, the guide portion includes a first end portion and a second end portion, the second end portion is further from the receiving opening than the first end portion is from the receiving opening.

22. The image forming apparatus according to claim 21,
wherein, in a case where a distance between the first end portion and the second end portion in the axial direction is a guide distance,
a guide distance of the second guide portion is shorter than a guide distance of the first guide portion.

23. The image forming apparatus according to claim 20,
wherein, in a case where an angle formed by the direction in which the guide portion extends and the axial direction is a guide angle, and a length of the guide portion in the direction in which the guide portion extends is a guide length, a guide length of the first guide portion is equal to a guide length of the second guide portion, and a guide angle of the second guide portion is larger than a guide angle of the first guide portion.

24. The image forming apparatus according to claim 20,
wherein, in a case where an angle formed by the direction in which the guide portion extends and the axial direction is a guide angle, and a length of the guide portion in the direction in which the guide portion extends is a guide length, a guide angle of the first guide portion is equal to a guide angle of the second guide portion, and a guide length of the second guide portion is shorter than a guide length of the first guide portion.

25. The image forming apparatus according to claim 17,
wherein the guide portion is a rib protruding from an inner wall surface of the storage chamber, and
wherein a normal line of the inner wall surface has a vertically upward component in the first rotation phase.

26. The image forming apparatus according to claim 25,
wherein, in a case where an angle formed by the direction in which the guide portion extends and the axial direction is a guide angle, a length of the guide portion in the direction in which the guide portion extends is a guide length, and a height of the guide portion protruding from the inner wall surface is a guide height, the guide length of the first guide portion is equal to the guide length of the second guide portion, the guide angle of the first guide portion is equal to the guide angle of the second guide portion, and a guide height of the second guide portion is lower than a guide height of the first guide portion.
